(19) United States
(12) Patent Application Publication
(10) Pub. No.: US 2026/0172465 A1
(43) Pub. Date: Jun. 18, 2026

(54) SYSTEMS AND METHODS FOR QUALITY-ENHANCED LOADING OF KEY MOMENTS IN LIVE STREAMING USING ADAPTIVE BITRATE STREAMING

(71) Applicant: Adeia Guides Inc., San Jose, CA (US)

(72) Inventors: Charles Dasher, Lawrenceville, GA (US); Christopher Phillips, Hartwell, GA (US); Reda Harb, Saint Petersburg, FL (US)

(21) Appl. No.: 18/981,362

(22) Filed: Dec. 13, 2024

(51) Int. Cl. H04L 65/80; H04L 65/611; H04N 21/234; H04N 21/432; H04N 21/433; H04N 21/45

(52) U.S. Cl. CPC H04L 65/80; H04L 65/611; H04N 21/23418; H04N 21/4325; H04N 21/433; H04N 21/4532

(57) ABSTRACT

Methods and systems are presented herein for providing enhanced-quality versions of key events during live streaming. Related apparatuses, devices, techniques, and articles are also described. During a live stream, a particular portion of content may be determined to be significant or otherwise known as a key event using a plurality of methods. If a higher-quality version of the key event is available, a client device may begin downloading the key event in the higher quality while continuing to display the live stream in a lower but presently available quality. As a result, when the key event is finished downloading at the client device, if the client device receives a request to replay the key event, the client device may replay the key event in the higher quality.

### BACKGROUND

The present disclosure relates to an enhancement upon current adaptive bitrate (ABR) streaming protocols, and more particularly, systems and methods are provided to support a quality-enhanced mechanism for display of key moments, or events, in content (e.g., in live streaming).

### SUMMARY

Recent technology has reshaped how media delivery systems provide live events, such as live sports. Streaming platforms, for example, may include features that allow for the streaming of a variety of different live sports, highlighting of preferred teams, and niche streaming of selected favorite events. Along with other network field techniques such the decrease of latency in mobile networks (i.e., 5G technology), live streaming and broadcasting provide a method of media consumption for virtually experiencing a real event, whether that be a sports event or other type of live event. The streaming of live events, such as sports events, may include additional personalization features, such as multiple camera angles, live statistics, and real-time commentary options, to offer viewers a more interactive experience in comparison to that of a traditional broadcast. Streaming systems, and other broadcasting systems, send a one-way transmission of video and audio content to a collection of receivers through airwaves or by satellite. For example, the on-site broadcaster, by way of a satellite uplink station, may multiplex video and audio streams together to be sent to a satellite transponder. The satellite transponder then distributes the multiplexed broadcast to receiving headends or servers within a specific coverage area on Earth. The receiving headend, such as a satellite dish, internet protocol television (IPTV) server, cable server, over the air (OTA) affiliate server, or over-the-top (OTT) server, receives the multiplexed broadcast signals through a satellite receiver downlink. The receiving headend/server decodes the multiplexed broadcast signal and sends the broadcast signal or streaming manifest to be shown on a client device.

In some approaches, adaptive bitrate (ABR) streaming is used to enhance viewing experiences for content being delivered over unreliable, or unmanaged, networks with fluctuating bandwidth. ABR may be used in OTT applications since OTT streaming services function on varying and uncontrolled network speeds. The OTT operator's headend, server, or any other ABR client device identifies an appropriate streaming quality based on the headend/server's or client device's available bandwidth and network capacity. In an ABR application, the content is encoded into multiple resolutions and bitrates to create different content adaptation sets of varying quality levels. The encoded content is then divided into smaller segments which are packaged by the streaming service and sent to the client device in a manifest stream created using an ABR-compatible streaming protocol (e.g., HLS for HTTP live streaming, MPEG-Dash for dynamic adaptive streaming, Adobe HTTP Dynamic Streaming or Microsoft Smooth Streaming). The OTT server then sends the manifest stream having links to the stored adaptation set segments to a content delivery network (CDN) which delivers the appropriate segment at the best quality available to the client device.

In some approaches, streaming applications determine quality levels solely based on network conditions at the time of playback, without accounting for the importance of the content being viewed. For example, a live streamed football game may only be available for playback at a resolution of 1080p because 1080p was the highest quality resolution at the time the segments were being downloaded. It would be beneficial for a display device to provide a replay of a segment of the football game having a game-changing field goal. However, the replay of the segment having the game-changing field goal would still be played back in 1080p, regardless of higher qualities of the game-changing field goal being available on other servers. Thus, the streaming application does not provide the most optimal quality for the key event during a replay. In such approaches, streaming applications primarily focus on maintaining continuous playback across varying network conditions and do not prioritize the quality or immediacy of specific content segments that are most likely to be replayed. This often results in key moments, such as the game-changing field goal, being replayed at lower qualities, especially if the network conditions of the client device fluctuate often. The display device, therefore, may provide a replay of a key event but not in the highest possible quality.

In some approaches, with streaming techniques such as IPTV, OTA, cable, satellite, or other approaches that may not rely heavily upon ABR, a portion of a live event that is considered significant may also be streamed at an available quality depending on a given scenario's conditions. However, in some approaches, if there exists a higher-quality version of the significant portion at another server, the streaming application may have no mechanism for storing the higher-quality version of the key event locally. Regardless of the significance of the portion of the content stream, the streaming application may not replay key event in the highest available quality when requested, despite a higher-quality version of the key event existing at another server. In some approaches, a streaming application has no indication that a portion of a content stream is considered significant and may therefore continue playback in a lower quality, even if higher qualities are available.

In yet another approach, a broadcaster may identify a moment of a live event that is deemed important to viewers. The broadcaster may insert a replay of that moment into the content stream so that viewers may watch the moment again. However, the replay of the moment is inserted by the live event television broadcaster on-site directly into the content feed. This means that the streaming of the replayed moment may still be susceptible to the quality constraints of the network conditions of the client device at the time that the replayed moment is being streamed. This system is not guaranteed to provide a higher-quality experience.

To address these limitations and problems, systems, methods, and apparatuses disclosed herein may be configured to enhance the preloading of key events. The disclosed quality-enhanced preloading system may be implemented via a media distribution system (e.g., IPTV, OTA, satellite, cable, OTT, etc.). The quality-enhanced preloading system comprises a client device (e.g., TV, phone, laptop) that is configured to display the live content stream. The client device may run a client application (e.g., streaming website, mobile app, TV app) from memory (e.g., local media player) or from an external client server (e.g., Netflix.com, broadcaster network) that receives the live content stream for display on the client device. The live content stream may be sent from a broadcaster server and received by a receiver on the external server or the client device. In some embodiments, a client device may receive a content stream from at least one of a plurality of servers for generating for display on a user device. In some embodiments, the client device or external client server may receive an indication from at least one of the plurality of servers that a first portion of the content stream is marked as a key event. In some embodiments, the client device or external client server may receive the indication from a broadcaster server. In some embodiments, the first portion of the content stream is marked as a key event based on a computer vision analysis performed by at least one of the plurality of servers. For example, the client device may input the raw video and audio of the live content stream into a computer vision and audio analysis model to identify a portion of the live content stream that is the key event. In some embodiments, the client device determines that (a) the content stream is being received by the user device in a first quality, and (b) that the content stream is available from at least one of a plurality of servers in a second quality that is higher than the first quality. In some embodiments, based on determining (a) and (b), the application begins to store at the user device the first portion of the content stream in the second quality while the playout is paused or idle. For example, the system, via a broadcaster headend, an external processing server, a broadcaster on-site uplink, or a client device, application, or server, may store the portion of the live stream that is the key event in the higher quality at a localized storage to be retrieved and displayed for an end user. For example, the client device may store the portion of the live stream at storage on the client device (e.g., on DVR, a buffer, a cache, volatile memory, or non-volatile memory), or the external client server may store the portion of the live stream at the external client server (e.g., on a buffer, cache, volatile memory, or non-volatile memory). In some embodiments, the application retrieves from the storage of the user device at least the first portion of the content stream in the second quality. In some embodiments, the application replays at least the first portion of the stream in the second quality.

Such aspects of the described systems, methods, and apparatuses are configured to alleviate the issue of replaying a portion of a content stream considered significant (i.e., considered a key event) in a quality that is not the highest available quality by providing a mechanism for identifying and storing a portion of a stream considered a key event. As a result, when the system, via the client device, receives a request to replay a portion marked as a key event, the replay may begin in the higher quality. For example, in cases where a higher-quality version of a key event is available from another server and must be demultiplexed at a device, or in cases when the network quality of the client device is fluctuating, the systems, methods, and apparatuses described of this disclosure ensure that the identified key event may be permanently or temporarily stored in a localized memory to be accessed during replay in a higher quality than an initially available quality. For example, such as in an OTT-enabled embodiment or other unmanaged networks, content may be displayed at a lower quality due to network conditions, but a client device may determine that a different manifest indicates that a higher quality version of a content stream may be available; the client device may then continue to play back content in a lower quality, while downloading the higher quality version of the content stream locally using leftover bandwidth. In another example, such as in a satellite-enabled embodiment, content may initially be received from a broadcast at a low quality; if the client device determines that content containing a key event is available via a different broadcast in a higher quality, the client device may begin to store the content containing the key event in the higher quality while continuing to display content from the broadcast broadcasting the event in the lower quality. In some embodiments, such as in cable, the invention may not rely on the existence of network quality. Furthermore, the systems, methods, and apparatuses described in this disclosure may ensure that the important portions of a live stream are provided in the highest quality regardless of quality constraints of the network conditions at the time that the important portions are being streamed.

In some embodiments, the described systems, methods, and apparatuses may receive live content streams via different media distribution systems, such as IPTV, OTA distribution, satellite distribution, cable distribution, OTT distribution, or any other media distribution system, and may be fully enabled to perform the functions described in this disclosure.

In some embodiments, a client device of a system receives the live content stream via an IPTV distribution system. The client device, client application, client server, or any suitable combination thereof, may also receive a multiplexed live content stream via a private managed IP network.

In some embodiments, the client device receives the live content stream via an OTA distribution system. The client device, client application, client server, or any suitable combination thereof, may also receive a multiplexed live content stream via transmitted radio waves from a broadcast transmission facility.

In some embodiments, the client device receives the live content stream via a satellite distribution system. The client device, client application, client server, or any suitable combination thereof, may also receive a multiplexed live content stream via a satellite uplink from a broadcast facility.

In some embodiments, the client device receives the live content stream via a cable distribution system. The client device, client application, client server, or any suitable combination thereof, may receive a multiplexed live content stream via a cable network.

In some embodiments, the client device receives the live content stream via an OTT distribution system. The client device, client application, client server, or any suitable combination thereof, may receive a manifest stream pointing to locations on one or a plurality of content delivery network (CDN) servers where segments of the live content stream are stored. The manifest stream may include different versions of stored content stream segments for use in ABR streaming. The client device, client application, or client server may determine the portion of the live content stream that is the key event by retrieving a manifest stream of the live content stream and determining that there is an indication in the manifest stream that identifies the portion as the key event.

In some embodiments, such as when receiving the live content stream from an IPTV, OTA, satellite, or cable distribution system, the client device, client application, or client server may receive the indication that a portion of the content stream is marked as a key event by demultiplexing packets of a received multiplexed content stream and conducting a visual and audio analysis on the demultiplexed packets to identify a portion of the live content stream that is of a key event. In other embodiments, the on-site broadcaster may receive the indication that a portion of the content stream is marked as a key event by demultiplexing packets of a received multiplexed content stream and conducting a visual and audio analysis on the demultiplexed packets to identify a portion of the live content stream that is of a key event, as further described in FIG. 6. In yet other embodiments, the broadcaster headend or other external processing server may receive the indication that a portion of the content stream is marked as a key event by demultiplexing packets of a received multiplexed content stream, and conducting a visual and audio analysis on the demultiplexed packets to identify a portion of the live content stream that is of a key event, as further described in FIG. 7.

In some embodiments, such as when receiving the content stream from an OTT distribution system, a client device, client application, or client server may receive the indication that a portion of the content stream is marked as a key event by determining that one or a plurality of segments in a manifest stream is marked as a key event and identifying the portion of the content stream that is the key event based on the marked segments. In other embodiments, the on-site broadcaster may receive the indication that a portion of the content stream is marked as a key event by determining that one or a plurality of segments in a manifest stream is marked as a key event and identifying the portion of the content stream that is the key event based on the marked segments, as further described in FIG. 6. In yet other embodiments, the broadcaster headend or other external processing server may receive the indication that a portion of the content stream is marked as a key event by determining that one or a plurality of segments in a manifest stream is marked as a key event, and identifying the portion of the content stream that is the key event based on the marked segments, as further described in FIG. 7.

In some approaches, it may also be desirable to replay significant events (i.e., a portion of a content stream marked as a key event) along with other related significant events. In some approaches, however, a streaming application would need to receive input to determine a list of similar plays to select for individual viewing and receive input to determine which similar play is to be played back. Such approaches may result in desired plays being generated linearly such that each desired similar play is generated in full before another similar play may be generated. For example, it may be desirable to view similar plays of a one-handed catch in a football game. In some approaches, a streaming application would need to open a separate search application containing a database of other related key events to the one-handed catch (e.g., a YouTube search engine). The streaming application may then receive an input to determine what similar content may have a related one-handed catch to display as a selectable list on a viewing device (e.g., a search query on YouTube) and then also receive an input to determine which similar play or similar plays from the selectable list of similar plays to play back (e.g., which of the similar plays YouTube generates should be played back). The streaming application may then play back each selected similar one-handed catch individually (i.e., play back each selected play to completion before being able to view the next play). Meanwhile, the live stream containing the rest of the content from the original touchdown may still be generated as similar plays are being watched. Such approaches prevent a seamless viewing experience where a key event may not be watched in parallel with other related key events.

To help address these problems, the systems, methods, and apparatuses disclosed herein may also be configured to generate a mosaic comprising a key event replay and another additionally accessed content portion from an additional content item. The disclosed system comprises a client device (e.g., TV, phone, laptop) that is configured to display the live content stream. The client device may run a client application (e.g., streaming website, mobile app, TV app) from memory (e.g., local media player) or from an external client server (e.g., Netflix.com, broadcaster network) that receives the live content stream for display on the client device. In some embodiments, the client device receives a content stream from at least one of a plurality of servers for generating for display on a user device. The client device also receives from at least one of the plurality of servers an indication that a portion of the content stream is marked as a key event. In some embodiments, the client device receives a request to replay the portion of the content stream marked as the key event and, based on receiving the request, accesses at least one additional content portion from at least one additional content item identified as relevant to the key event. In some embodiments, the client device generates for simultaneous display a mosaic of content items comprising a replay of the portion of a content stream marked as a key event and at least one additional content portion from at least one additional content item. For example, when streaming a live event, the client device, client server, or client application may replay a key event from the current live event and also replay a related key event together in a mosaic.

Such aspects of the present disclosure alleviate the issue of being unable to seamlessly watch a key event together with a related key event at the same time by providing a mechanism for replaying a key event and a related key event together in a mosaic format. As a result, multiple related events may be watched simultaneously, providing a more seamless viewing experience relative to other approaches. For example, instead of a client device of a system having to manually receive input to display a plurality of related key events, receiving input to play back certain related events, and playing back each selected key event individually, the present disclosure describes a means for watching related key events at the same time by accessing at least one related key event for display and generating the desired key events together in a mosaic.

The described systems, methods, and apparatuses may receive live content streams via different media distribution systems, such as IPTV, OTA distribution, satellite distribution, cable distribution, OTT distribution, or any other media distribution system, and may be fully enabled to perform the functions described in this disclosure. In any of the previously mentioned media distribution systems, the client device of a system may generate a mosaic of content items including the key event and at least one other related key event from at least one additional content portion from at least one additional content item.

Notably, the present invention is not limited to the combination of the elements as listed above and may be assembled in any combination of the elements as described herein.

These and other capabilities of the disclosed subject matter may be more fully understood after a review of the following figures, detailed description, and claims.

### BRIEF DESCRIPTIONS OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration these drawings are not necessarily made to scale.

The embodiments herein may be better understood by referring to the following description in conjunction with the accompanying drawings in which like reference numerals indicate identical or functionally similar elements, of which:

FIG. 1 illustrates a quality-enhanced preloading system for preloading a quality-enhanced content portion of a key event from a live content stream into a localized storage, in accordance with some embodiments of this disclosure;

FIG. 2 illustrates an example mosaic rendering system for identifying and displaying together similar key events based on a replay of a key event, in accordance with some embodiments of this disclosure;

FIG. 3 is an illustrative example wherein multiple key events during streaming are fetched, and a portion of a screen is allocated for each of the key events, in accordance with some embodiments of this disclosure;

FIG. 4 is an illustrative example wherein a media analysis system that sends a multiplexed file with relevant key event data to a casting headend determines the existence of a key event during a live media event, in accordance with some embodiments of this disclosure;

FIG. 5 is an illustrative example wherein a media analysis system that utilizes a manifest file determines the existence of key event during a live media event, in accordance with some embodiments of this disclosure;

FIG. 6 illustrates a system for executing a computer vision and audio analysis process to identify key events of a live content stream at the live event on-site uplink, in accordance with some embodiments of this disclosure;

FIG. 7 illustrates a system for executing a computer vision and audio analysis process to identify key events of a live content stream at a broadcaster headend, in accordance with some embodiments of this disclosure;

FIG. 8 illustrates a system for executing a computer vision and audio analysis process to identify key events of a live content stream at OTT headend or IPTV, OTA, satellite or cable headend, in accordance with some embodiments of this disclosure;

FIG. 9 illustrates a multiplexed audio, video, and key event metadata being delivered to a DVR system via a satellite receiver, IPTV set top box, cable TV set top box, or a home DVR with an OTA receiver, in accordance with some embodiments of this disclosure.

FIG. 10 illustrates an internal DVR system for replay of a received video, audio, and key event metadata stream, in accordance with some embodiments of this disclosure;

FIG. 11 illustrates a TSTV or network PVR system for replay of received video, audio, and key event metadata, and implementation of key event features, in accordance with some embodiments of this disclosure.

FIG. 12 illustrates an IPTV or cable STB system for replay of received video, audio, and key event metadata, and implementation of key event features, in accordance with some embodiments of this disclosure;

FIG. 13 illustrates an OTT system architecture to generate key event manifests, in accordance with some embodiments of this disclosure;

FIG. 14 illustrates an OTT/ABR device 1400 supporting key event playouts, in accordance with some embodiments of this disclosure;

FIG. 15 illustrates an IPTV or cable TV system 1500 for allowing similar plays using a mosaic processing system to be streamed, in accordance with some embodiments of this disclosure;

FIG. 16 illustrates a system 1600 to search for key events that are similar to the key event in the live content, in accordance with some embodiments of this disclosure;

FIG. 17 depicts an illustrative example of a client device playing key events with common key event adaptation sets within the key event period, in accordance with some embodiments of this disclosure;

FIG. 18 is an illustrative flowchart for replaying a portion of content in a higher quality, in accordance with some embodiments of this disclosure;

FIG. 19 is an illustrative flowchart for removing a previously stored portion marked as a key event based on determining that the previously stored portion is not a key event, in accordance with some embodiments of this disclosure;

FIG. 20 is an illustrative flowchart for determining that another portion of a content stream is a key event, in accordance with some embodiments of this disclosure;

FIG. 21 is an illustrative flowchart where a client device may generate a mosaic of a key event and another related key event, in accordance with some embodiments of this disclosure;

FIG. 22 is an illustrative flowchart of a process in which a client device may replay a key event in a higher quality in a mosaic, in accordance with some embodiments of this disclosure;

FIG. 23 is an example of an artificial intelligence analysis system, in accordance with some embodiments of the disclosure; and

FIG. 24 depicts a communication system, in accordance with some embodiments of the disclosure.

The drawings are intended to depict only typical aspects of the subject matter disclosed herein, and therefore should not be considered as limiting the scope of the disclosure. Those skilled in the art may understand that the structures, systems, devices, and methods specifically described herein and illustrated in the accompanying drawings are non-limiting exemplary embodiments and that the scope of the present invention is defined solely by the claims.

### DETAILED DESCRIPTION

The present disclosure, in accordance with one or more various embodiments, is directed towards methods and systems to provide quality-enhanced preloading of key moments, or events, in live streaming using adaptive bitrate streaming protocols. The system described herein dynamically identifies key events in content streams of a live event using real-time analysis and predictive modeling. For example, a key event may be a goal, match point, or pivotal play from a streamed sporting event. The term “key event” may be used interchangeably herein with the term “key moment.” The system prioritizes the identified key events for quality enhancement and preloads high-resolution versions of the key events in localized caches (e.g., edge servers, client devices). In some situations, a client device, application, or server may not be able to fetch a portion of a content stream in the highest quality available due to bandwidth limitations. For example, a client device may only be able to receive content in 720p even though the content is available in 1080p because of network conditions that restrict download to 720p. To address these concerns, the system described herein may, in response to a request to replay a key event, begin fetching the key event in a highest available quality (e.g., 4K) of current bandwidth conditions, if the highest available quality (e.g. 4K) is higher than the previously streamed quality (e.g., 720p). The previously streamed quality may have been the previously highest available quality. If a streaming device already successfully precached the highest available quality version of the key event (e.g., due to available bandwidth conditions during the streaming of a key event) in its entirety, then the streaming device will begin replay of the key event in the highest available quality upon request. If a streaming device was unable or did not precache the key event in the highest available quality upon the request, the device will first ensure that enough segments have been downloaded such that the entire contents of the key event may be played out smoothly once the device begins playout. The device may continue to playout the received content stream during download of the key event, ensuring some form of content is being displayed. The number of segments to download to the buffer in the highest quality may be determined based on a bandwidth calculation performed while downloading the segments before the key event playout begins. In some embodiments, the system may prefetch and cache content associated with a key event in the highest available quality (e.g., in 4K) during a pause of the streamed content or when the fluctuating network conditions of the streamed content allows for download in the highest available quality (e.g., in 4K). The system may therefore initiate playout of the cached high quality segments for the key event, ensuring instant playback of the key event in the highest possible quality.

A key event may be identified by a computer vision and audio analysis system, herein referred to as the “CV system.” The CV system analyzes raw video and audio of the live content stream to determine the key event start time and end time. The CV system may also be used to identify more information about the key event such as the type of key event (e.g., a touchdown, field goal, game-changing play), key players, key actors, or other information of interest to a viewer of the live content stream. The CV system may generate key event metadata based on the identified information. In some cases, the generated key event metadata may be encoded in MPEG-7, allowing for content-based search and retrieval. In some cases, the generated key event metadata may be encoded in key-length-value (KLV).

A localized storage refers to a transitory storage solution (e.g., cache or buffer) or a non-transitory storage solution (e.g., DVR) that holds, among other data, preloaded quality-enhanced content portions on a client device (e.g., laptop, TV, set-top box), an edge server (e.g., CDN edge server), a browser (e.g., web browser on a client device), an application (e.g., mobile application, desktop application), an edge computing device (e.g., smart home devices, edge nodes in IoT networks), or any other local storage that may store preloaded quality-enhanced content portions for the purpose of reducing latency and improving access speeds for an end-user (e.g., a client device hosting a viewing session for a viewer) to retrieve the content portions. Likewise, the definitions mentioned in this paragraph may be used interchangeably with “localized storage.”

A media distribution network, as discussed in this specification, refers to the framework or infrastructure utilized by the disclosed invention to deliver media content from the content provider to a client (e.g., a client device, a client application, a client server). The system described herein may utilize one or a plurality of media distribution network/frameworks, such as IPTV, OTA, satellite, cable, and OTT. In some embodiments, the media distribution network/framework provides guidelines for the delivery of media content via terrestrial towers or satellites to televisions or radios, such as in broadcast television, OTA, and satellite television. In other embodiments, the media distribution network/framework provides guidelines for the delivery of media content, such as linear channels and video-on-demand (VOD) via coaxial or fiber networks, such as in cable television. In some embodiments, the media distribution network/framework provides guidelines for the delivery of media content via the internet, such as using a managed network in IPTV, using an internet-based streaming platform in OTT, or using any other live-streaming platform in any internet-based distribution system. In some embodiments, the media distribution network/framework provides guidelines for the delivery of media content via satellite to dishes at user locations, such as in broadcast television, or satellite television. References to embodiments related to IPTV, OTA, satellite, cable, OTT, or any other media distribution network are directed towards the framework by which media content is delivered from the content provider to the client device.

A content provider is any content creator, entity, or organization that creates, owns, licenses, or aggregates media content. A content provider may be a content creator, such as a production studio that creates TV shows, movies, music, articles, or other forms of media, or a digital media creator that creates social media. Examples of content creators include production studios (e.g., Warner Bros, BBC), independent creators (e.g., TikTok creators, YouTube creators), or any other entity that records and produces media. A content provider that owns media content may be any entity that owns intellectual property rights to content (e.g., Disney owns the rights to Marvel and Star Wars content). A content provider that licenses media content may be any entity that licenses content to distributors or platforms for broadcast or streaming (e.g., HBO licenses content to cable operators or streaming platforms like Amazon Prime). In some embodiments, the content provider is the entity that provides media content feed on site at a live event, such as a television broadcaster.

A broadcaster headend or broadcaster server may refer to a server in the media distribution network that is configured to process video, audio, and data of content being streamed or distributed through the media distribution network. The terms “broadcaster headend” and “broadcaster server” may be used interchangeably herein. The broadcaster server may receive media content from various sources, such as the content provider, a broadcaster, or other broadcaster headends (e.g., receiving satellite feed from a satellite headend). For example, an OTA headend may prepare media signals for over-the-air transmission using broadcast towers. In another example, a cable headend may process and send content to cable providers. In yet another example, a satellite headend may process and send signals to satellites for redistribution to satellite dishes or other headends. In yet another example, IPTV, OTT, or other internet-based headends may process raw content to be distributed through CDNs to a client device. A broadcaster headend may include both a satellite receiver downlink station that receives media content from a content provider or other headend and a satellite transponder uplink station that prepares the processed media content to be sent to a client device or other headend.

A client device may refer to any physical hardware (e.g., smartphone, laptop, tablet, TV, set top box) that displays media content.

A client application may refer to any software or application (e.g., Netflix app, Samsung TV software, YouTube app) that runs on the client device to provide the client device with a user interface to interact with and play the media content. In some embodiments, the client application may be a streaming application.

A client server may refer to the architecture where a client device and client application interacts with a server (e.g., Netflix server, YouTube server) to request and receive media content. In some embodiments, the client server may be a broadcaster server (e.g., a satellite server) that directly sends media content to a client application to be displayed on a client device. In other embodiments, the client server may be a CDN server that receives media content from a broadcaster server. The client server may also be a streaming server.

As such, the term “client” used herein may refer to one or a combination of a client device, a client application (running on the client device), or a client server (of the client application). The localized storage on a client device (e.g., laptop, TV, set-top box), an edge server (e.g., CDN edge servers), a browser (e.g., web browser on a client device), an application (e.g., mobile application, desktop application), an edge computing device (e.g., smart home devices, edge nodes in IoT networks), or any other local storage that may store preloaded quality-enhanced content portions for the purpose of reducing latency and improving access speeds for an end-user (e.g., a client device hosting a viewing session for a viewer) to retrieve the content portions, is located within the “client.”

Media content may be transmitted via the above-defined media distribution networks as a transport stream made up of media packets. In adaptive bitrate systems, a broadcaster headend or server may divide the media content into a plurality of portions. A portion may be a “segment” of the media asset comprising a number of seconds of audio and/or video data and may be the minimum amount of data that may be played back by the client. Alternatively, a portion may be a packet, as defined above, which contains a small amount of data that, when combined with other packets, make up the transport stream.

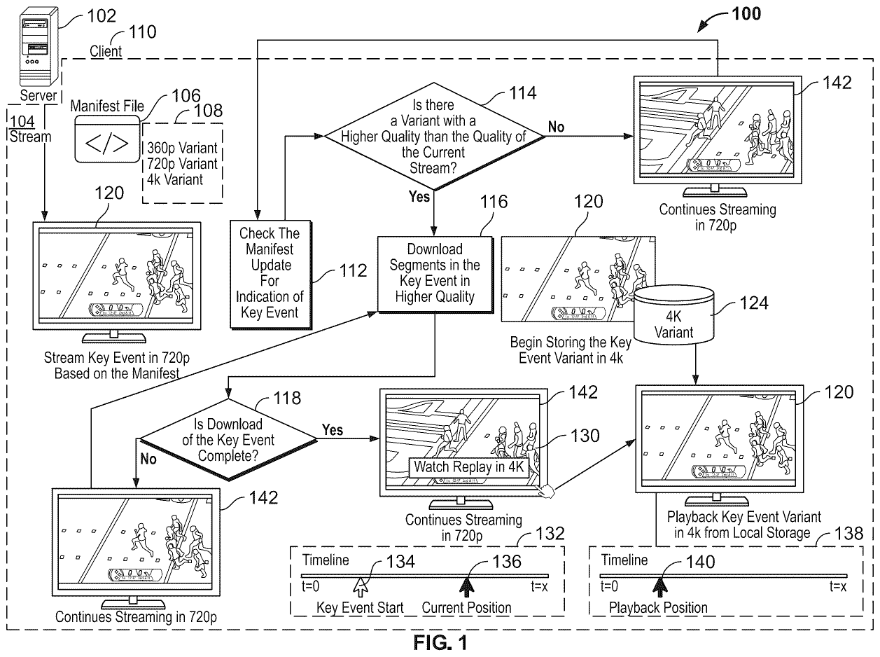

FIG. 1 illustrates a quality-enhanced preloading system 100 for preloading a quality-enhanced content portion of a key event from content stream 104 into localized storage on a client device, application, or server, in accordance with some embodiments of this disclosure. In some embodiments, content stream 104 is a live content stream of a live event.

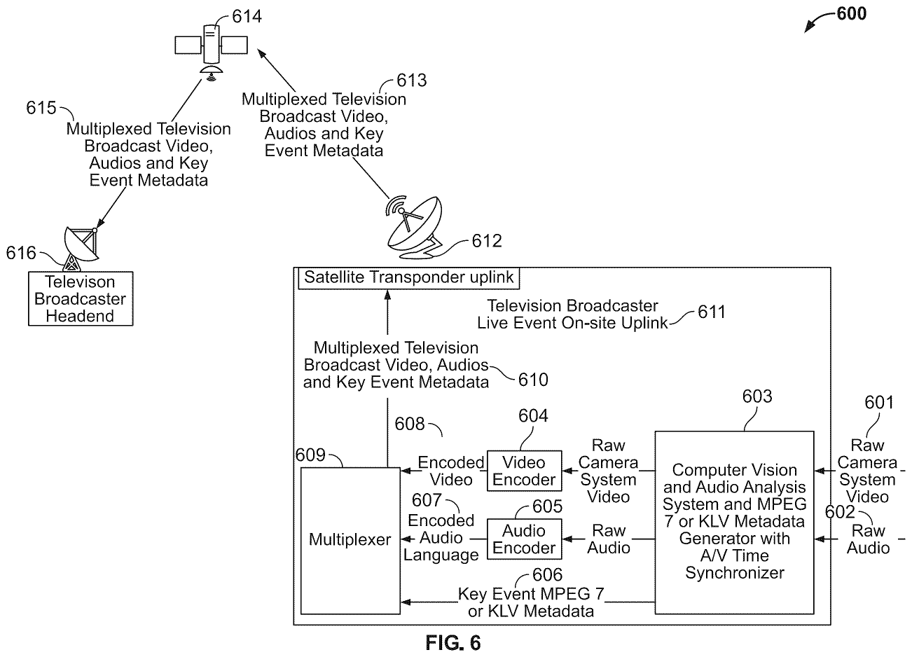

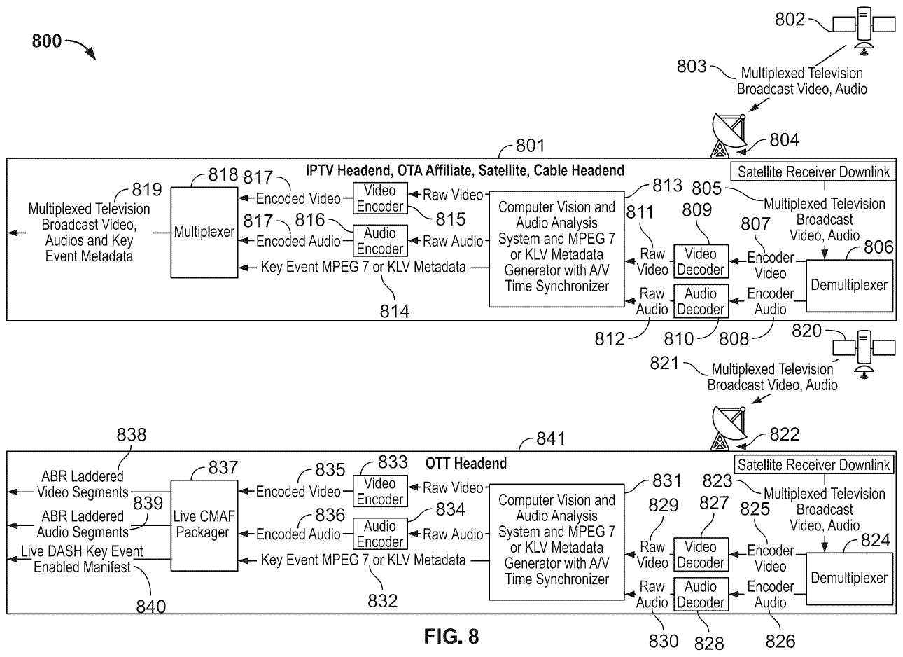

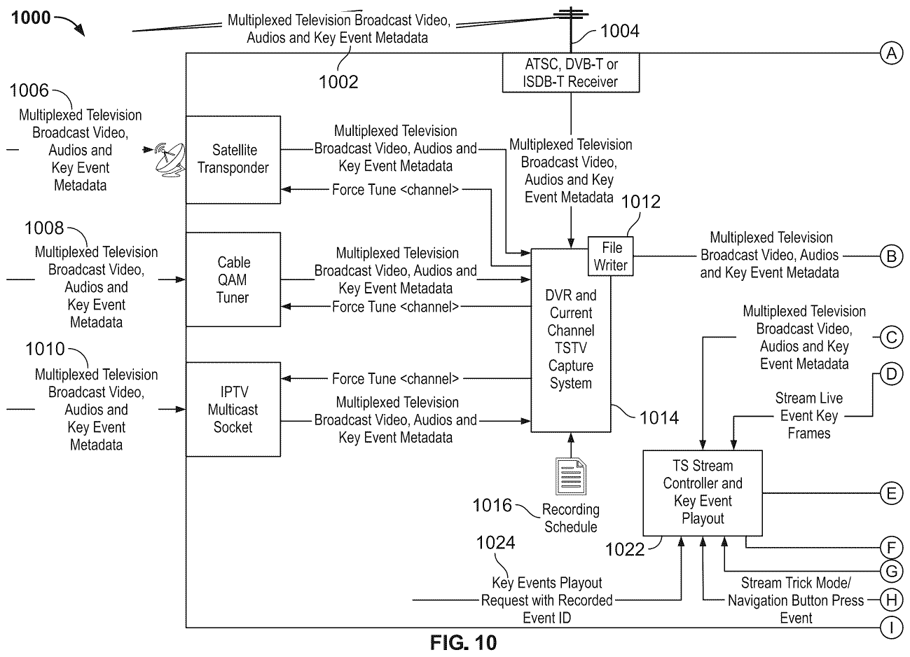

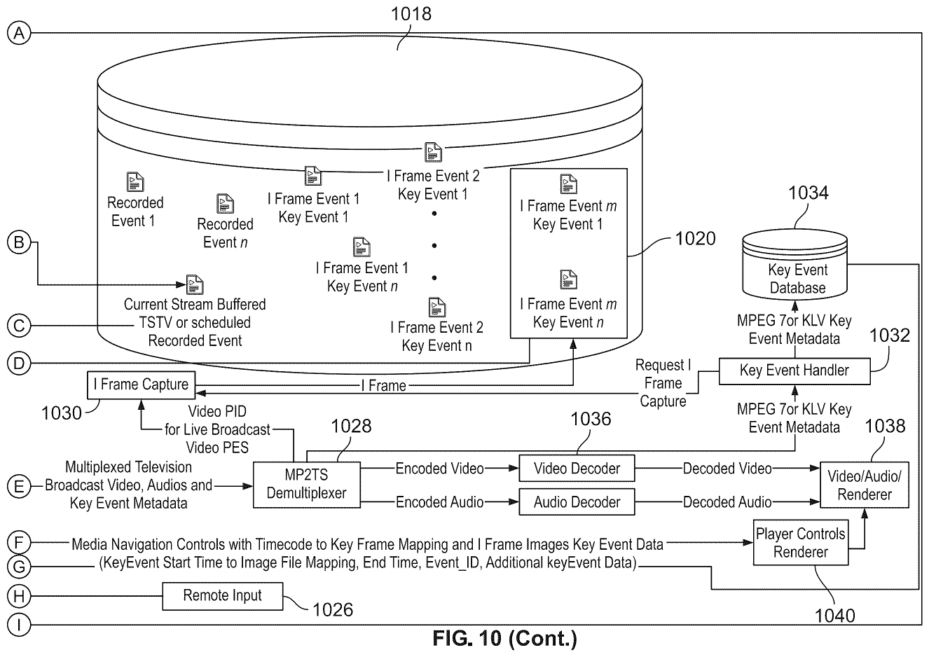

Content stream 104 may be received by a client device 110 from provider system 102. In some embodiments, provider system 102 is one or a plurality of IPTV, OTA affiliate, satellite, cable TV, or OTT headends or servers that are external servers from the client device, client application, or client servers. IPTV, OTA affiliate, satellite, and cable TV embodiments may be further described in detail in FIGS. 6, 7, 8, 9-17. OTT and ABR embodiments may be further described in detail in FIGS. 8, 10

In IPTV, OTA, satellite, cable, and OTT embodiments, live content stream 104 may be encoded into a packetized elementary stream (PES) and multiplexed into a transport stream (MP2TS) or MPEG 4 Part 14 stream (MP4) for the purpose of transport. The raw video and audio of the live content stream may be divided into packets with headers that indicate details related to the live content stream. The headers of the live content stream packets may contain metadata such as presentation time stamps (PTS) and decoding time stamps (DTS), which identify timestamps of video and audio playback. The headers of the live content stream packets may also include stream identifiers and optional fields indicating packet length. In some embodiments, packets are multiplexed into transport streams for delivery. For example, PES packets may be segmented into 188-byte TS packets, which are then transmitted over broadcast systems or stored on devices like DVRs. Each PES packet represents a specific elementary stream, allowing it to be decoded independently by the receiving device.

In IPTV embodiments, packets of live content stream 104 are transported from provider system 102 (e.g., telecom or internet service providers (ISPs)) to client device 110 (e.g., set top box).

In OTA embodiments, packetized media of live content stream 104 are transported from provider system 102 (e.g., broadcast tower) to client device 110 (e.g., antenna) by radio signals.

In satellite embodiments, packets of live content stream 104 are transported from provider system 102 (e.g., satellite) to client device 110 (e.g., satellite dish and receiver) by television signals.

In cable embodiments, packets of live content stream 104 are transported from a server 102 to client device 110 by coaxial cables.

In OTA, satellite, and OTT embodiments, packets of live content stream 104 are transported from provider system 102 to client device 110.

The system disclosed may be implemented by any live content streaming or broadcasting system. The live content stream may be sent to a broadcaster headend at an uplink site at the live event. For example, a recording of a Cal/Stanford football game may be uploaded to a broadcaster headend in real time during the play of the game in Palo Alto. The football game is recorded live by a camera in Palo Alto connected to an on-site uplink that sends the live video and audio feed to the broadcaster headend, such as an IPTV headend, OTA affiliate headend, satellite distributor headend, cable headend, OTT headend, or other media distribution system headends.

In some embodiments, live content stream 104 may be divided into segments (e.g., two-second portions) of equal time lengths.

In some embodiments, the live stream of an event may be delivered to an IPTV headend (e.g., AT&T U-verse, Verizon Fios) for processing. In such embodiments, the live content stream is delivered to a client device over a private, IP-based managed network installed in telecommunications or internet service facilities. The live stream is encoded, stored, and distributed via IP packets, providing a closed system with dedicated bandwidth for video content.

In OTT or other ABR embodiments, packets may be requested at different bitrates based on the client device's capabilities, such as download speed or internet speed, optimizing the quality of the experience without requiring to first load the larger entirety of the content stream. The packets may carry segments.

In OTT or other ABR embodiments, segments of live content stream 104 may be described within manifest 106. Manifest 106 may be an HLS manifest, MPEG-DASH manifest, or any other suitable manifest that provides a structured list of information about live content stream 104 to access, load, and play the video and audio of live content stream 104. Manifest 106 may contain different resolution quality levels (e.g., 360p, 720p, 1080p, 4k) and their associated bitrates of live content stream 104. Manifest 106 may have references to a list of versions 108 of live content stream 104 associated with the different quality levels. Manifest 106 may also contain segment indicators for segments of live content stream 104. For example, a manifest stream may include segment URLs for a series of sequential two-second segments of content. The segment URLs or other types of segment indicators may point to a location on a content delivery network (CDN) server where the segment is stored. For example, the actual two-second video or audio stream is stored at the CDN location of the segment URL.

In OTT and other ABR embodiments, manifest 106 may be further organized and grouped into periods. Periods are high-level groupings of content with varying start and end times. For example, different scenes of the Cal/Stanford football game may be grouped into different periods (e.g., pre-game content, the main game, halftime, advertising period, post-game analysis). In some embodiments, manifest 106 may contain period identifiers. For example, pre-game content for the Cal/Stanford football game may be grouped into “Period id=‘p1’,” the main game may be grouped into “Period id=‘p2’,” halftime may be grouped into “Period id=‘p3’,” and the post-game analysis may be grouped into “Period id=‘p4’.” In some embodiments, manifest stream 106 may contain start times for each period. For example, the manifest stream may indicate that Period “p1” has a start time at 0 seconds (e.g., “start=“PTOS””). In some embodiments, manifest 106 may contain end times for each period.

In some embodiments, manifest 106 contains a key event indicator that indicates whether or not a key event exists within a period of the live content stream. For example, the manifest stream may have a Boolean identifier at the header of each period to determine whether the existence of a key event is true or false in that period (e.g., “keyEvent=‘true’,” or “keyEvent=‘false’”).

In some embodiments, ad periods are included in the manifest.

An example of a live DASH manifest with n periods is shown below:

```
<?xml version = “1.0” encoding = “UTF-8”?>
<MPDF xmlns = “urn:mpeg:dash:schema:pdf:2011”
  profiles = “urn:mpeg:dash:profile:isoff-live:2011”
  type = “dynamic”
  availabilityStartTime = “2026-09-05T12:00:00Z”
  publishTime = “2024-09-05T12:00:00Z”
  minimum UpdatePeriod = “PT2S”
  time ShiftBuffer Depth = “PT1H”
  suggestedPresentationDelay = “PT10S”
  maxSegmentDuration = “PT2S”
  <!-- Period 1 -->
  <Period id = ″p1” start = “PT0S” keyEvent = “false”>
  <!-CMAF Multiplexed Video and Audio Sets -->
  <!-Adaptation Set for 4K -->
    <AdaptationSet id=″as1″ contentType=″video″
    mime Type=″video/mp4″
codecs=″avc1.640033,mp4.40.2″ frameRate=″30″ startWithSAP=″1″
segmentAlignment= ″true″>
    <!-- 4K Qualities -->
      <Representation id=″segment_4k_quality1″
      mimeType=″video/mp4″
codecs=″avc1.640028″ width=″3840″
height=″2160″ bandwidth=″6000000″>
        <SegmentTemplate
        media=″segment_4k_quality1_$Number$.m4s″
initialization=″segment_4k_quality1_init.mp4″ duration=″2000″
startNumber=″1″
timescale=″1000″/>
      ... Representation of 4K segment in second quality,
      bandwidth = 8000000
      ... Representation of 4K segment in third quality,
      bandwidth = 10000000
      <!-- 1080p Qualities -->
      ... Representation of 1080p segment in first quality,
      bandwidth = 2000000
      ... Representation of 1080p segment in second quality,
      bandwidth = 4000000
      ... Representation of 1080p segment in third quality,
      bandwidth = 6000000
      <!-- 720p Qualities -->
      ... Representation of 720p segment in first quality,
      bandwidth = 1000000
      ... Representation of 720p segment in second quality,
      bandwidth = 2000000
      ... Representation of 720p segment in third quality,
      bandwidth = 3000000
  </AdaptationSet>
  <!-- Adaptation Set for English Audio -->
    <AdaptationSet id=″as4″ contentType=″audio″
    mime Type=″audio/mp4″
codecs=″mp4a.40.2″ lang=″en″
segmentAlignment=″true″ startWithSAP=″1″>
    SegmentTemplate media=″audio_segment_$Number$.m4s″
initialization=″audio_init.m4s″ duration=″2″ startNumber=″1″
timescale=″1000″/>
    <Representation id=″r10″ bandwidth=″192000″
audioSamplingRate=″48000″ />
    <Representation id=″r11″ bandwidth=″128000″
audioSamplingRate=″44100″ />
    <Representation id=″r12″ bandwidth=″96000″
    audioSamplingRate=″44100″ />
  </AdaptationSet>
  <!-- Adaptation Set for Spanish Audio -->
    <AdaptationSet id=″as5″ contentType=″audio″
mimeType=″audio/mp4″
codecs=″mp4a.40.2″ lang=″es″
segmentAlignment=″true″ startWithSAP=″1″>
    <SegmentTemplate media=″audio_segment $Number$.m4s″
initialization=″audio_init.m4s″ duration=″2″ startNumber=″1″
timescale=″1000″/>
    <Representation id=″r13″ bandwidth=″192000″
audioSamplingRate=″48000″/>
    <Representation id=″r14″ bandwidth=″128000″
audioSamplingRate=″44100″ />
    <Representation id=″r15″ bandwidth=″96000″
audioSamplingRate=″44100″ />
  </AdaptationSet>
  </Period>
  <!-- Period 2 -->
  <Period id=″p2″ start=″PT20M18S″ keyEvent=”true”>
  <!-- Repeat the Adaptation Sets as in Period 1 -->
  <!-- Adaptation Set for video -->
    ... 4K adaptation sets
    ... 1080p adaptation sets
    ... 720p adaptation sets
  <!-- Adaptation Set for English Audio -->
    ... English audio adaptation sets
  <!-- Adaptation Set for Spanish Audio -->
    ... Spanish audio adaptation sets
  </Period>
  <!-- Period 3 -->
  <Period id=″p3″ start=″PT20M34S″ keyEvent=”false”>
  <!-- Repeat the Adaptation Sets as in Period 1 -->
  <!-- Adaptation Set for video -->
    ... 4K adaptation sets
    ... 1080p adaptation sets
    ... 720p adaptation sets
  <!-- Adaptation Set for English Audio -->
    ... English audio adaptation sets
  <!-- Adaptation Set for Spanish Audio -->
    ... Spanish audio adaptation sets
  </Period>
  <!-- Period 4 -->
  <Period id=″p4″ start=″PT45M18S″ keyEvent=”true”>
  <!-- Repeat the Adaptation Sets as in Period 1 -->
  <!-- Adaptation Set for video -->
    ... 4K adaptation sets
    ... 1080p adaptation sets
    ... 720p adaptation sets
  <!-- Adaptation Set for English Audio -->
    ... English audio adaptation sets
  <!-- Adaptation Set for Spanish Audio -->
    ... Spanish audio adaptation sets
  </Period>
  <!-- Period 5 -->
  <Period id=″p5″ start=″ PT46M30S″ keyEvent=”false”>
  <!-- Repeat the Adaptation Sets as in Period 1 -->
  <!-- Adaptation Set for video -->
    ... 4K adaptation sets
    ... 1080p adaptation sets
    ... 720p adaptation sets
  <!-- Adaptation Set for English Audio -->
    ... English audio adaptation sets
  <!-- Adaptation Set for Spanish Audio -->
    ... Spanish audio adaptation sets
  </Period>
  <!-- Period n -->
  <Period id=″pn″ start=″ PThhHmmMssS″ keyEvent=true OR false>
  <!-- Repeat the Adaptation Sets as in Period 1 -->
  <!-- Adaptation Set for 4K -->
    ... 4K adaptation sets
    ... 1080p adaptation sets
    ... 720p adaptation sets
  <!-- Adaptation Set for English Audio -->
    ... English audio adaptation sets
  <!-- Adaptation Set for Spanish Audio -->
    ... Spanish audio adaptation sets
  </Period>
</MPD>
```

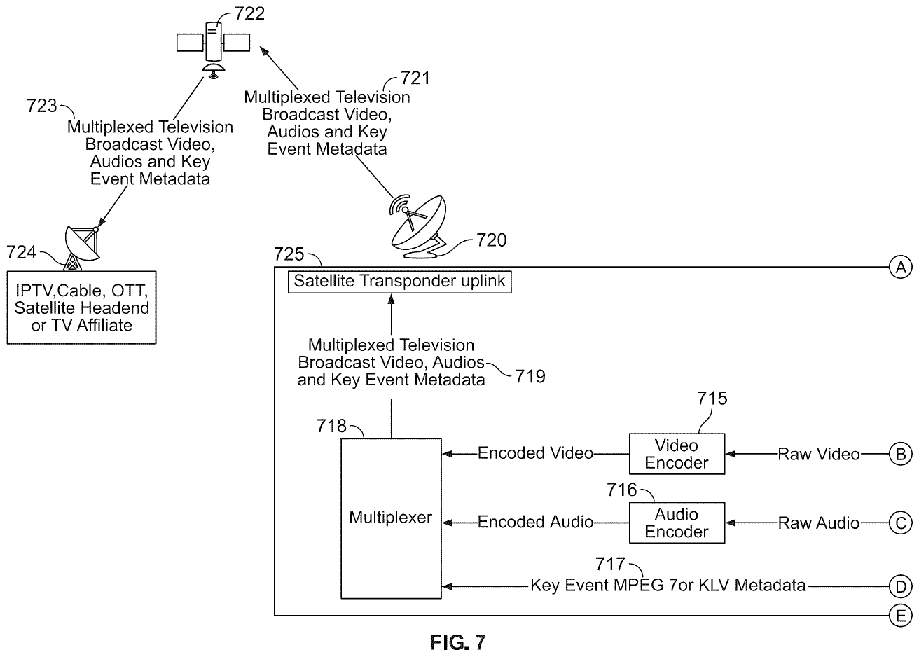

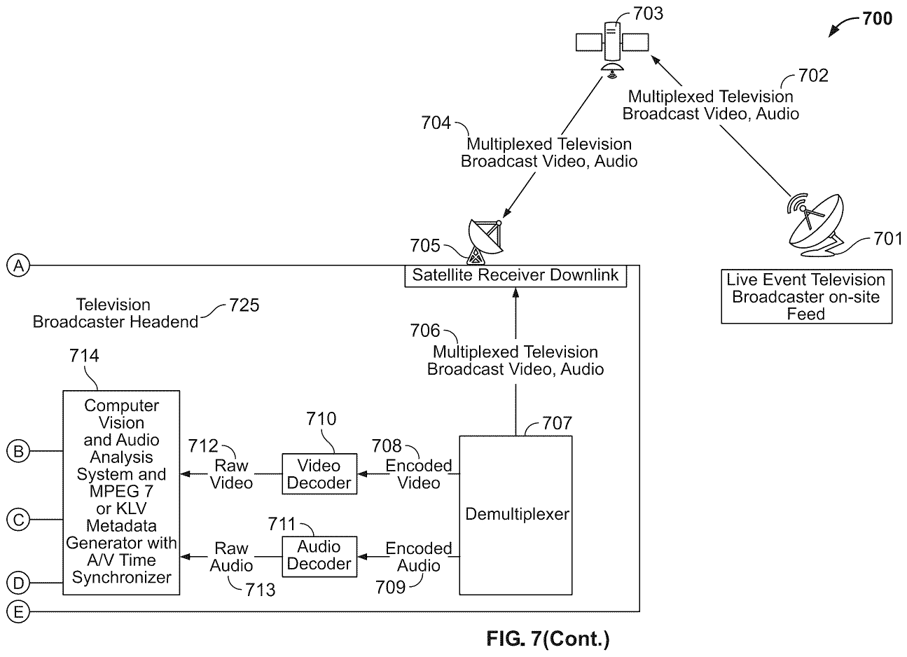

In OTT and ABR embodiments, the live stream of the event may be delivered to an OTT headend (e.g., Netflix, Hulu, Disney+, Amazon Prime Video) for processing. In such embodiments, the live content stream is delivered to the client device on-demand via the open internet, independent of any internet service provider (ISP) or cable provider. In such embodiments, the OTT server may encode, package, and segment content into multiple bitrates and resolutions, such as in ABR streaming to be compatible with different devices and internet speeds. The OTT headend 102 may process the live content stream, as described in further detail in relation to FIGS. 7 and 8, and send the processed live content stream with key event metadata with manifest 106 to client 110, either directly or via other external servers.

In OTT and OTT ABR embodiments, the client (e.g., client device, client application, or client server) 110 may receive live content stream 104 from an external server (e.g., client application, client server, broadcasting headend, or other external processing server). Client device 110 may also receive, in periodic updates, manifest 106 with different quality versions 108 of content stream 104 segments (e.g., segment in 360p, segment in 720p, and segment in 4k), according to ABR specifications. The client device 110 may also be streaming content stream 104 in one of the provided qualities in manifest 106. In some embodiments, the client device may have a network quality restriction and will stream content stream 104 in the highest provided quality under the network quality restriction. For example, the client device may be connected to an internet network that has bandwidth to download and stream content in only 720p.

At 112, the client device, application, or server processing manifest 106 may identify a key event indicator for a period or segment in manifest 106 showing key event 120. For example, the client device may be notified by the manifest to identify that a current streaming portion of a football game is actually a key play for an important touchdown in the game. At 114, the client checks manifest 106 to see if there is a higher quality version for the portion of the content stream 104 that has the key event. For example, if the client is currently streaming the football game at 720p and the manifest file has the option to stream the football game at 4k, then the client may determine that there is a higher quality version of the content than the current quality being streamed. If there is a higher quality version of the content, the client may begin to download the segments of the key event 120 from manifest 106 in the higher quality (e.g., 4k) and store it in localized storage 124. The client may continue to stream the content stream 104, until, at 118, it is determined that the download of the segments of key event 120 in the higher quality is completed. The client may already be streaming the content stream 104 of a second event 142 before download of the key event 120 is complete. In some embodiments, the client may provide a prompt 130 during the stream of second event 142 to replay key event 120 in the higher quality. In some embodiments, manifest 108 may be updated to indicate a key event start time 134. The replay of key event 120 may be initiated by rewinding the content stream from current time position 136 to key event start time 134. For replay of key event 120, the client may retrieve the higher quality version (e.g., 4k variant) of key event 120 from localized storage 124 and provide the higher quality version of the key event during replay, regardless of the lower network bandwidth.

Manifest stream 106 may comprise of information for streaming one or more segments of live content stream 104 via a data communications network. Manifest stream 106 may also include information for streaming one or more segments of a media stream. In some embodiments, the live content stream may be segmented into transport stream (TS) streams within manifest stream 106. In other embodiments, the live content stream may be segmented into fragmented (e.g., fragmented MP4) streams within manifest stream 106.

In IPTV embodiments, the live stream of an event may be delivered from a broadcaster on-site uplink or a distribution satellite to an IPTV headend (e.g., AT&T U-verse, Verizon Fios) for processing. In such embodiments, the live content stream is delivered to a client device over a private, IP-based network installed in telecommunications or internet service facilities. The live stream is encoded, stored, and distributed via IP packets, providing a closed system with dedicated bandwidth for video content. The IPTV headend 102 may process the live content stream, as described in further detail in relation to FIGS. 7 and 8, and send the processed live content stream with key event metadata as a multiplexed stream 104 to client 110, either directly or via other external servers.

In satellite TV embodiments, the live stream of the event may be delivered to a satellite headend (e.g., DirectTV, Dish Network Sky) for processing. In such embodiments, the live media stream is sent to a satellite in orbit via a satellite uplink and directed to a satellite downlink (such as a satellite dish or other type of satellite receiver) at the client device's location. In some embodiments, the satellite headend transmits signals of the live media stream to geostationary satellites, and the geostationary satellites broadcast the signals of the live media stream back to Earth, where it is received by satellite dish and receiver. The satellite headend 102 may process the live content stream, as described in further detail in relation to FIGS. 7 and 8, and send the processed live content stream with key event metadata as a multiplexed stream 104 to client 110, either directly or via other external servers.

In cable TV embodiments, the live stream of the event may be delivered to a cable TV headend (e.g., Comcast Xfinity, Spectrum, Cox Communications) for processing. In such embodiments, the live content stream is delivered to the client device through coaxial or fiber-optic cables directly connected to a local system of the client device, without reliance of the internet. In some cases, cable TV headends gather satellite, local, and sometimes internet-fed channels and transmit them over a network of coaxial and fiber-optic cables. The cable headend 102 may process the live content stream, as described in further detail in relation to FIGS. 7 and 8, and send the processed live content stream with key event metadata as a multiplexed stream 104 to client 110, either directly or via other external servers.

In OTA-affiliate embodiments, the live stream of the event may be delivered to an OTA-affiliate headend (e.g., local television broadcasting headend) for processing. In such embodiments, the live media stream is sent to an OTA-affiliate station, and delivered to a client device via over-the-air broadcasting. The OTA-affiliate headend 102 may process the live content stream, as described in further detail in relation to FIGS. 7 and 8, and send the processed live content stream with key event metadata as a multiplexed stream 104 to client 110, either directly or via other external servers.

In some of the above broadcaster headend embodiments, the content stream delivered to the receiving headends may be a pre-recorded content stream such as a pre-recorded event, movie, TV show rerun, any other type of content that is not a live stream, or a combination thereof.

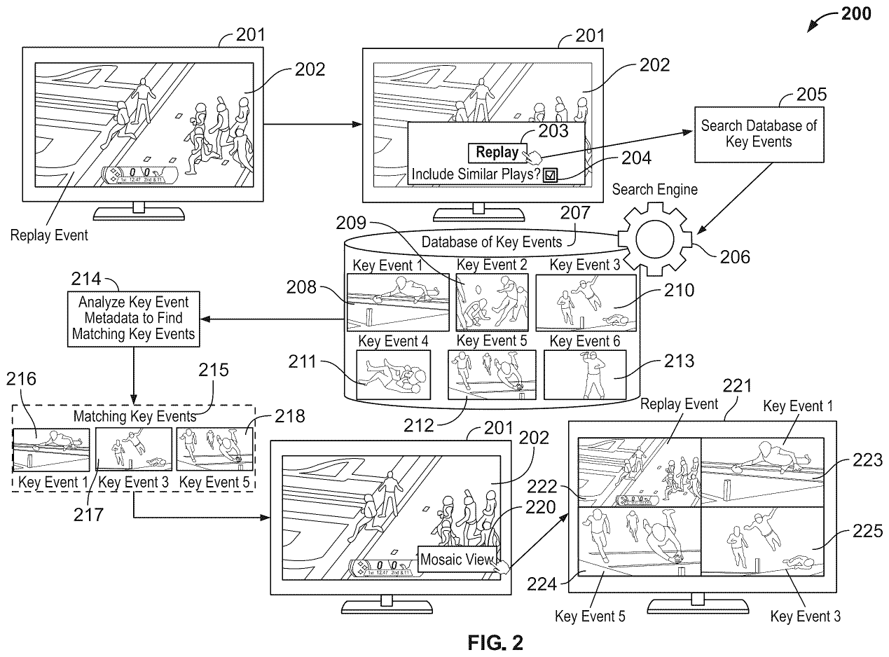

FIG. 2 illustrates an example mosaic rendering system 200 (within the client device, client application, client server, or any other processing server) for identifying and displaying together similar key events 223, 224, and 225 based on a replay of a key event, as described in FIG. 1, in accordance with some embodiments of this disclosure.

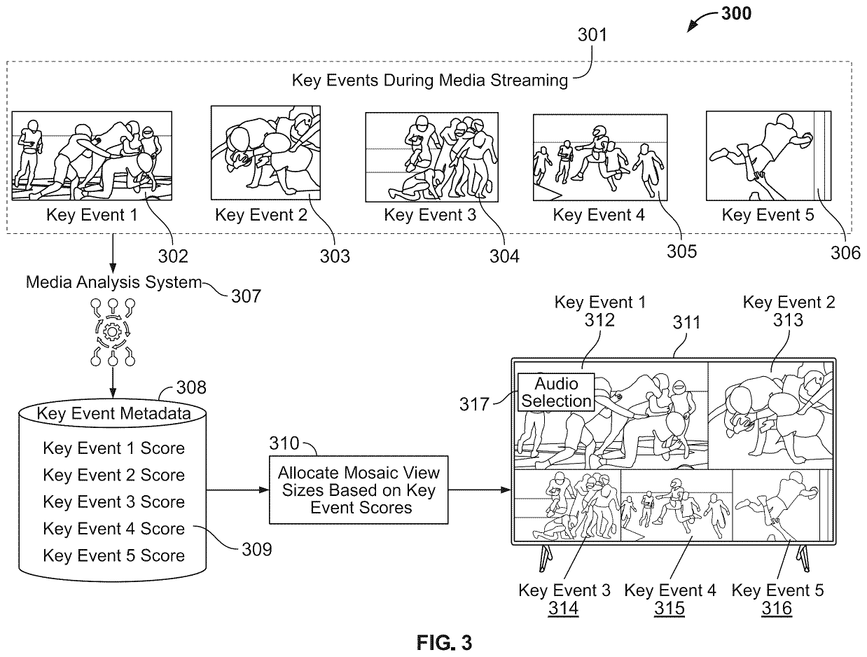

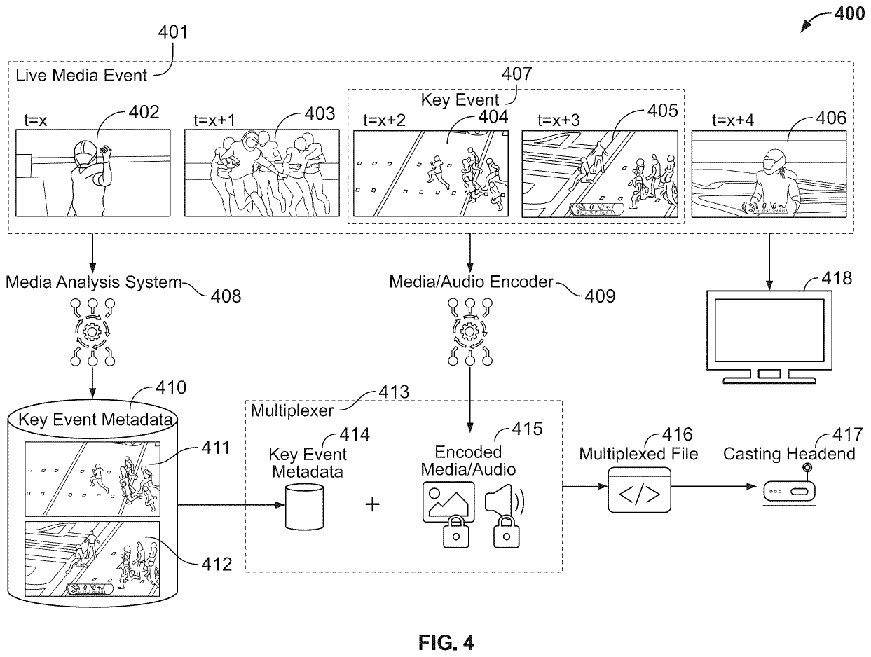

In some quality-enhanced preloading embodiments, the client device, application, or server 201, corresponding to client 110 in FIG. 1, may query the streaming provider headend, corresponding to server 102 of FIG. 1, for similar key events to a key event being streamed. In some embodiments, the client device may receive user input 203 to replay a key event being streamed, corresponding to user input 130 in FIG. 1. The client device, application, or server 201 may also receive a query input 204 to include similar key events to the key event 202 being streamed. At 205, the client 201 queries for similar key events using search engine 206 on database of key events 207. Examples of database of key events 207 are further described in further detail in relation to FIGS. 3-5, 10-11, and 13-17. In some embodiments, database of key events 207 may be a database of key event metadata (e.g., name, description, type, filename, media key event start and stop times, media file location, etc.). The key event video and audio files may be stored on an external CDN server. In such cases, the key event metadata may have a path or URL for the client server to access video and audio files for the key event on the CDN.

In some embodiments, search engine 206 searches for similar key events based on the key event metadata. For example, search engine 206 receives key event metadata for the key event being streamed. The search engine may identify that the key event being streamed is a touchdown event. The search engine may then query the database of key events 207 for key events that are also touchdown events. Search engine 206 may be located in database of key events 207.

Database of key events 207 may include key events that are not similar to the key event being streamed. For example, kick event 209, fumble event 211, and flag event 213 are not similar to the replay event, which is a touchdown event.

At 214, search engine 206 analyzes key event metadata to output matching key events 215 that are similar to the key event being streamed. For example, the search query may return touchdown event 216, touchdown event 217, and touchdown event 218 from the database of key events 207 that are similar to the replay event, which is a touchdown event.

In some embodiments, the client device 219, may receive user input 220 to render a mosaic of similar key events.

Client device 221 may generate for display retrieved similar events 223, 224, and 225 from the search engine 206 in a mosaic rendering. Examples of rendering a mosaic are described in further detail in FIG. 3. In some embodiments, the mosaic rendering system is processed on the client device, server, or application In other embodiments, the mosaic rendering system is processed on the broadcaster headend or server, and sent as a unicast to the client. Examples of such embodiments are described in further detail in FIGS. 6-17.

FIG. 3 is an illustrative example of streaming system 300 wherein multiple key events during streaming 301 are fetched, and a portion of a screen is allocated for each of the key events. Streaming system 300 may comprise of client device 311 (e.g., smart TV, phone, tablet, laptop, etc.) configured to receive an input to determine that multiple key events should be displayed at once. For example, client device 311 may be the same as client device 110 in FIG. 1 or 201 in FIG. 2. A client device 311 may determine that key events 302, 303, 304, 305 and 306 captured during streaming are requested to be viewed. Client device 311, which may utilize results from media analysis system 307, may determine from key event metadata 308 scores 309 for each of the key events. In some embodiments, an external server, a broadcaster headend, an on-site uplink server, or any other suitable computing medium, and as further discussed in relation to FIG. 6, 7, or 8, may run or receive results from media analysis system 307. Results of media analysis system 307 may include various types of relevant information (e.g., significant characters, textual descriptions of content portions, or other types of metadata that further contextualize content considered to be a key event) with respect to determining key events in a message to client device 311. Client device 311 may utilize results from media analysis system 307 (e.g., sent as a multiplexed file) to perform certain actions related to the results, such a generating the relevant information for display or selecting a content based on the other types of metadata. In some embodiments, such as in a DVR-based implementation, client device 311 may determine key event data based on content locally stored instead of receiving results from media analysis system 307.

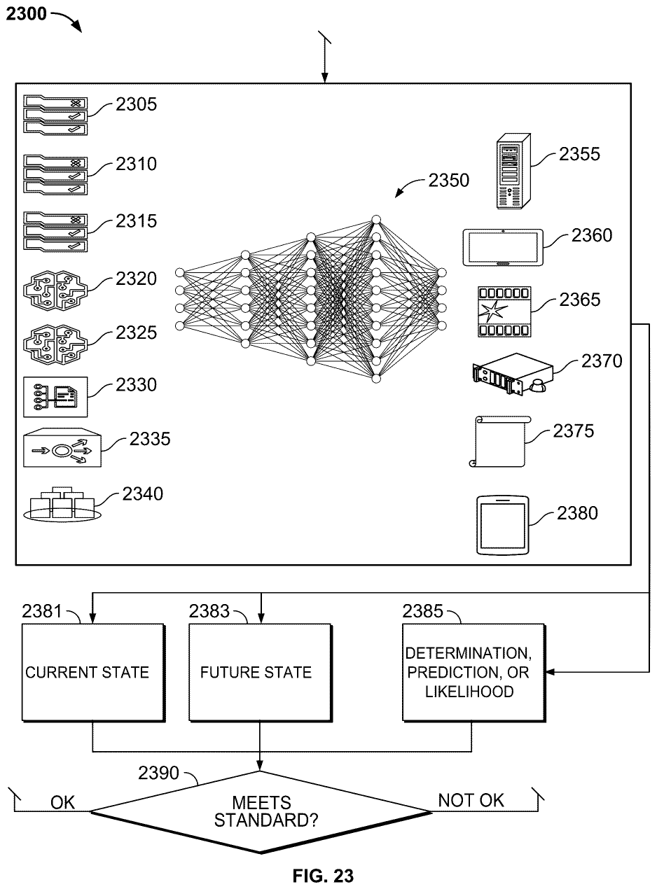

In some embodiments, results from media analysis system 307 may include display scores for each of the key events 309 from a display scoring algorithm. In some embodiments, the an external server, a broadcaster headend, an on-site uplink server may determine the display scores by running media analysis system 307 on the content stream or identified key events. In other embodiments, a client server may determine the display scores by running media analysis system 307 on the content stream or identified key events. In other embodiments, a client device or client application may run the media analysis system 307 on locally stored key events to determine display scores. The display scoring algorithm may be a computer vision analysis model, an audio analysis model, or any suitable combination thereof, and as further described in FIG. 23. In some embodiments, a deep learning model such as a convolutional neural network, region-based convolutional neural network, generative adversarial network, transformer-based model, or any suitable combination may be used to implement the scoring algorithm. In some embodiments, the scoring algorithm may be implemented using at least one of a random forest, support vector machine, linear regression, another non-deep learning method, or any suitable combination thereof. In both deep learning-based implementations and non-deep learning-based implementations, the scoring algorithm may use data amassed from previously stored data from a client device or stored data from another external server.

In some embodiments, client device 311 may determine (e.g., from results of media analysis system 307) key event metadata 308 that includes data other than scores for each of the key events 309. For example, results from media analysis system 307 may identify at least one of key players, actors, gameplays, critical decisions, or game scores (e.g., touchdowns, goals, etc.) that are present in portions of the content stream considered a key event. In some implementations, client device 311 may utilize results of media analysis system 307 to determine a textual summary of the content in the portion of the live stream considered a key event. For example, if a key event comprises a one-handed catch from a football game, then the media analysis system may add an attribute attached to key event metadata 308 indicating “Summary: one-handed catch” on the respective key event. In some implementations, the textual summary may be generated as an overlay on a viewing device.

In some embodiments, display scores for each of the key events 309 are calculated randomly. As a result, in step 310, the allocation of mosaic view sizes based on key event display scores may also be random.

In some embodiments, results from media analysis system 307 may base scores for each of the key events 309 on a predefined criterion. For example, the predefined criterion may indicate that higher display scores should be assigned to key events where a particular person, character or any other entity has the greatest amount of screentime.

In some embodiments, display scores for each of the key events 309 are used at step 310 to allocate mosaic view sizes based on key event scores such that at client device 311, each of the key events are allocated an appropriate size according to their respective scores. For example, key event 1 302 may be allocated a large portion on client device 311 as key event 1 312. Key event 2 303 may be allocated a smaller portion on client device 311 as key event 2 313. The allocation is again determined from the scores for each of the key events 309. In some embodiments, key event 3 304 corresponding to key event 3 314 when displayed on client device 311, key event 4 305 corresponding to key event 4 315 when displayed on client device 311, and key event 5 306 corresponding to key event 5 316 when displayed on client device 311 may all be allocated the same portion of the screen on client device 311 based on receiving the same score from the scores for each of the key events 309.

In some embodiments, audio selection prompt 317 may be generated on client device 311 as an overlay over the mosaic of content items. Audio selection prompt 317 may be a user interface prompt which may receive a selection to play a desired audio. The desired audio may correspond to the audio from any one of key events 302-306. In some implementations, the desired audio may default to the key event which received the highest key event score from the scores for each of the key events 309. In some implementations, the desired audio may be determined from predefined criterion. For example, predefined criterion may specify that the desired audio should default to the key event where a particular person, character or any other entity has the greatest amount of screentime. In another example, predefined criterion may specify that the desired audio should default to the key event containing metadata indicating the key event has the most recent creation date out of all other desired key events for display on client device 311. In response to determining the desired audio, client device 311, or any other suitable device, may begin playback of desired audio and prevent the playback of audios from other key events. In some implementations, the key event corresponding to the desired audio may be played back with content from other live streams or from an on-demand content store (e.g., related stored content which may have been released during the same day, week, year, etc.) in a mosaic.

In some embodiments, client device 311 may receive an indication to enlarge the portion of the screen displaying of any one of the key events on a mosaic viewing (e.g., key events 312-316). Upon client device 311 receiving the selecting any one of the key events for enlargement, the selected key event may be enlarged for viewing, and client device 311 may begin playout for only the selected key event in a full screen view. In some implementations, the selected key event may be deep linked to its full content resource. Upon client device 311 receiving selection to enlarge a key event deep linked to its full content resource, client device 311 may begin playout of the entire content stream from which the key event originated from with full replay functionality (e.g., rewind functionality, fast forward functionality, muting functionality, etc.).

In some embodiments, each or at least one of the key events 312-316 may be displayed with identifying metadata. For example, if key event 312 is from the UCLA vs USC football game on Nov. 23, 2024, then a caption such as “UCLA vs USC (Nov. 23, 2024)” may be displayed in a region of the portion corresponding to the game. In some implementations, the identifying metadata may correspond to a URL, time stamp, or any other data that may be used to identify the origin of a key event.

FIG. 4 is an illustrative example of a streaming system 400 wherein a media analysis system 408 determines the existence of a key event 407 during a live media event 401. Streaming system 400 may comprise of a client device 418. For example, client device 418 may be run on any one of client devices 110 from FIG. 1, 201 in FIG. 2, or 311 in FIG. 3. Client device 418 may utilize results from media analysis system 408 to perform certain actions. Client device 418 may also utilize data stored locally to determine relevant key event data. In some embodiments, a cloud computing server, a broadcaster headend, an on-site station, or any other suitable computing medium as further discussed in FIG. 6, 7, or 8 may be used to determine results from media analysis system 408. Reference to results of media analysis system 408 may be the same as results from media analysis system 307 from FIG. 3. On client device 418, live media event 401 may begin streaming starting from live media portion 402 at a specific time point and continue streaming live media portions 403, 404, 405, and 406 which come after the specific time point. In some implementations, each of the live media portions 402, 403, 404, 405, and 406 each occur at a fixed time period apart. For example, during a live media event 401, live media portion 402 may correspond to a 1:00:00 timestamp, live media portion 403 may correspond to a 1:00:30 timestamp, live media portion 404 may correspond to a 1:01:00 timestamp, live media portion 405 may correspond to a 1:01:30 timestamp, and live media portion 406 may correspond to a 1:02:00 timestamp. While streaming, client device 311, which may utilize results from media analysis system 408, may determine that portions 404 and 405 are considered key event 407. In response to determining that portions 404 and 405 are considered key event 407, client device 418 may begin to extract relevant key event metadata 410.

In some embodiments, key event metadata 410 may comprise of metadata for both live media portion 404 as live media metadata 411 and live media portion 405 as live media metadata 412. In some implementations, key event metadata 410 may further comprise metadata indicative of key players, actors, gameplays, critical decisions, or scores (e.g., touchdowns, goals, etc.) s identified in key event 407. In some implementations, client device 418, which may utilize results from media analysis system 408, may determine a textual summary of the content in the portion of the live stream considered a key event. For example, if a key event comprises of a one-handed catch from a football game, then results from media analysis system 408 may indicate an attribute attached to key event metadata 410 indicating “Summary: one-handed catch” on the respective key event. In some implementations, the textual summary may be generated as an overlay on a viewing device. In some implementations, while key event metadata 410 associated with results for media analysis system 408 is being determined by a server, media/audio encoder 409 may encode media, video, audio, or any other data necessary to encoding key event 407 as encoded key event data 415. In some embodiments, multiplexer 413 may multiplex necessary key event metadata 414 with encoded key event data 415. Multiplexer 413 may generate multiplexed stream 416. Multiplexed stream 416 comprises a signal streaming the necessary audio data, video data, metadata, or any other relevant data needed to encode key event 407. In some embodiments, multiplexed stream 416 may be sent to casting headend 417.

In some embodiments, casting headend 417 may be any device capable of at least packaging data streams, receiving data streams, sending data streams, or demultiplexing data streams. Casting headend 417 may be used in a variety of embodiments. For example, in a streaming system based on an IPTV embodiment, multiplexer 413 may multiplex relevant data associated with key event 407 and send multiplexed stream 416 to casting headend 417. Casting headend 417 may then send a data stream containing contents from multiplexed stream 416 to an end device to be demultiplexed and ultimately plated back at a viewing device (e.g., a smart TV, laptop, phone).

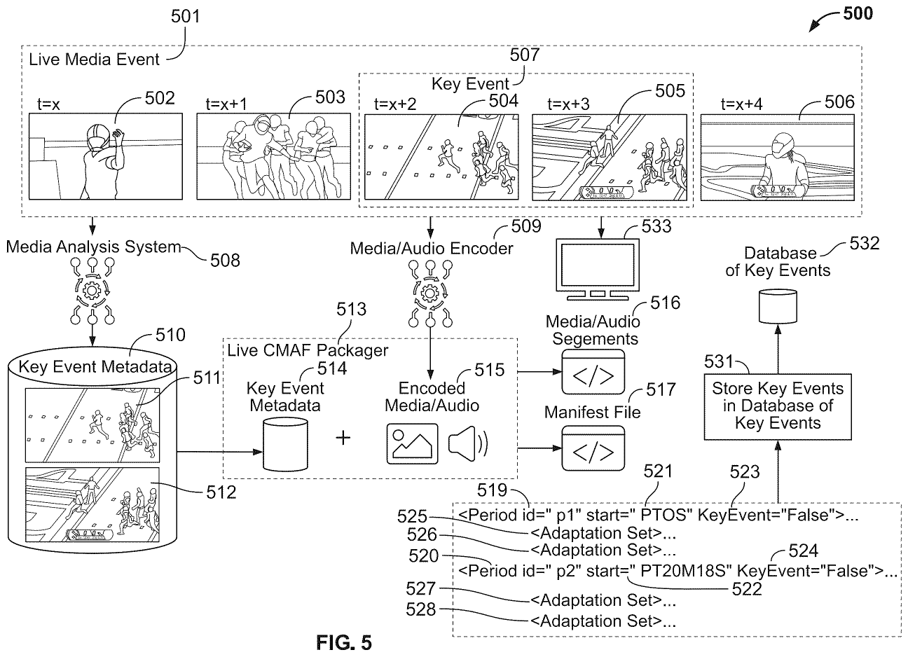

FIG. 5 is an illustrative example of a streaming system 500 wherein a media analysis system 508 determines the existence of key event 507 during a live media event 501. Streaming system 500 may comprise of a client device 533 which may utilize results from media analysis system 508 to perform certain actions. For example, client device 533 may be run on any one of client devices 110 from FIG. 1, 201 in FIG. 2, 311 in FIG. 3, or 418 of FIG. 4. Client device 533 may also utilize data stored locally to determine relevant key event data. In some embodiments, a cloud computing server, a broadcaster headend, an on-site station, or any other suitable computing medium as further discussed in FIG. 6, 7, or 8 may be used to determine results from media analysis system 408. Reference to results of media analysis system 508 may be the same as any one of results of media analysis system 307 from FIG. 3 or 408 from FIG. 4. The live media event 501 may begin streaming starting from live media portion 502 at a specific time point and continue streaming live media portions 503, 504, 505, and 506 which come after the specific time point. In some implementations, each of the live media portions 502, 503, 504, 505, and 506 each occur at a fixed time period apart. For example, during live media event 501, live media portion 502 may correspond to a 1:00:00 timestamp, live media portion 503 may correspond to a 1:00:30 timestamp, live media portion 504 may correspond to a 1:01:00 timestamp, live media portion 505 may correspond to a 1:01:30 timestamp, and live media portion 506 may correspond to a 1:02:00 timestamp. While streaming, client device 533 which may utilize results from media analysis system 508, may determine that portions 504 and 505 are considered key event 507. In response to determining that portions 504 and 505 are considered key event 507, client device 533, which may run media analysis system 508, may begin to extract relevant key event metadata 510.

In some embodiments, key event metadata 510 may comprise of metadata for both live media portion 504 as live media metadata 511 and live media portion 505 as live media metadata 512. In some implementations, key event metadata 510 may further comprise metadata indicative of key players, actors, gameplays, critical decisions, or goals identified in key event 507. In some implementations, client device 533, which may utilize results from media analysis system 508, may also determine a textual summary of the content in the portion of the live stream considered a key event. For example, if a key event comprises of a one-handed catch from a football game, then results media analysis system 508 may indicate an attribute attached to key event metadata 510 indicating “Summary: one-handed catch” on the respective key event. In some implementations, key event metadata 510 is being determined for results of media analysis system 508 by a server, media/audio encoder 509 may encode media, video, audio, or any other data necessary to encoding key event 507 as encoded key event data 515. Live CMAF packager 513 may package relevant key event metadata 514 and encoded key event data 515 into media/audio segments 516 and manifest stream 517. Manifest stream 517 may describe how live media event 501 may be delivered to a viewing device. Manifest stream 517 may comprise data indicative of a particular period 519, 520, a starting point for a particular period 521, 522, an attribute indicating key event status for a particular period 523, 524, and adaptation sets for a particular period 525, 526, 527, 528.

In some embodiments, manifest stream 517 may be used at step 531 to store key event related data into database of key events 532. In some implementations, adaptation sets 527, 528 may be stored in database of key events 532 because attribute 524 indicates that adaptation sets 527, 528 associated with period 520 are considered key events. In some implementations, adaptation sets 525, 526 are not stored in database of key events 532 because attribute 523 indicates that adaptation sets 525, 526 associated with period 519 are not considered key events.

FIG. 6 illustrates a system 600 for executing a computer vision and audio analysis process 603 to identify key events of a live content stream 601 and 602 at the live event on-site uplink 611, in accordance with some embodiments of this disclosure.

In some embodiments, the CV system 603 is located within television broadcaster live event on-site uplink 611, which refers to the process an equipment uses to transmit live video and audio from the location of an event. The live event on-site uplink 611 receives raw video 601 (e.g., MP4, MOV, MKV, WMV, FLV, MPEGAVI, ProRes, H.265, etc.) and raw audio 602 (e.g., WAV, AIFF, PCM, BWF, FLAC, ALAC, APE, etc.) from a camera system at the live event. For example, raw video and audio is sent directly from a camera recording a football game to a connected processing equipment that encodes the raw video and audio.

In some embodiments, the processing live event on-site uplink 611 encodes raw video 601 via video encoder 604 into encoded video data 608. Likewise, the processing live event on-site uplink 611 may also encode raw audio 602 via audio encoder 605 into encoded audio data 607. Live event on-site uplink 611 may multiplex the encoded video 608 and encoded audio 607 using multiplexer 609.

In some embodiments, live event on-site uplink 611 uses CV system 603 to generate metadata describing raw video 601 and raw audio 602. In some embodiments, the CV system may implement an A/V time synchronizer to match the metadata with segments of video and audio. In some embodiments, the generated metadata identifies the existence of a key event in the media stream. The generated metadata may also include the start time of the key event. The generated metadata may also describe the type of key event and key players during the key event, among other descriptive data.

In some embodiments, multiplexer 609 multiplexes encoded video 608, encoded audio 607, and key event metadata 606 together to a single multiplexed stream 610. Multiplexed stream 610 is then sent to satellite transponder uplink 612 to be transmitted at 613 to an external headend or server 614 to be distributed.

External headend or server 614 may be one or a plurality of broadcaster headends or servers as described in para [0051]. External headend or server 614 may also be a satellite system that receives multiplexed stream 610 from satellite transponder uplink 612 to be sent to a broadcaster headend for processing. External headend or server 614 may then distribute at 615 multiplexed stream 610 to a television broadcaster headend 616 for processing.

FIG. 7 illustrates a system 700 for executing a computer vision and audio analysis process 714 to identify key events of a live content stream at a broadcaster headend 725, in accordance with some embodiments of this disclosure. In some embodiments, broadcaster headend 725 corresponds to server 102 in FIG. 1

Live event television broadcaster on-site feed 701 may refer to raw video and raw audio from an on-site camera that has already been encoded and multiplexed into multiplexed stream 702, as explained in FIG. 6.

External headend or server 703 (corresponding to external headend or server 614) may be a satellite server that receives multiplexed stream 702 from the live event on-site 701 and processes it into multiplexed stream 704 to be sent satellite receiver downlink 705 at broadcaster headend 725.

In some embodiments, broadcaster headend 725 receives multiplexed stream 702 via satellite receiver downlink 705 from satellite server 703. Broadcaster headend 725 may send multiplexed stream 706 received from satellite receiver downlink 705 to demultiplexer 707 to demultiplex the stream into encoded video 708 and encoded audio 709. Broadcaster headend 725 may use video decoder 710 to decode encoded video 708 into raw video 712. Likewise, broadcaster headend 725 may use audio decoder 711 to decode encoded audio 709 into raw audio 713.

In some embodiments, broadcaster headend 725 may input raw video 712 and raw audio 713 into CV system 714. Functions of CV system 714 may correspond to functions of CV system 603, as described in FIG. 6. CV system 714 may output key event metadata 717 (corresponding to key event metadata 606). In some embodiments, the CV system may implement an A/V time synchronizer to match the metadata with segments of video and audio. In some embodiments, the generated metadata identifies the existence of a key event in the media stream. The generated metadata may also include the start time of the key event. The generated metadata may also describe the type of key event and key players during the key event, among other descriptive data.

In some embodiments, broadcaster headend 725 may encode raw video 712 via video encoder 715 into encoded video. Likewise, broadcaster headend 725 may encode raw audio 713 via audio encoder 716 into encoded audio. Broadcaster headend 725 may multiplex the encoded video, encoded audio, and key event metadata 717 using multiplexer 718 (corresponding to multiplexer 609) into a single multiplex stream 719. In some embodiments, broadcaster headend 726 may use satellite transponder uplink 720 to process the multiplexed stream 719 and send the stream to an external headend or server 722. External headend or server 722 may be one or a plurality of broadcaster headends or servers as described in para [0051]. External headend or server 722 may also be a satellite system that receives multiplexed stream 721 from satellite transponder uplink 720 to be sent to a broadcaster headend for processing. External headend or server 722 may then distribute at 723 multiplexed stream 719 to another broadcaster headend 724 for distribution.

In some embodiments, the CV system is performed at the broadcaster headend with the incoming feed demultiplexed, the video PES and audio PES are decoded and the decoded video and audio are routed into the computer vision and audio analysis system (CV system) which generates the MPEG 7 or KLV metadata for the key event.

In some embodiments, the CV system may output the analyzed decoded raw video to the video encoder and the decoded raw audio to the audio encoder where the video and audio are reencoded to the broadcaster's distribution specifications.

In some embodiments, the encoded video, encoded audio, and MPEG 7 or KLV metadata is then sent to the MP2TS multiplexer which is multiplexed together and distributed via satellite and OTA or fixed line network to the cable, IPTV, and OTT headends.

In some embodiments, broadcaster headend 725 may be in the same network as broadcaster headend 724.

FIG. 8 illustrates a system 800 for executing a computer vision and audio analysis process 813 and 831 to identify key events of a live content stream at OTT headend 841 or IPTV, OTA, satellite or cable headend 801, in accordance with some embodiments of this disclosure. In some embodiments, headend 841 corresponds to server 102 in FIG. 1. In some embodiments, headend 801 corresponds to server 102 in FIG. 1.

In some embodiments, the operator employs the computer vision and audio analysis system (CV system) in the IPTV, cable TV, satellite, OTA affiliate, or OTT headends. This approach is like the broadcaster headend approach, as described in FIG. 7. The incoming broadcast multiplexed MP2TS audio and video stream is received in the headend via satellite or a fixed line network, as described in FIG. 7.

In IPTV, OTA, satellite, and cable embodiments, broadcaster headend 801 receives multiplexed stream 803 via satellite receiver downlink 804 from satellite server 802. Broadcaster headend 801 may send multiplexed stream 805 received from satellite receiver downlink 804 to demultiplexer 806 to demultiplex the stream into encoded video 807 and encoded audio 808. Broadcaster headend 801 may use video decoder 809 to decode encoded video 807 into raw video 811. Likewise, broadcaster headend 801 may use audio decoder 810 to decode encoded audio 808 into raw audio 812.

In IPTV, OTA, satellite, and cable embodiments, broadcaster headend 801 may input raw video 811 and raw audio 812 into CV system 813. Functions of CV system 813 may correspond to functions of CV system 603 and CV system 714, as described in FIG. 6. CV system 813 may output key event metadata 814 (corresponding to key event metadata 606 and key event metadata 717). In some embodiments, the CV system may implement an A/V time synchronizer to match the metadata with segments of video and audio. In some embodiments, the generated metadata identifies the existence of a key event in the media stream. The generated metadata may also include the start time of the key event. The generated metadata may also describe the type of key event and key players during the key event, among other descriptive data.

In IPTV, OTA, satellite, and cable embodiments, broadcaster headend 801 may encode raw video 811 via video encoder 815 into encoded video 817. Likewise, broadcaster headend 801 may encode raw audio 812 via audio encoder 816 into encoded audio 817. Broadcaster headend 801 may multiplex the encoded video, encoded audio, and key event metadata 818 using multiplexer 818 (corresponding to multiplexer 609 and multiplexer 718) into a single multiplex stream 819. In some embodiments, broadcaster headend 801 send multiplexed stream 819 to the client.

In OTT embodiments, OTT headend 841 receives multiplexed stream 821 via satellite receiver downlink 822 from satellite server 820. Broadcaster headend 841 may send multiplexed stream 823 received from satellite receiver downlink 822 to demultiplexer 824 to demultiplex the stream into encoded video 825 and encoded audio 826. Broadcaster headend 841 may use video decoder 827 to decode encoded video 825 into raw video 829. Likewise, broadcaster headend 841 may use audio decoder 828 to decode encoded audio 826 into raw audio 830.

In OTT embodiments, OTT headend 841 may input raw video 829 and raw audio 830 into CV system 831. Functions of CV system 831 may correspond to functions of CV system 603, CV system 714, and CV system 813, as described in FIG. 6. CV system 831 may output key event metadata 832 (corresponding to key event metadata 606, key event metadata 717, and key event metadata 814). In some embodiments, the CV system may implement an A/V time synchronizer to match the metadata with segments of video and audio. In some embodiments, the generated metadata identifies the existence of a key event in the media stream. The generated metadata may also include the start time of the key event. The generated metadata may also describe the type of key event and key players during the key event, among other descriptive data.

In OTT embodiments, OTT headend 841 may encode raw video 829 via video encoder 833 into encoded video 837. Likewise, broadcaster headend 841 may encode raw audio 830 via audio encoder 834 into encoded audio 836. Broadcaster headend 841 may package the encoded video, encoded audio, and key event metadata 832 using live CMAF packager 837 and store the packets on a CDN. Live CMAF packager 837 may also segment the encoded video and encoded audio into ABR laddered video segments 838 and ABR laddered audio segments 839. Live CMAF packager 837 may also generate manifest stream 840 (in MPEG-DASH or HLS). Manifest stream 840 may have indicators of key events based on key event metadata 832.

In some embodiments, the MP2TS stream is demultiplexed and the audio PES is sent to the audio decoder and video PES is sent to the video decoder. The decoded video and audio streams are sent to the CV system which generates MPEG 7 or KLV metadata for the key event. In IPTV or cable embodiments, the CV system outputs the raw video and raw audio streams for a video encoder and audio encoder, which encodes the video and audio to the headend video and audio specifications. The key event metadata, along with the audio and video, are multiplexed into a single multiplex stream and then multicast over the cable TV or IPTV headend for set top boxes and TSTV systems. The TSTV system may demultiplex the key event metadata out of the MP2TS for processing, defined later in this specification for TSTV handling of key events.

In OTT embodiments, the raw video and audio may be encoded to the ABR ladder specifications as defined by the OTT headend provider. The output of all video PES and audio PES in the ABR ladder, along with the key event metadata, may be sent to the ABR packager where the packager may multiplex the video streams into a format like CMAF. The audio streams may be multiplexed into a compatible CMAF audio container. The ABR packager may generate a manifest which may include segments identified as key events. These key event segments may be in their own periods. Since the period time length coming into the key event period is not known until the end of the key event is triggered, the period may not include indications of the duration of the period.

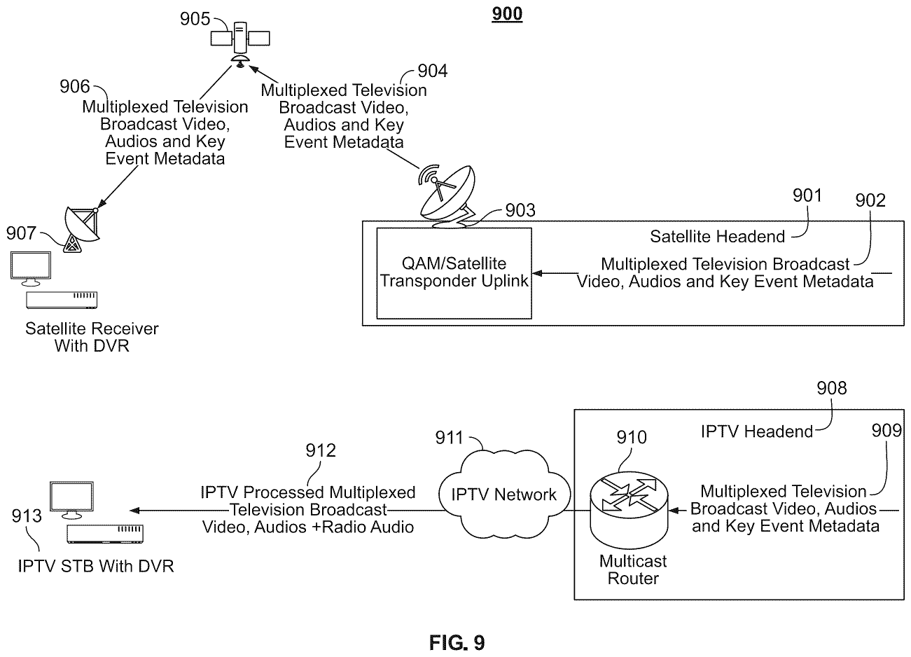

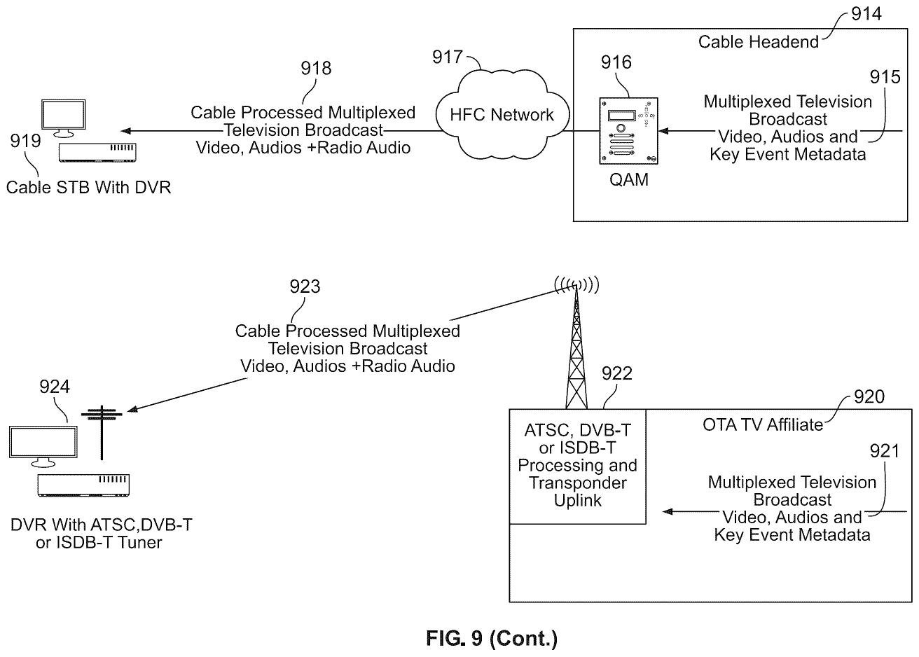

FIG. 9 illustrates a multiplexed audio, video, and key event metadata being delivered to a DVR system via a satellite receiver 907, IPTV set top box 913, cable TV set top box 919, or a home DVR with an OTA receiver 924, in accordance with some embodiments of this disclosure.

A local DVR may receive the live content stream and key event metadata via the IPTV multicast address or the cable STB QAM tuner. The local server receiving the multiplexed video, audio, and key event metadata stream may provide processing by parsing the incoming demultiplexed metadata stream to identify the key events along the timeline of the stream. The DVR may provide processing to create a playlist of the key events from the captured stream during a recording session, or after a recording session.

The DVR may also extract I-frame intra pictures from the recorded stream along the key event metadata identified timeline. These Intra pictures may be decoded and presented on a display timeline for a scroller or scrubber to navigate the TSTV or captured stream.

In satellite embodiments, satellite server 901 receives multiplexed video, audio, and key event metadata stream 902 and processes the multiplexed stream to be sent to a satellite 905 via QAM/satellite transponder uplink 903. QAM/satellite transponder uplink 903 may send the processed multiplexed stream 904 to satellite 905, which may adjust the multiplexed stream 906 into specifications receivable by satellite receiver 907. Satellite receiver 907 may be configured to record the media stream via a DVR.

In IPTV embodiments, IPTV server 908 receives multiplexed video, audio, and key event metadata stream 909 and processes the multiplexed stream to be sent through an IPTV network 911 via multicast router 910. Multicast router 910 may send the processed IPTV-compliant multiplexed stream 912 to a client IPTV set top box 913 via the IPTV network 911. IPTV STB 913 may be configured to record the media stream via a DVR.

In cable embodiments, cable server 914 receives multiplexed video, audio, and key event metadata stream 915 and processes the multiplexed stream to be sent through an HFC network 917 via QAM 916. QAM 916 may send the processed cable-compliant multiplexed stream 918 to a client cable set top box 919 via the HFC network 917. Cable STB 919 may be configured to record the media stream via a DVR.

In OTA embodiments, OTA TV affiliate server 920 receives multiplexed video, audio, and key event metadata stream 921 and processes the multiplexed stream to be sent through a OTA or radio network via an ATSC, DVB-T, or ISDB-T processing and transponder uplink 922. OTA transponder uplink 922 may send the processed OTA affiliate-compliant multiplexed stream 923 to an OTA tuner 924 (e.g., ATSC, DVB-T, or ISDB-T tuner) via the over-the-air signals. OTA tuner 924 may be configured to record the media stream via a DVR.

FIG. 10 illustrates an internal DVR system 1000 for replay of a received video, audio, and key event metadata stream, in accordance with some embodiments of this disclosure.

In OTA embodiments, multiplexed video, audio, and key event metadata stream 1002 may be received by ATSC, DVB-T, or ISDB-T receiver 1004. Receiver 1004 may send the multiplexed stream to DVR or any other current channel TSTV capture system 1014.

In satellite embodiments, multiplexed video, audio, and key event metadata stream 1002 may be received by satellite transponder 1006. Satellite transponder 1006 may send the multiplexed stream to DVR or any other current channel TSTV capture system 1014. Satellite transponder 1006 may receive from DVR or any other current channel TSTV capture system 1014 a tuning input to force tune to a certain channel on the satellite network.

In cable embodiments, multiplexed video, audio, and key event metadata stream 1002 may be received by cable QAM tuner 1008. Cable QAM tuner 1008 may send the multiplexed stream to DVR or any other current channel TSTV capture system 1014. Cable QAM tuner 1008 may receive from DVR or any other current channel TSTV capture system 1014 a tuning input to force tune to a certain channel on the satellite network.

In IPTV embodiments, multiplexed video, audio, and key event metadata stream 1002 may be received by IPTV multicast socket 1010. IPTV multicast socket 1010 may send the multiplexed stream to DVR or any other current channel TSTV capture system 1014. IPTV multicast socket 1010 may receive from DVR or any other current channel TSTV capture system 1014 a tuning input to force tune to a certain channel on the satellite network.

In some embodiments, capture system 1014 may receive a recording schedule 1016 of OTA, satellite, cable, or IPTV channels.

In some embodiments, capture system 1014 may comprise of a file writer 1012 which is configured to store multiplexed streams into database storage 1018. Database storage 1018 may be located within a broadcaster server, on the DVR or capture system device, on the client device, within a client application or client server, or on another external server such as a CDN server. System 1000 may store recorded events in database 1018 for the purpose of replay. Database 1018 may also have stored I-Frames of key events and current streams of buffered TSTV or scheduled recorded events. In some embodiments, a key event is stored when the key event metadata indicates that a segment from the received stream is a key event. In some embodiments, the DVR may refrain from storing key events if the system is configured to pause storing of key events. In other embodiments, the DVR may store key events in a buffer or other temporary storage in database 1018. In yet other embodiments, the key events may be stored in permanent memory in database 1018.

In some embodiments, a TS stream controller and key event playout system 1022 is configured to retrieve the current multiplex stream of video, audio, and key event data from database 1018. The controller and key event playout system 1022 may receive a client request 1024 to replay a key event with an identifier of which key event to replay. In some embodiments, controller and key event playout system 1022 may receive remote input 1026 of a stream trick mode or navigation button press event.

In some embodiments, system 1000 may also comprise of key event database 1034 in which key event metadata are temporarily or permanently stored. In some embodiments, controller and key event playout system 1022 sends the multiplexed stream of video, audio, and key event metadata to MP2TS demultiplexer 1028. Demultiplexer 1028 demultiplexes the stream into encoded video and encoded audio, which is sent to video decoder and audio decoder 1036, and key event metadata. The key event metadata prompts system 1000 to capture key event I-frames 1030 and stores the key event I-frames 1020 in database 1018. In some embodiment, the demultiplexer 1028 sends the key event metadata to a key event handler 1032 which initiates the capture and storing of key event I-frames, as described previously. Key event handler 1032 may send the key event metadata for storage in key event database 1034. The stored key event metadata may have pointers to key event I-frame locations 1020 in database 1018. When prompted to replay key events, database 1018 sends key event I-frames 1020 to controller and key event playout system 1022. In some embodiments, key event database 1034 may send specific key event data such as the key event start time, image file mapping, key event end time, event identifier, or additional key event descriptive data to controller and key event playout system 1022. The specific key event data may help controller and key event playout system 1022 navigate to key events during the stream via the start times or I-frames retrieved from the frame mappings. Controller and key event playout system may send the media navigation controls (either from client request 1024 or from remote input 1026) to player control renderer 1040 which processes the request to be inputted into a video and audio renderer 1038 on the client. Video and audio renderer 1038 may receive decoded video and decoded audio from decoder 1036 to stream on the client.

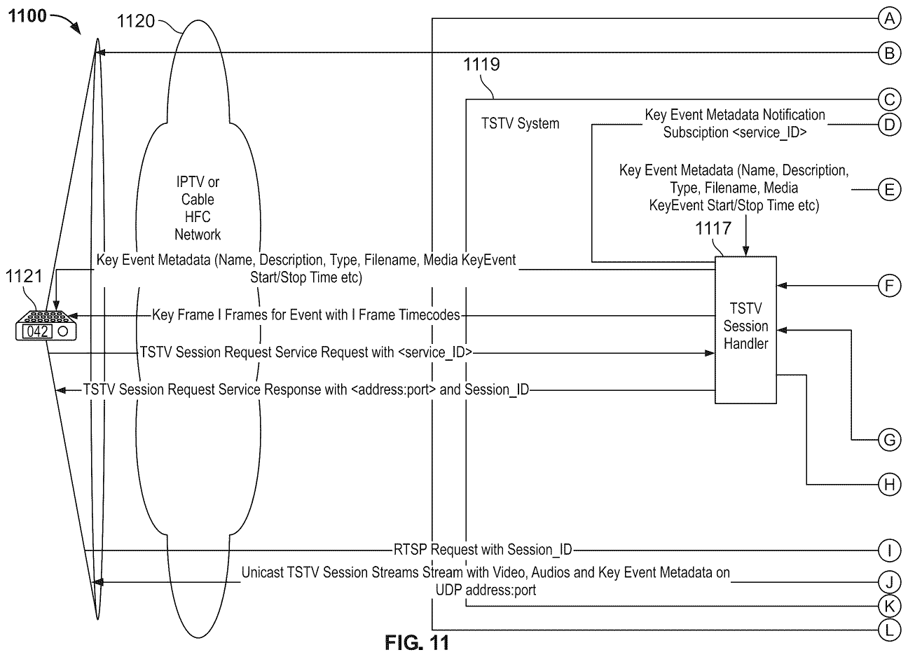

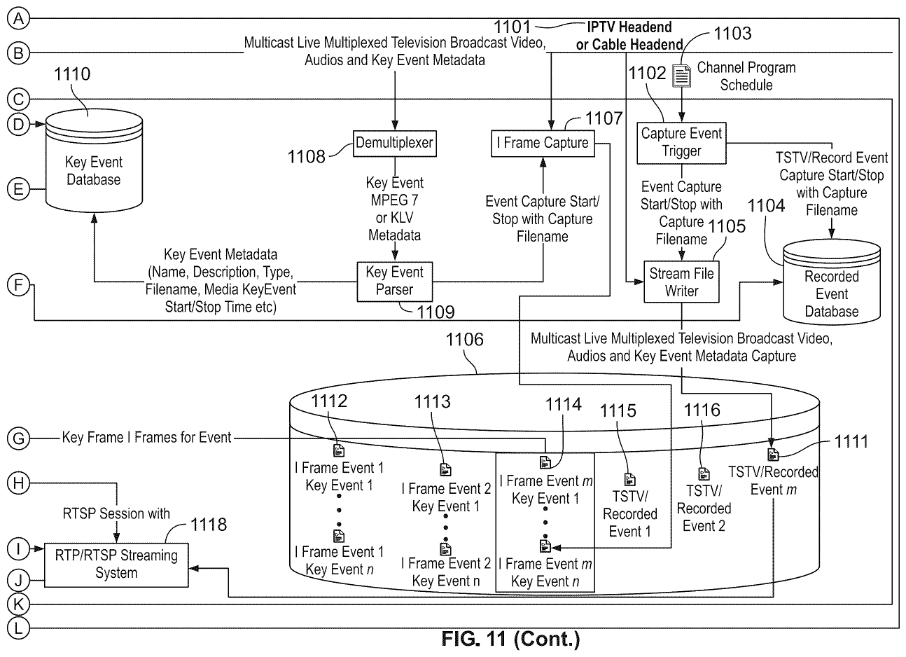

FIG. 11 illustrates a TSTV or network PVR system 1100 for replay of a received video, audio, and key event metadata, and implementation of key event features, in accordance with some embodiments of this disclosure. Replay of received video may correspond to playback of key event 120 in a higher quality, as described in FIG. 1.

IPTV and cable TV media distribution may be handled differently than OTT media distribution and ABR client devices. In IPTV and cable headend embodiments, the media distribution system may deliver the live content stream with the multiplexed metadata to a set top box and send the live content stream to the IPTV or cable TSTV system. The TSTV system may demultiplex the metadata as the stream is received from the transport stream and save the metadata in a file associated with the stream. The TSTV system may extract I-frames or generate an image at the start of the key event. When the TSTV system receives a request from a STB to navigate the TSTV stream, the extracted I-frames may be shown in a timeline display, along with text summary descriptions for key events up until the current live timepoint in the stream. The images may be shown above a scroll bar for the video for rewinding back from current time. The images of the key events may also be selected via user input on the client device to view the key events for the time duration of the key event. The TSTV system may also provide a playlist of all key events up until the current time live stream.

Set top box 1121 may send a TSTV session request to TSTV session handler 1117, with a session identifier. TSTV session handler 1117 may send a service response with an address and session identifier back to set top box 1121. Set top box 1121 may receive key event metadata (e.g., name, description, type, filename, media key event start and stop times) and related key event I-frames with timecodes from TSTV session handler 1117. TSTV session handler 1117 may interact with key event database 1110 (corresponding to key event database 1034) to send request (e.g., notification or subscription with a service identifier) to retrieve key event metadata for a specific key event to be replayed. The TSTV session handler 1117 may use the key event metadata to identify key event I-frames 1114 from I-frame database 1106 (corresponding to database 1018) and retrieve them from storage for display on the client (in this case, the set top box 1121). In some embodiments, TSTV session handler 1117 may send an RTSP session request to an RTP/RTSP streaming system. In other embodiments, the RTSP session request may be sent from the set top box 1121. In other embodiments, TSTV session handler 1117 may send the RTSP session from the recorded event database to the RTP/RTSP streaming system 1118. RTP/RTSP streaming system 1118 may send the unicast TSTV session stream with video, audio, and key event metadata to the set top box 11221. In some embodiments, the set top box 1121 may receive a multicast of live multiplexed stream of video, audio, and key event metadata from an external headend or server.

In TSTV or NPVR embodiments, the multiplexed stream may be demultiplexed at 1108 and sent to a key event parser 1109. The multiplexed stream may also be used to extract I-frames 1112, 1113, 1114, and 1116 via an I-frame capture system at 1107 and stored in the I-frame database 1106. The multiplexed stream may also be sent to a stream file writer 1105 that stores TSTV recorded events 1115, 1116, and 1111 in database 1106. In some embodiments, channel program schedule 1103 triggers the system to capture events at 1102 and sends the event capture to stream file writer 1105. In some embodiments, the TSTV/recorded event capture is sent to recorded event database 1104.

In some TSTV or NPVR embodiments, key event database 1110 is located within the IPTV headend or cable headend. In some embodiments, recorded event database 1104 is located within the IPTV headend or cable headend. In some embodiments, I-frame database 1106 is located within the IPTV headend or cable headend.

In some TSTV or NPVR embodiments, the demultiplexer 1108, I-frame capture system 1107, stream file writer 1105, session handler 1117, and streaming system 1118 is processed within the IPTV headend or cable headend.

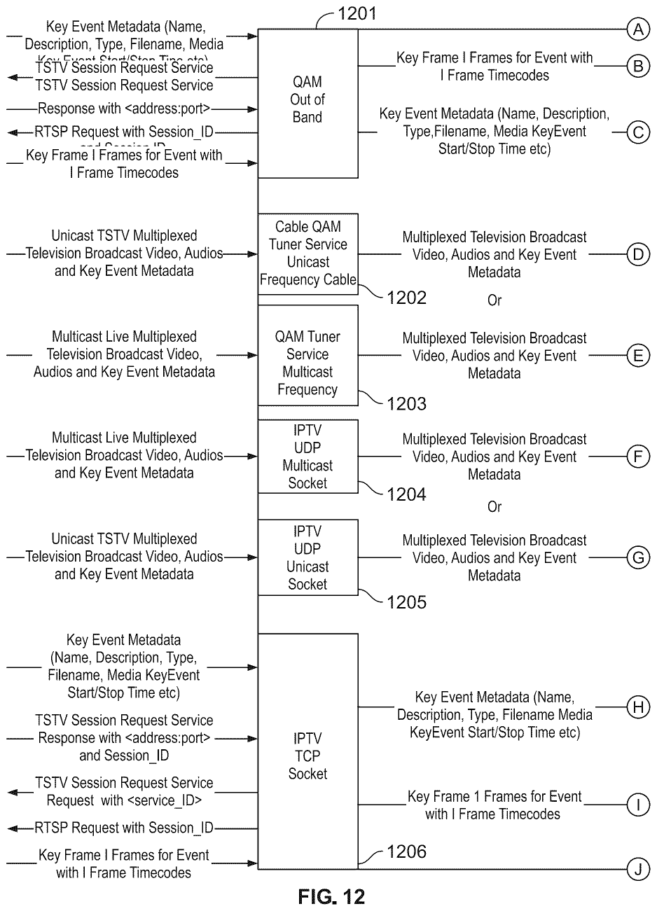

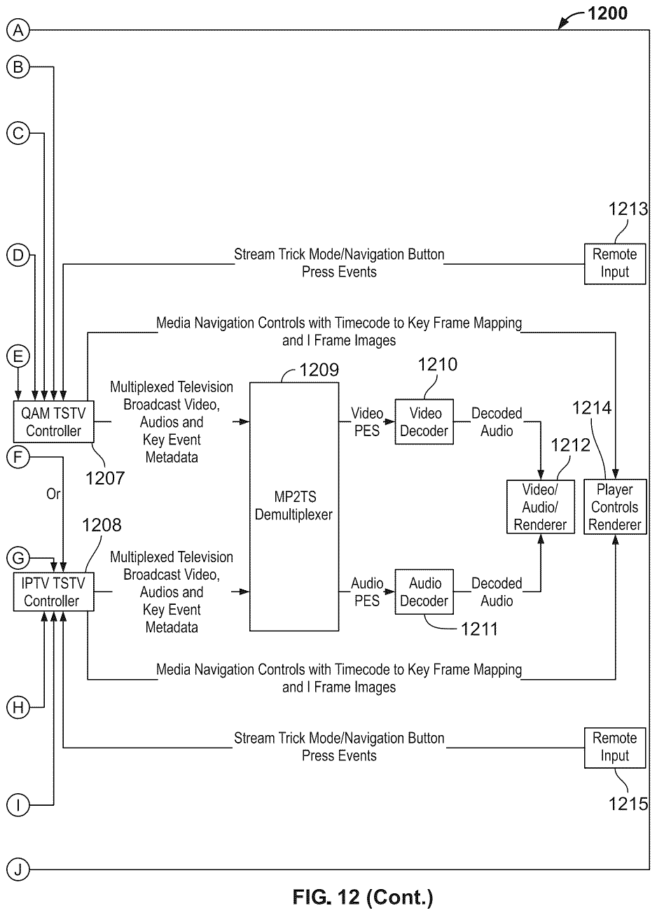

FIG. 12 illustrates an IPTV or cable STB system 1200 for replay of a received video, audio, and key event metadata, and implementation of key event features, in accordance with some embodiments of this disclosure. Replay of received video may correspond to playback of key event 120 in a higher quality, as described in FIG. 1.

In cable and IPTV embodiments, a QAM TSTV or IPTV TSTV controller 1207 retrieves multiplexed video, audio, and key event metadata streams from one or a plurality of QAM out of band servers 1201, cable QAM tuner for service unicast/multicast frequency 1202 and 1203, IPTV UPD unicast/multicast sockets 1204 and 1205, among other tuner and input sockets. TSTV controller 1207 may also receive key event metadata (e.g., name, description, type, filename, media key event start and end times, etc.) and key event I-frames with timecodes from IPTV TCP socket 1206.

In cable and IPTV embodiments, TSTV controller 1207 sends the multiplexed metadata to be demultiplexed into video PES and audio PES via MP2TS demultiplexer 1209. Video decoder 1210 and audio decoder 1211 may decode the video and audio and combine them into a stream via video and audio renderer 1212. In some embodiments, a player control render 1214 may receive media navigation controls and adjust the playback of the video and audio stream. In other embodiments, remote inputs 1213 and 1215 may trigger trick mode or navigation events, as described in FIG. 10. Remote input 1215 may correspond to remote input 1026. Player controls renderer 1214 may correspond to player controls renderer 1040.

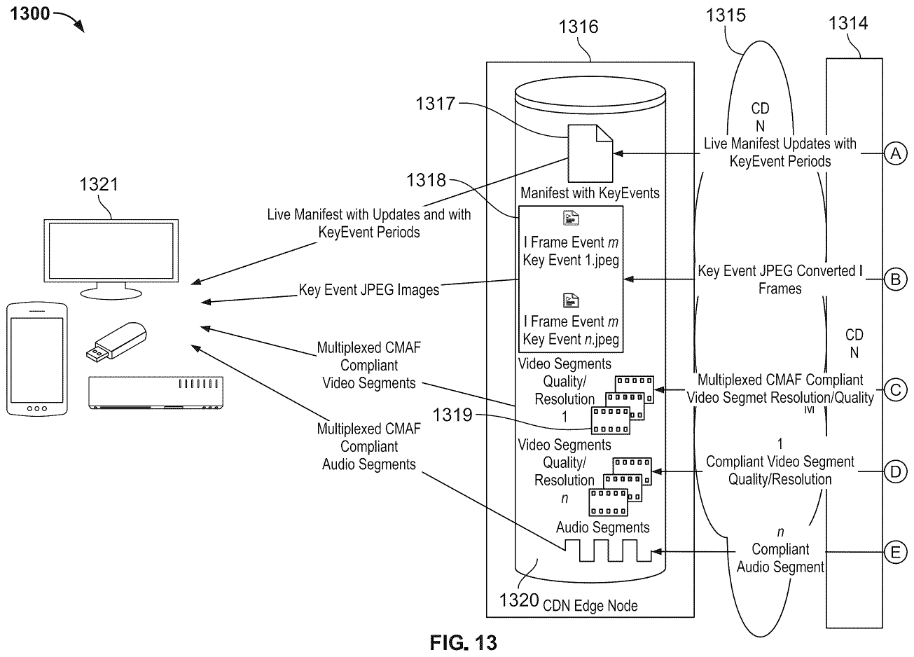

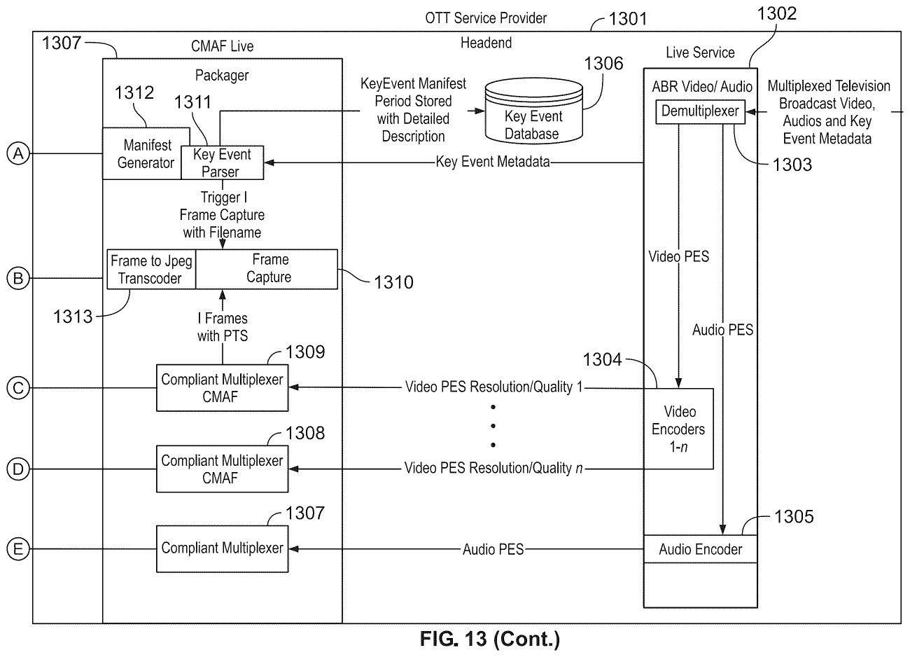

FIG. 13 illustrates an OTT system architecture 1300 to generate key event manifests, corresponding to manifest 106 in FIG. 1, in accordance with some embodiments of this disclosure.

In OTT embodiments, an OTT application on a HDMI stick, phone/tablet, smartTV, game console, etc. may provide the same type of key event replay experience implemented in an OTT ABR client device. System 1300 may create a live manifest with identified periods for the Key Events. The OTT application may provide a list of key events identified from a manifest. For each key event, an Intra picture may be made available to the client device. The client device may download the lowest quality of the first segment for each identified key event in the manifest and extract the IDF frame from that segment to be shown with the key event. This key event image may be shown above the scroll bar or provided in a list of key events. When the client receives a replay request to watch a key event, the client player may automatically start downloading and playing the segments in the key event until the end of the period for the key event. The time-shift may also continue playing the content once the Key Event playout is completed. The OTT ABR case may offer additional functionality over the IPTV, Cable or DVR system. Since ABR dynamically adjusts to a calculated bandwidth when playing video, the user may wish to watch key events in the absolute highest quality represented in the manifest for the duration of the key event regardless of the bandwidth available to the client device. This may be provided as a user option. In the case the user has selected to watch the key event in the highest quality, the ABR client may begin downloading the first segment of the key event when the user selects or time shifts backwards to the beginning or somewhere in the middle of a key event. At this point, the ABR client device may begin downloading the highest quality user selected segment to begin playout for the selected period of the key event. A bandwidth calculation may be made during that segment download. If the bandwidth is high enough to begin and continue playout at the highest quality, the rendering of the highest quality segment may begin immediately. If the calculated bandwidth is too low to play the key event in its entirety, the calculation may be made on how many segments must be buffered to begin playout for the highest quality and continue in the highest quality until the end of the key event. In some cases, the bandwidth may be so low requiring the client to download all segments for the key event provided the key event is over. If the key event is not yet complete when the user rewinds, the initial segment download may begin and the bandwidth may be calculated during the initial segment download. If the initial segment download bandwidth calculation is determined to be too low, the client device may continue buffering all highest quality segments as they are produced by the packager and made available on the CDN until the key event period ends. Once the end of the period is reached for the downloaded segments, the replay of the key event may begin with the highest quality downloaded ABR segments. If the typical size of the ABR client buffer is 3 segments, once there are only 2 highest quality key event segments left in the buffer, the next segment may be downloaded and the bandwidth calculation may be made during the download of that segment and normal ABR playout may continue as is known in the art. In some embodiments, the key event image for the timeline may be embedded as another adaptation set within the key event period.

OTT service provider headend 1301 receives multiplexed television broadcast video, audio, and key event metadata from an external headend or server. At 1302, OTT service provider 1301 demultiplexes the multiplexed stream using demultiplexer 1301, encodes the demultiplexed video with video encoder 1304, and encodes the demultiplexed audio with audio encoder 1305. At 1302, OTT service provider headend 1301 uses demultiplexer 1303, video encoder 1304, and audio encoder 1305 to create ABR video and audio in real time during the live streaming. OTT service provider headend 1301 sends the key event metadata from the demultiplexed stream to frame capture system 1310. Frame capture system 1310 retrieves multiple versions of the video in different qualities. For example, the frame capture system may receive video in a first quality 1308 and video in a second quality 1309. Frame capture system 1301 may also retrieve the encoded audio 1307 of the live stream that correlates to the retrieved video. In some embodiments, frame capture system 1310 identifies whether a portion of the live stream has a key event based on the key event metadata. The frame capture system may send the portions of retrieved video (of multiple qualities) and audio to manifest generator 1312. Manifest generator 1312 may use a key event parser 1311 that sends video and audio of identified key events to be stored in key event database 1306. At 1314, OTT service provider 1301 sends the live manifest updates with key event periods, key event converted I-frames, multiplexed CMAF compliant video segments in different qualities, and multiplexed CMAF compliant audio segments to a CDN edge node 1316. In some embodiments OTT service provider 1301 sends the above listed data via CDN 1314 and 1315. CDN edge node 1316 may send the live manifest 1317, I-frames of the key event 1318, different quality video segments 1319, and audio segments 1320 to the client device 1312 (e.g., television, smartphone, set top box, other storage or display device).

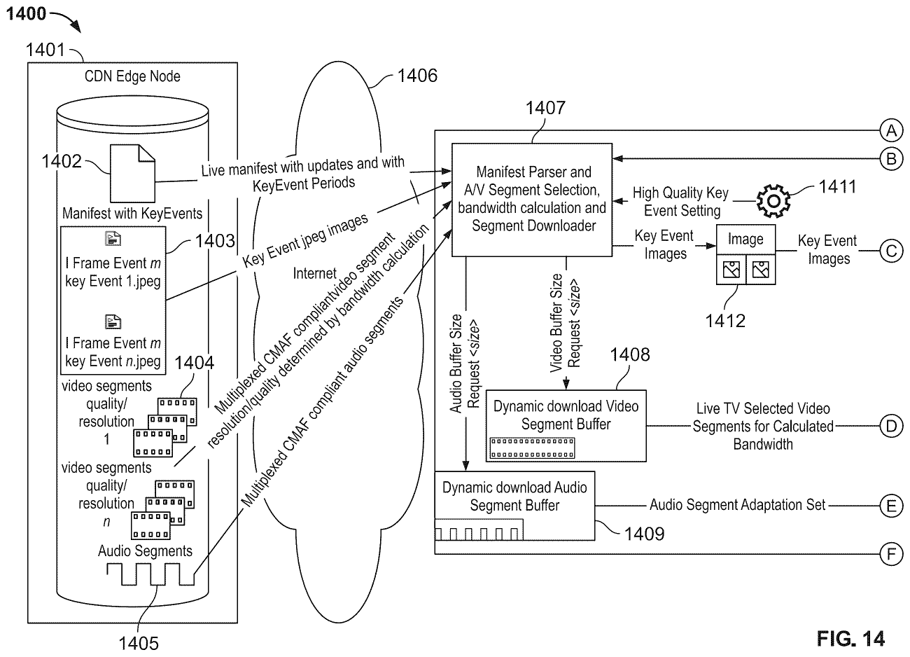

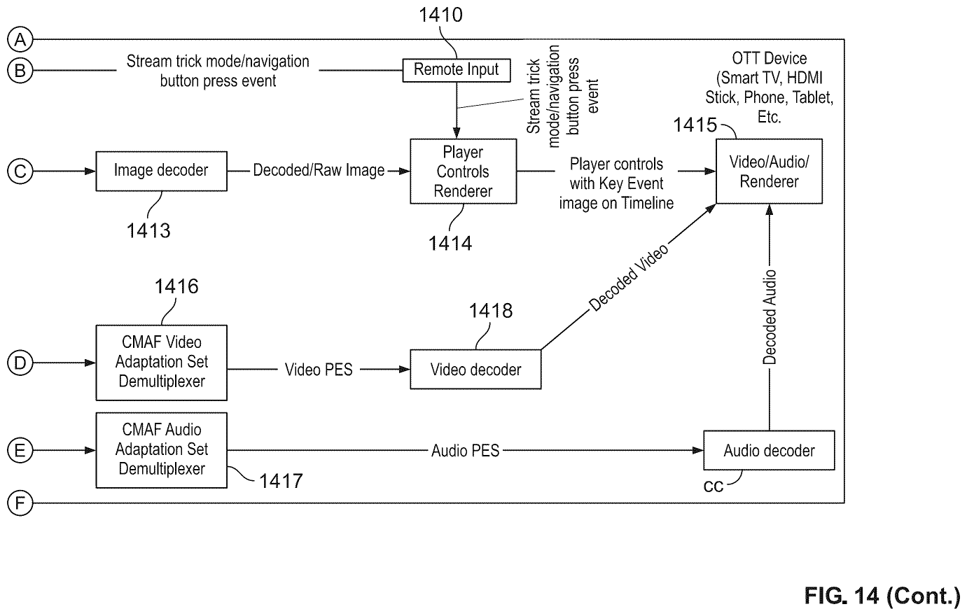

FIG. 14 illustrates an OTT/ABR device 1400 supporting key event playouts, in accordance with some embodiments of this disclosure. Key event playouts may correspond to playback of key event 120 in a higher quality, as described in FIG. 1.

Manifest file 1402, I-frames of key event 1403, different quality video segments 1404, and audio segments 1405 are sent to the OTT client device (e.g., smart TV, HDMI stick, phone, tablet, etc.) from CDN edge node server 1401 via the internet 1406. Manifest file 1402 may be a live manifest with updates and key event periods. I-frames of key event 1403 may be retrieved from a database corresponding to database 1106 located within CDN edge node 1401. Video segments 1404 may be multiplexed into a CMAF compliant video segment with resolution/quality determined by bandwidth calculation in ABR embodiments. Audio segment 1405 may be also multiplexed into a CMAF compliant audio segment. The OTT client device receives manifest file 1402, I-frames 1403, video segments 1404, and audio segments 1405 via manifest parse 1407. Manifest parser 1407 may be coupled with an A/V segment selector, bandwidth calculator, and segment downloader. Manifest parser 1407 may receive remote input 1410 that indicates a replay, trick mode, or navigation from a user button press event. Manifest parser 1407 may also receive a setting 1411 from the client device that indicates the quality that the content stream should be loaded. In some embodiments, setting 1411 indicates the quality that the key event should be loaded. Manifest parser 1407 sends key event images 1412 to an image decoder 1413. Image decoder 1413 sends the decoded raw images to a player controls renderer 1414 which sends key event images to video/audio renderer 1415 to output on the client device. In some embodiments, manifest parser 1407 may also send a video buffer size request to a dynamic download video segment buffer 1408 and an audio buffer size request to a dynamic download audio segment buffer 1409. The video buffer 1408 sends live TV selected video segments for calculated bandwidth to a demultiplexer 1416, which sends packeted video streams to video decoder 1418. Video decoder 1418 sends the decoded video to video/audio renderer 1415 to output on the client device. The audio buffer 1409 sends the audio segment adaptation set to audio demultiplexer 1417, which sends packeted audio streams to audio decoder 1419. Audio decoder 1419 sends the decoded audio to video/audio renderer 1415 to output on the client device.

In OTT ABR live event embodiments, the client may monitor manifest metadata and key event markers provided by the content server, which indicate when key moments (e.g., goals, touchdowns, dramatic plot points) are happening. For example, a live sports event feed might include markers when a goal is scored, triggering the client to pre-cache the next few seconds or minutes at higher quality.

Based on the type of content being streamed (e.g., live sports, concerts), the client may predict likely key events (e.g., the final minutes of a close game) and prepare to pre-cache those segments.

When the user replays a key event, the OTT client device instantly switches to the pre-cached high-quality segment, providing a seamless and high-resolution playback experience.

The invention is directed towards a system and method for enhancing the delivery of key moments in live streaming through quality-enhanced preloading, leveraging existing Adaptive Bitrate (ABR) streaming specifications such as MPEG-DASH and Apple's HLS. This invention addresses the challenge of delivering high-quality replays of critical moments, such as goals in sports events, in real-time without introducing latency or buffering delays. Traditional ABR streaming systems focus primarily on adapting video quality based on network conditions to maintain continuous playback, but they do not prioritize specific content segments that are more likely to be replayed by users. The proposed system anticipates these user interactions by analyzing real-time data, event markers, and historical behavior to dynamically cache and deliver key segments in the highest available quality.

The system operates by integrating with the existing encoding and distribution workflow used in IPTV, Cable TV, OTA, satellite or OTT ABR streaming. The multiplexer, which is responsible for multiplexing the video, audio and subtitles into a multiplexed live stream, identifies key events during the event through a combination of scene detection algorithms and metadata integration. These key events, such as a goal or a critical play, are then marked within the MPEG-DASH or HLS manifest. For example, in MPEG-DASH, the system may embed periods identified by a key event indicator to signal the occurrence of a key moment. In HLS, EXT-X-DATERANGE tags may be used within the playlist to indicate important time ranges associated with these moments.

Once identified and marked, the system ensures that these key moments are encoded at higher bitrates and with finer granularity in the Group of Pictures (GOP) structure. For instance, the GOP interval may be reduced, and more frequent I-frames may be introduced, allowing for quicker access and better quality during replays. The encoded segments, along with their associated metadata, are then distributed to edge servers within the Content Delivery Network (CDN). The edge servers, equipped with predictive algorithms, analyze regional demand and user interaction patterns to determine the likelihood of specific segments being replayed. Based on this analysis, the edge servers prioritize the caching of high-quality versions of these key segments, ensuring that they are readily available for immediate delivery to users.

The client device plays a critical role in this system by managing localized caching and dynamically switching to high-quality pre-cached segments during replays. The client continuously monitors real-time event markers, user interactions, and network conditions to decide when to preload certain segments. For example, upon detecting a goal event marker embedded within the stream, the client may preemptively cache the subsequent segments at the highest available quality using features like MPEG-DASH's prefetch hints or HLS's EXT-X-PRELOAD-HINT tags. The client's decision-making process also incorporates historical user behavior data, such as the frequency of replays or the typical duration of key moments that are rewatched. By cross-referencing this data with the real-time events, the client may accurately predict which segments the user is likely to replay and pre-cache them accordingly.

When the client receives a replay request, the client instantly switches from the live stream to the pre-cached high-quality segment. This is achieved by leveraging ABR's adaptation mechanisms that allow seamless switching between different representations or adaptation sets. For instance, in MPEG-DASH, the client may transition to a higher-bitrate adaptation set that has been pre-cached specifically for the key moment. Similarly, in HLS, the client may use the EXT-X-DISCONTINUITY tag to smoothly switch to the preloaded high-resolution segment. The client's ability to pre-cache and prioritize these segments ensures that the replay is delivered without buffering, at the highest quality, and with minimal delay.

Additionally, the system supports dynamic quality management by continuously monitoring the network conditions and adjusting the caching strategy accordingly. If the network is stable and bandwidth is sufficient, the client may pre-cache even higher-bitrate segments. Conversely, if network conditions degrade, the system ensures that at least a moderate quality version of the key moment is available for replay, thereby avoiding interruptions in the user experience. The invention also leverages low-latency extensions in ABR specifications, such as Low-Latency DASH (LL-DASH) and Low-Latency HLS (LL-HLS), to further reduce the time between segment generation and availability. By breaking down segments into smaller parts or chunks, the system may begin caching portions of a key moment even before the full segment is encoded, thus enabling near-instantaneous access during replays.

The invention is further enhanced by the integration of edge computing capabilities, where edge servers not only cache high-quality segments but also perform on-the-fly re-encoding based on real-time demand. For example, if an edge server detects a high number of replay requests within a given region, the edge server may dynamically allocate resources to re-encode that segment at an even higher quality or at multiple bitrates, ensuring that all users in that region receive the best possible experience. The client and edge servers work in concert to manage the buffer and ensure that key segments are never evicted prematurely, prioritizing their retention in the cache based on predicted replay likelihood.

In one embodiment, the key event replay may include multiple key events recorded sources. Multiple recorded events from different sources may contain similar key events. For example, the video stream related to the main content is a similar event (e.g., a similar play, such as another touchdown) that occurred in the main content or in a different content (e.g., a different game, such as a different football game), and was identified in near real-time for generating a video that combines the similar events with the main video event.

Many key events within TSTV recorded source streams may be coupled (e.g., displayed on an interface directly or indirectly) with a video search engine that searches databases of content such as key plays. In one embodiment, the search engine may be queried via metadata describing a desired key play (e.g., one-handed catch by Stanford, one-handed catch by Solomon Thomas, etc.). In another embodiment, the search engine may be queried based on a set of images. In such embodiments, at least one video may be retrieved from the query. In similar embodiments, the URL of the video may be retrieved, wherein the URL points to a location on a CDN where the video is stored. The retrieved video or video source (e.g., the video URL) may be fed into a mosaic generation system to generate a video display depicting multiple videos of different key plays. For example, the first video source may be a primary video, while a second video source (depicting a similar play) may be a secondary video. In some embodiments, the secondary video may be scaled down or have a smaller display size than the primary video.

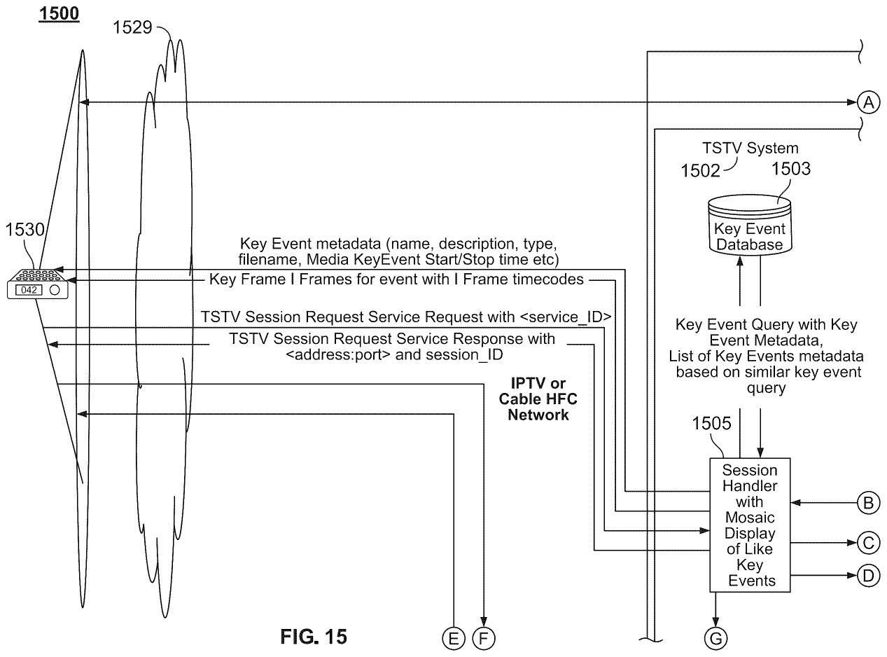

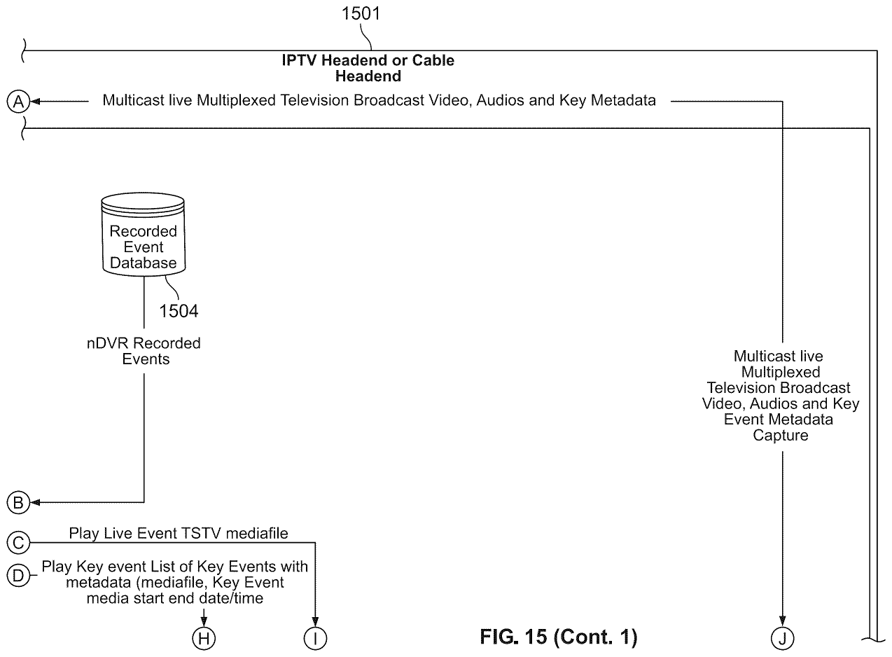

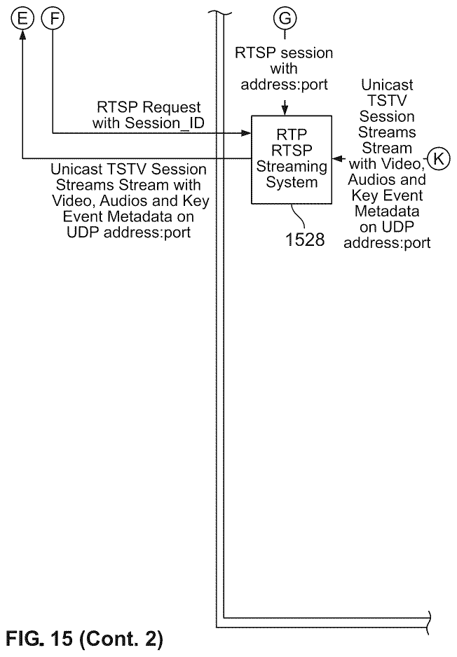

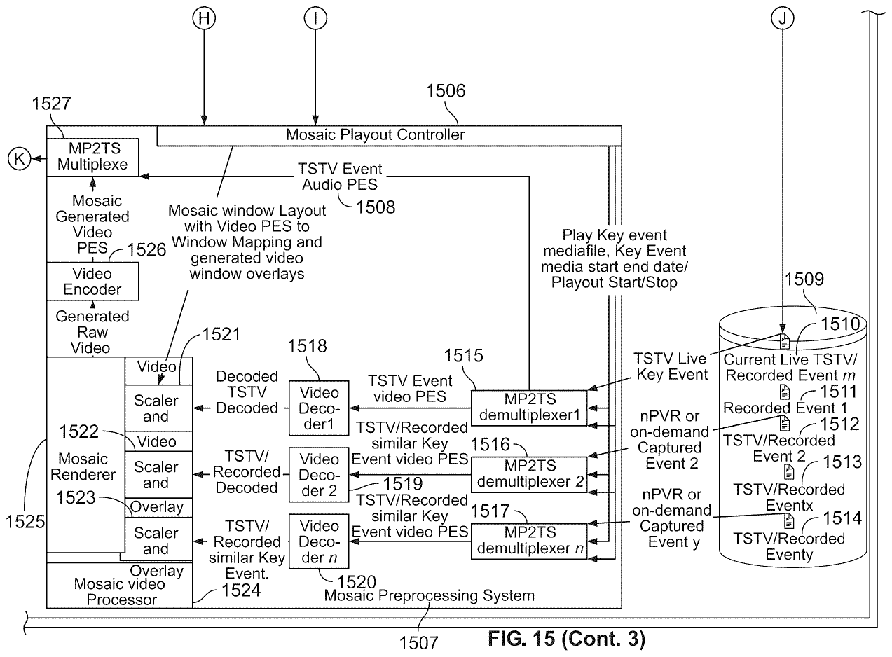

FIG. 15 illustrates an IPTV or cable TV system 1500 for allowing similar plays using a mosaic processing system to be streamed, in accordance with some embodiments of this disclosure. The IPTV/Cable STB device architecture remains the same as in previous figures. Replay of received video may correspond to playback of key event 120 in a higher quality, as described in FIG. 1.

In yet another embodiment, this functionality is invoked upon an interactive replay feature being selected. For example, a video player option may allow viewers to select an option such as “Replay with Similar plays.” This would trigger a video search service to construct a query to find a similar play and provide the content or content display score to the multiplexer to decide on the layout. In another embodiment, the multiplexer is only utilized when a functionality such as “replay with key similar play” is invoked. In some embodiments, the key event continues playing in full screen after the playout of similar plays. In other embodiments, the key event continues playing in full screen in response to a received user input to end playout of similar plays.

IPTV headend or cable TV headend 1501 receives a TSTV session request with a service ID from an IPTV or cable TV client device 1530 via IPTV or Cable HFC network 1529. Session handler 1505 receives the TSTV session request and queries key event database 1503 for key event metadata. In some embodiments, session handler 1505 queries key event database 1503 for other key event metadata based on a similar key event. Session handler 1505 retrieves recorded events from recorded event database 1504. Mosaic playout controller 1506 receives live event TSTV media files and list of key events with respective key event metadata (e.g., medial files, key event start time, key event end time, etc.) and sends retrieved media files to demultiplexers 1515, 1516, 1517 to be decoded by decoder 1518, 1519, and 1520 to be rendered for display by mosaic renderer 1525 and video scalers 1521, 1522, and 1523, all in mosaic processing system 1507. In some embodiments, the demultiplexed audio file may be sent to a multiplexer 1527 and unicast with rendered mosaics from mosaic renderer 1525. Multiplexer 1527 then sends the unicast of TSTV session streams with video, audio, and key event metadata to streaming system 1528, which communicates with the client device 1530 via the IPTV or Cable HFC network 1529 to display the rendered mosaic.

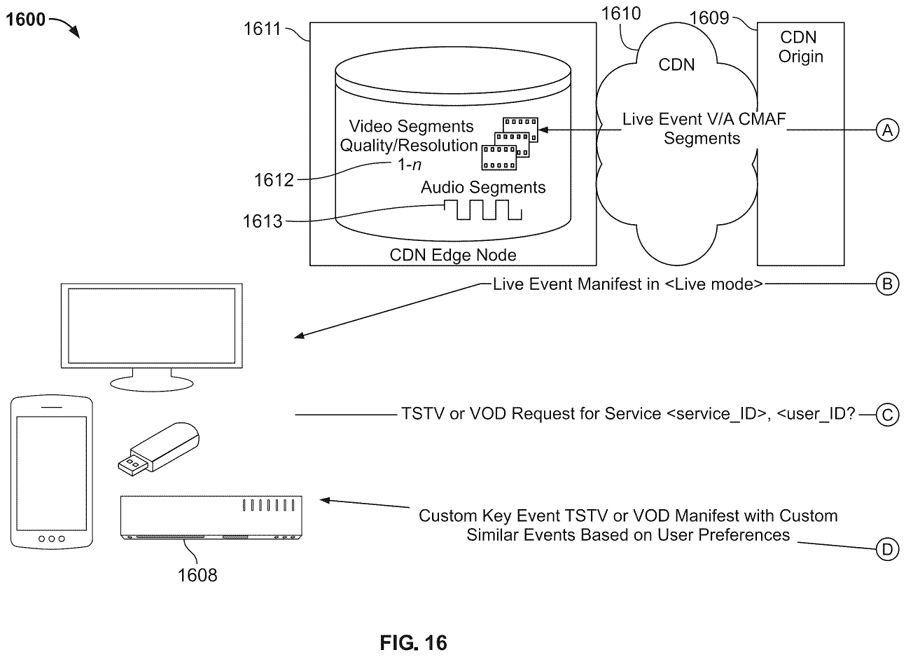

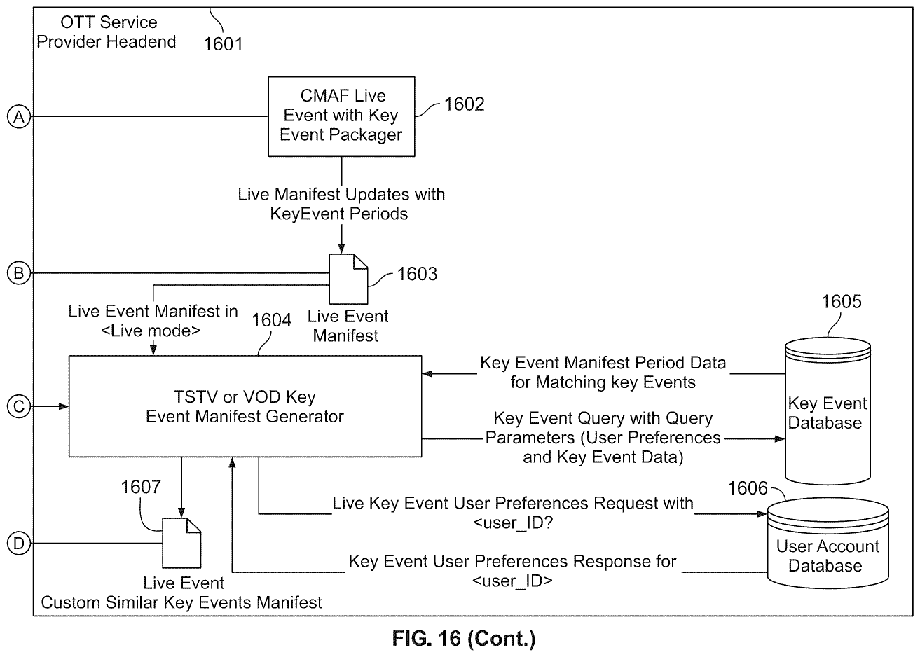

FIG. 16 illustrates a system 1600 to search for key events that are similar to the key event in the live content, in accordance with some embodiments of this disclosure. Replay of received video may correspond to playback of key event 120 in a higher quality, as described in FIG. 1.

In another embodiment, segments from identified similar key events may be represented in a manifest for the same key event period as additional adaptation sets. These key events will be dynamically determined in extreme low latency once the key event in the live content has ended. The live manifest will be modified to insert new adaptation sets into the key event once the key event in the main content stream has been determined to be over by the CV system. Previous figures covering the OTT headend and OTT ABR client device systems for the similar key events in OTT TSTV or VOD streaming. In OTT embodiments, all key events received are processed by packager, and the key events are saved in the key event database. The period defining the key event is also saved in the database. The system in FIG. 16 leverages this key event database to search for key events that are similar to the key event in the live content. The user may set preferences like favorite teams, favorite types of plays, illegal hits/targeting, etc. Depending on the user's preferences, if set, the TSTV or VOD Key Event Manifest Generator will look up similar key events based on the preferences and the current key event data. For the key Event Period metadata returned from the lookup, the current live key event period will be modified to include all of the returned period's adaptation sets into the key event period for the latest key event. This custom manifest will continue to be saved for when the user performs a TSTV action to a Key Event or a Key Event is played while watching the time shifted content. If the user goes Back and watched the content that was a nPVR OTT recorded session or watched on VoD, the same common Key Events may be included. If there are many key events that match the criteria, the Key Events may be updated in the manifest resulting in a different set of common key events to be played in the mosaic playout during the key event.

OTT headend or server 1601 receives a TSTV or VOD request for service from client device 1608 via manifest generator 1604. The manifest generator retrieves live event manifest 1603 from key event packager 1602, key event metadata from key event database 1605, and live event user preferences and key event user preferences from 1606. manifest generator 1604 creates a custom manifest 1607 comprising of key events similar to the key event from the live event. OTT headend or server 1601 sends the custom manifest 1607 for use on client device 1608. Non-key events, like the regular video 1612 and audio 1613 content stream, will be sent to CDN edge node 1611 via CDN origin 1609 and CDN 1610.

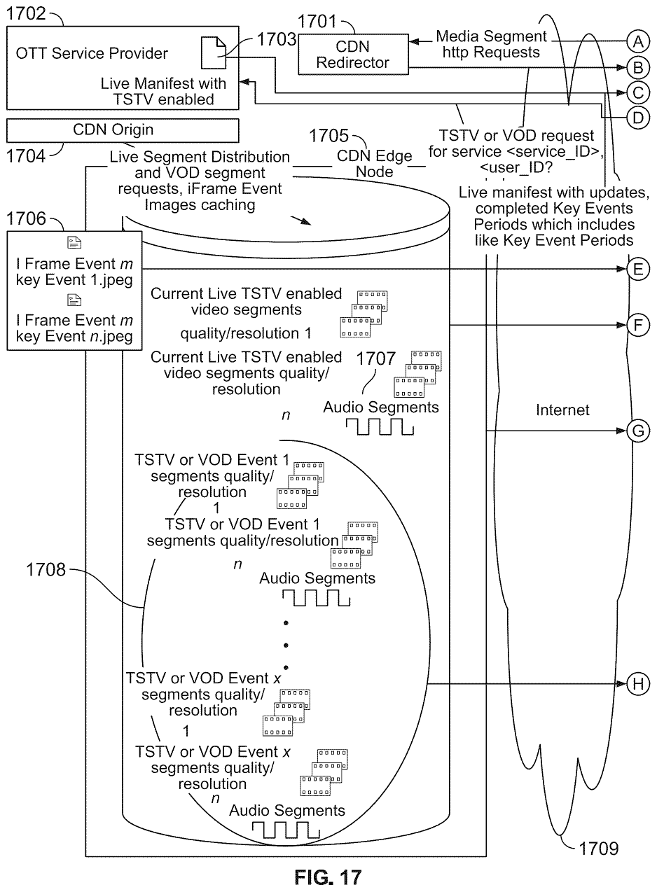

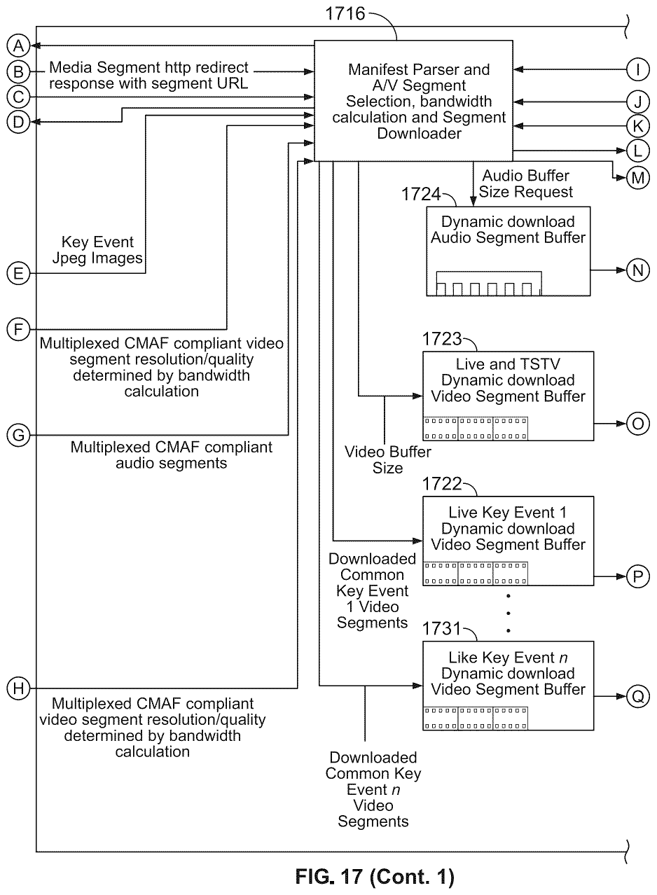

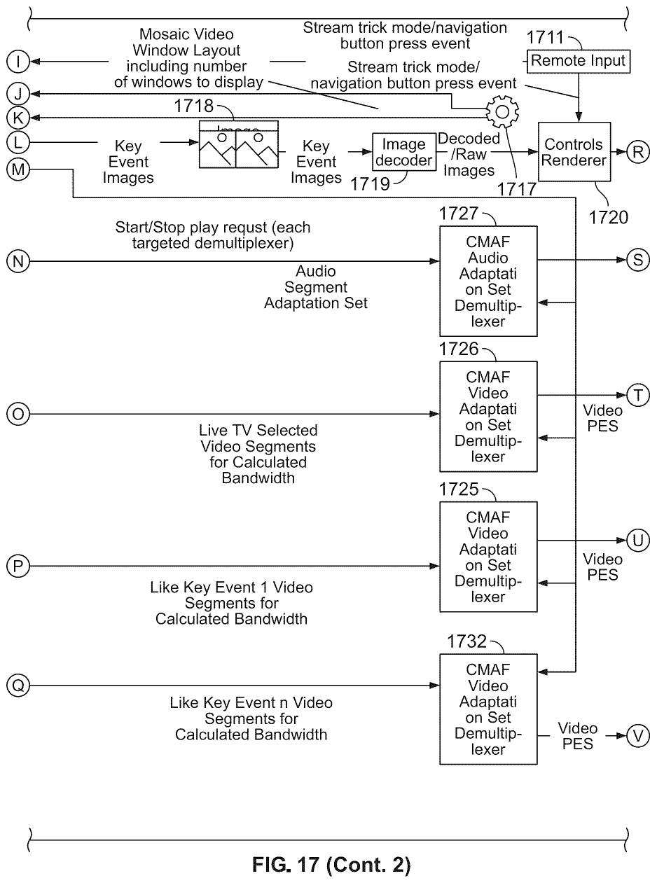

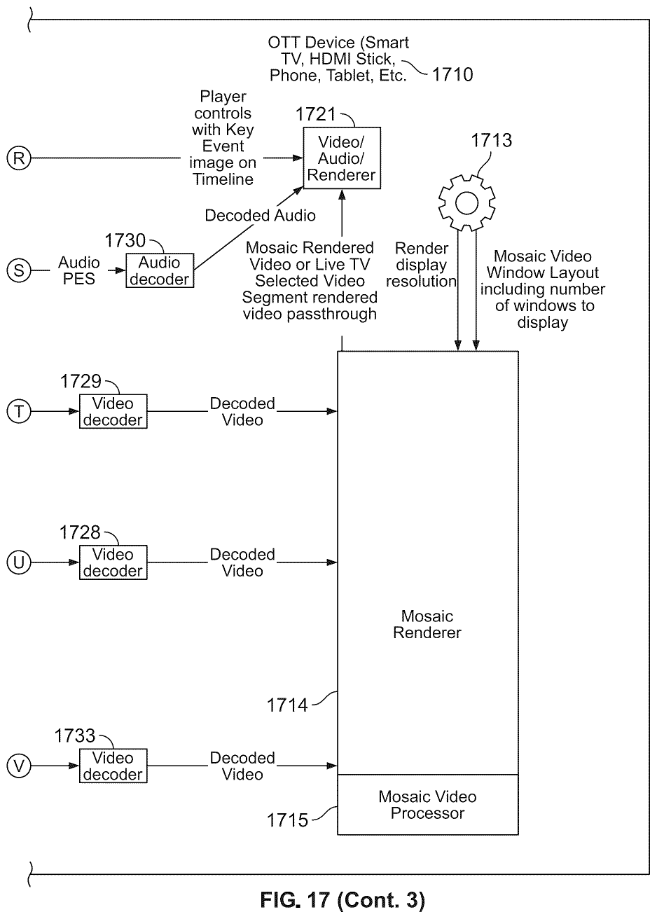

FIG. 17 depicts an illustrative example of a client device playing key events with common key event adaptation sets within the key event period, in accordance with some embodiments of this disclosure. Replay of received video may correspond to playback of key event 120 in a higher quality, as described in FIG. 1.

FIG. 17 is an example of the client device playing key events with common key event adaptation sets within the key event period. In this case, the Manifest Parser and A/V Segment Selection Bandwidth Calculation and Segment Downloader makes a request for time shifted or VOD playout of a live event. The OTT Provider System will generate a custom manifest based on the user preferences and Key Event data for playout of similar key events. The manifest will be returned to the client device. If the device time shifted to the key event, the system May 1) download all of the highest quality videos into the video buffers before playout begins allowing the highest quality playout for all mosaic windows. Or 2) based on mosaic layout, download the proper calculated resolution based on the mosaic window sizes related to the display resolution. An example, if there were 4 different adaptation sets (1 TSTV key event and 3 similar key events) on a 4K display, the client device may download the 1080p live event key event adaptation sets and 3 1080p adaptation sets. There could be a case where the version may be downloaded 1080p and multiple 540p, if available, may be downloaded. This may be controlled based on the number of key events in the manifest, the amount of bandwidth available to the client device, user settings, etc. All video is sent to the Mosaic Renderer. If the mosaic renderer is only receiving one video stream, the rendering will cover the full connected display (passthrough mode) with no mosaic rendering applied.

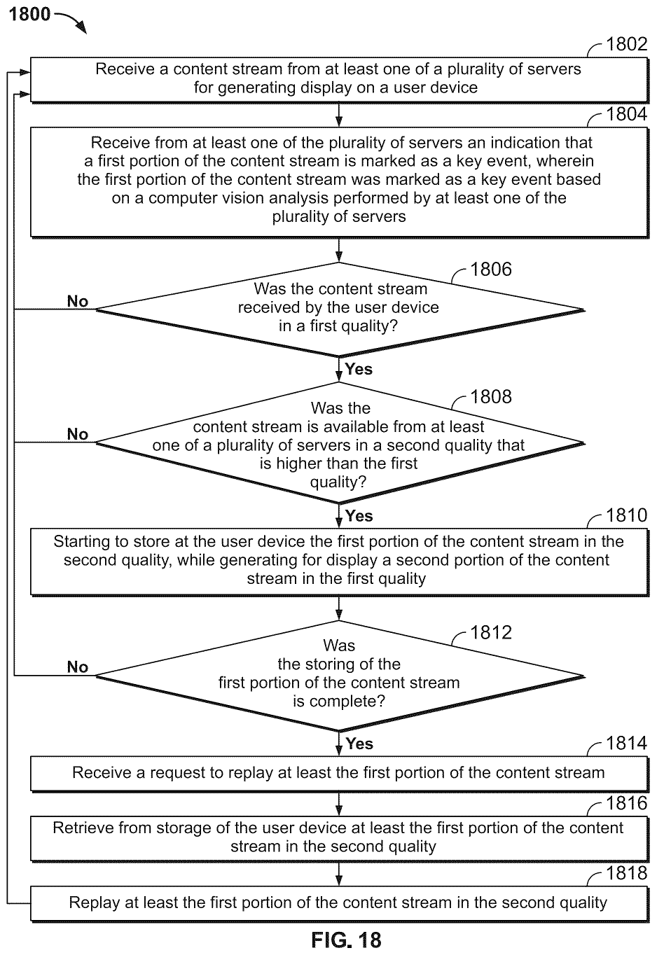

FIG. 18 depicts an illustrative flowchart of process 1800 for replaying a portion of content in a higher quality, in accordance with some embodiments of this disclosure. Steps outlined in FIG. 18 may also be implemented in parallel with steps outlined in FIGS. 1-17.

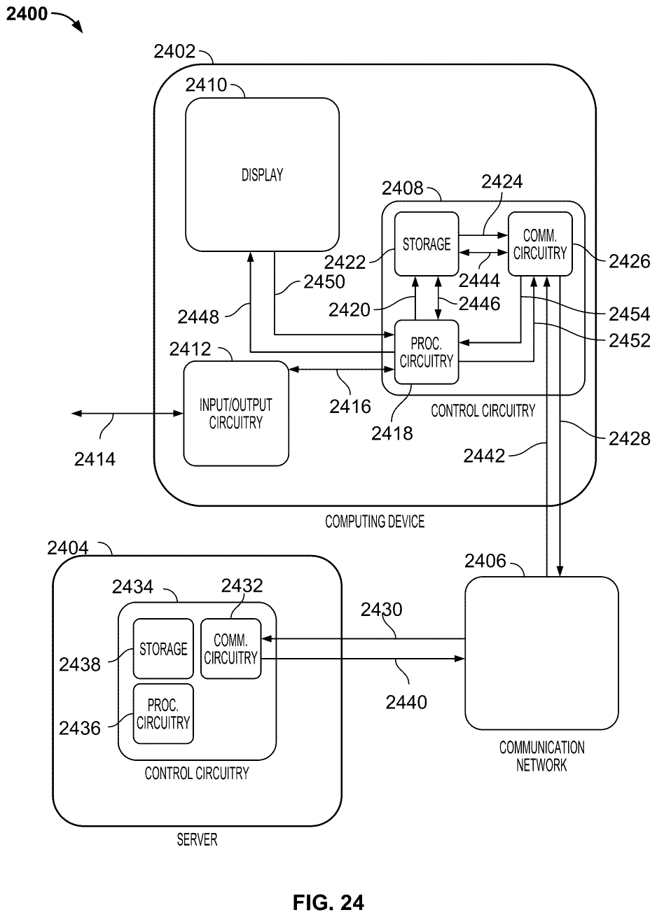

At step 1802, I/O circuitry (e.g., I/O circuitry 2412 of FIG. 24) receives a content stream from at least one of a plurality of servers for generating display on a user device (e.g., any one of devices 110, 120, 126, 128, 142, 201, 202, 219, 221, 311, 418, 533). As an example, at step 110 of FIG. 1, a client device may stream an event.

At step 1804, I/O circuitry (e.g., I/O circuitry 2412 of FIG. 24) receives from at least one of the plurality of servers an indication that a first portion of the content stream is marked as a key event, wherein the first portion of the content stream was marked as a key event based on a computer vision analysis performed by at least one of the plurality of servers. As an example, at step 112 of FIG. 1, a client device determines if the manifest has an update for the indication of a key event. In another example, the computer vision analysis may correspond to an analysis performed by media analysis system 307, 408, 508.

At step 1806, control circuitry (e.g., circuitry 2434 of FIG. 24) determines if the content stream was received by the user device in a first quality. At step 1808, control circuitry further determines if the content stream is available from at least one of a plurality of servers in a second quality that is higher than the first. As an example, at step 114 of FIG. 1, a client device determines if there is a variant that has a higher quality version of the stream. In another example, control circuitry (e.g., I/O circuitry 2412 of FIG. 24) may determine that a content stream was first received in 1080p, but then determine that the content stream is available in a higher quality such as 2160p from another server.

If at step 1806 control circuitry (e.g., I/O circuitry 2412 of FIG. 24) determines that the content stream was not received in a first quality or if at step 1808 control circuitry (e.g., I/O circuitry 2412 of FIG. 24) determines that the content stream is not available from at least one of a plurality of servers in a second quality that is higher than the first quality, then I/O circuitry (e.g., I/O circuitry 2412 of FIG. 24) may continue to receive content from at least one of a plurality of severs to generate on display on a user device. As an example, at step 142 of FIG. 1, a client device continues to stream an event in an available quality. In another example, control circuitry (e.g., I/O circuitry 2412 of FIG. 24) may determine that the content stream is being displayed at a user device at 1080p, but the control circuitry (e.g., I/O circuitry 2412 of FIG. 24) may determine that there does not exist a higher quality version of the content stream in a higher quality, so the I/O circuitry (e.g., I/O circuitry 2412 of FIG. 24) will continue to display content from the content stream at the 1080p quality.

If control circuitry (e.g., I/O circuitry 2412 of FIG. 24) determines that the content stream was both received in a first quality (e.g., at step 1806) and that the content stream is also available in a higher quality (e.g., at step 1808), at step 1810, the control circuitry (e.g., I/O circuitry 2412 of FIG. 24) may begin to starting to store at the user device the first portion of the content stream in the second quality in memory, while generating for display a second portion of the content stream in the first quality with I/O circuitry (e.g., I/O circuitry 2412 of FIG. 24). As an example, at step 120 of FIG. 1, a client device may continue to stream an event while storing a higher quality version of the key event. As another example, control circuitry (e.g., I/O circuitry 2412 of FIG. 24) may determine that a content stream is streamed at 480p, determine that the content stream may be streamed at 720p, and start to store the 720p version of the content stream while continuing to display the 480p version of the content stream.

At step 1812, control circuitry (e.g., I/O circuitry 2412 of FIG. 24) determines if the storing of the first portion of the content stream is complete. If not, the I/O circuitry (e.g., I/O circuitry 2412 of FIG. 24) will continue to display content received from a content stream from at least one of a plurality of servers for generating display. If control circuitry (e.g., I/O circuitry 2412 of FIG. 24) determines that storing the first portion of the content stream is complete, at step 1814, control circuitry (e.g., I/O circuitry 2412 of FIG. 24) may receive a request to replay at least the first portion of the content stream. As an example, in step 130 of FIG. 1, the client device may receive a request to watch a higher quality version of the key event after the higher quality version has completed storage.

At step 1816, control circuitry (e.g., I/O circuitry 2412 of FIG. 24) may retrieve from storage of the user device (i.e., memory) at least the first portion of the content stream in the second quality. At step 1818, control circuitry (e.g., I/O circuitry 2412 of FIG. 24) may replay at least the first portion of the content stream in the second quality. As an example, at step 126 of FIG. 1, a client device will playback the stored higher quality version of a key event.

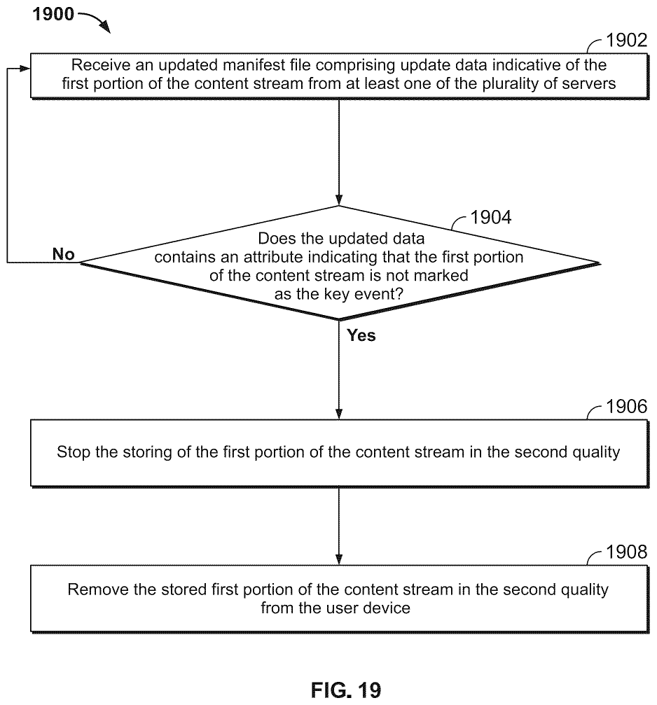

FIG. 19 depicts an illustrative flowchart of process 1900 for removing a previously stored portion marked as a key event based on determining that the previously stored portion is not a key event, in accordance with some embodiments of this disclosure. Steps outlined in FIG. 19 may also be implemented in parallel with steps outlined in FIGS. 1-17. For example, in an OTT embodiment, control circuitry (e.g., I/O circuitry 2412 of FIG. 24) may initially be storing a portion of a football game during the fourth down where no game-changing events as a key event occur in memory of a client device.

Control circuitry (e.g., I/O circuitry 2412 of FIG. 24) may later receive an indication that the portion of the football game during the fourth down is not a key event. As a result, control circuitry (e.g., I/O circuitry 2412 of FIG. 24) may then prevent further storage of the portion initially marked as a key event and remove the higher quality version of the portion initially marked as a key event from any local memory. As an example, at step 122 of FIG. 1, further storage of the portion initially marked as a key even may be prevented.

At step 1902, I/O circuitry (e.g., I/O circuitry 2412 of FIG. 24) may receive an updated manifest file comprising update data indicative of the first portion of the content stream from at least one of the plurality of servers. At step 1904, control circuitry (e.g., I/O circuitry 2412 of FIG. 24) determines if the updated data contains an attribute indicating that the first portion of the content stream is not marked as the key event. As an example, the updated data may contain an attribute tag as seen in 523 of FIG. 5. If control circuitry (e.g., I/O circuitry 2412 of FIG. 24) determines that the first portion of the content stream was indeed a key event, then I/O circuitry (e.g., I/O circuitry 2412 of FIG. 24) may continue to receive a content stream from at least one of a plurality of servers for generating display on a user device (e.g., as in step 1802). As an example, at step 142 of FIG. 1, a client device may continue to generate a received content stream for display. Otherwise, at step 1906, control circuitry (e.g., I/O circuitry 2412 of FIG. 24) may then stop the storing of the first portion of the content stream in the second quality.

At step 1908, control circuitry (e.g., I/O circuitry 2412 of FIG. 24) may then remove the stored first portion of the content stream in the second quality from the user device. In some implementations, the first portion of the content stream may also be stored in database of key events 532 of FIG. 5. At step 1908, control circuitry (e.g., I/O circuitry 2412 of FIG. 24) may also remove the first portion of the content stream from database of key events 207 of FIG. 2 or 532 of FIG. 5.

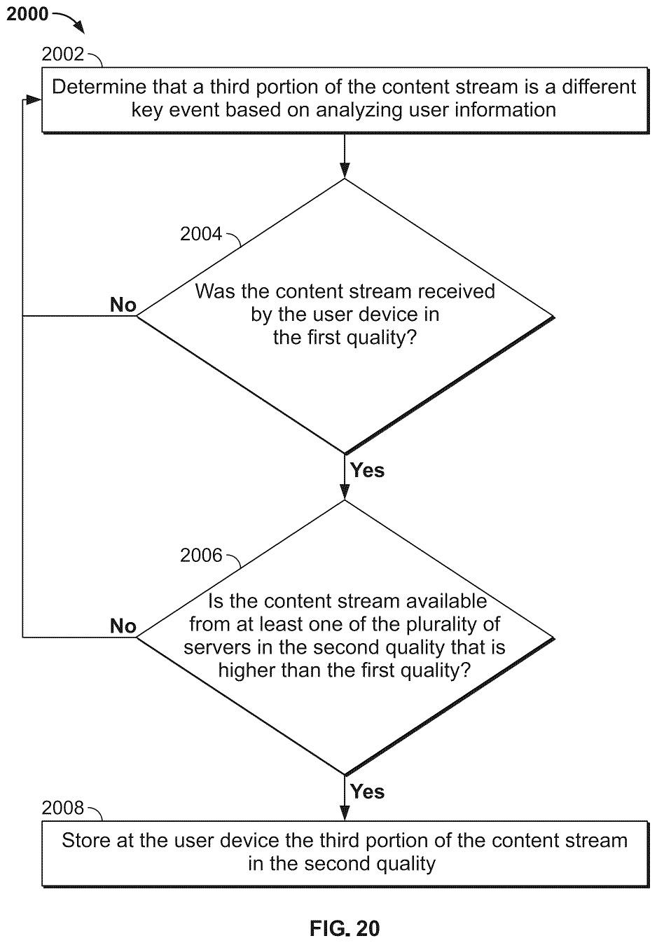

FIG. 20 depicts an illustrative flowchart of process 2000 for determining that another portion of a content stream is a key event, in accordance with some embodiments of this disclosure. Steps outlined in FIG. 20 may also be implemented in parallel with steps outlined in FIGS. 1-17. For example, control circuitry (e.g., I/O circuitry 2412 of FIG. 24) may determine that two distinct key events occur in succession in a content stream. As a result, control circuitry (e.g., I/O circuitry 2412 of FIG. 24) may begin to start to store the later key event in a higher quality, if available, at a local memory medium.

At step 2002, control circuitry (e.g., I/O circuitry 2412 of FIG. 24) determines that a third portion of the content stream (i.e., a portion of the content stream that is marked as a key event right after a different key event that occurred previously in the content stream) is a different key event based on analyzing user information. For example, the third portion of the content stream marked as a key event may correspond to timestamps 1:00:00-1:01:30 in a live stream, a second portion of the content stream marked as a key event may correspond to timestamps 00:58:30-1:00:00 in a live stream, and a first portion marked as a key event may correspond to timestamps 00:20:00-00:21:30 in a live stream. In some implementations, the process of analyzing user information may also utilize media analysis system 307 of FIG. 3, 408 of FIG. 4, or 508 of FIG. 5.

At step 2004, control circuitry (e.g., I/O circuitry 2412 of FIG. 24) may determine if the content steam was received by the user device in a first quality and, at step 2006, determine if the content stream is available from at least one of the plurality of servers in the second quality that is higher than the first quality. For example, control circuitry (e.g., I/O circuitry 2412 of FIG. 24) may determine that a content stream was first received in 1080p, but then determine that the content stream is available in a higher quality such as 2160p from another server. If control circuitry (e.g., I/O circuitry 2412 of FIG. 24) determines that the content steam was received by the user device in a first quality or that the content stream is not available from at least one of the plurality of servers in the second quality that is higher than the first quality, then I/O circuitry (e.g., I/O circuitry 2412 of FIG. 24) may continue to receive a content stream from at least one of a plurality of servers for generating display on a user device (e.g., as in step 1802). Otherwise, at step 2008, control circuitry (e.g., I/O circuitry 2412 of FIG. 24) may store at the user device the third portion of the content stream in the second quality in a local memory medium.

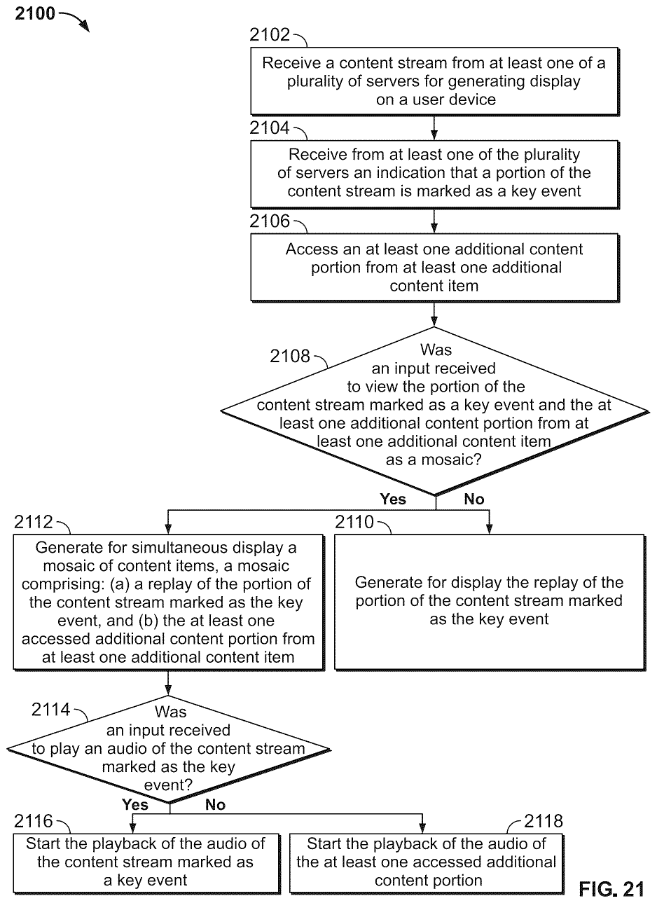

FIG. 21 depicts an illustrative flowchart of process 2100 where I/O circuitry (e.g., I/O circuitry 2412 of FIG. 24) may output a mosaic of a key event and another related key event. Steps outlined in FIG. 21 may also be implemented in parallel with steps outlined in FIGS. 1-17.

At step 2102, I/O circuitry (e.g., I/O circuitry 2412 of FIG. 24) may receive a content stream from at least one of a plurality of servers for generating display on a user device. As an example, at step 110 of FIG. 1, a content event is streamed after a client device receives a manifest file. As another example, a smart TV may receive a stream of content over a private internet connection and generate its content for display.

At step 2104, I/O circuitry (e.g., I/O circuitry 2412 of FIG. 24) may receive an indication from at least one of a plurality of servers that a portion of the content stream is marked as a key event. In some implementations, media analysis system 307 of FIG. 3, 408 of FIG. 4, or 508 of FIG. 5 may determine that a portion of a content stream is a key event using a plurality of analysis methods.

At step 2106, control circuitry (e.g., I/O circuitry 2412 of FIG. 24) may access at least one additional content portion from at least one additional content item, allowing the client device to generate related content when required. As an example, at step 215 of FIG. 2, a client device may access related key events when a key event is requested to be replayed. In another example, during a live stream of a football game, a touchdown may occur, and the client device may determine at step 2104 that a portion of the content stream is marked as a key event. At step 2106, control circuitry (e.g., I/O circuitry 2412 of FIG. 24) may then access an additional portion from at least one additional content item such as another touchdown from different football game.

At step 2108, control circuitry (e.g., I/O circuitry 2412 of FIG. 24) may determine that an input was received to view the portion of the content stream marked as a key event and the at least one additional content portion from at least one additional content item as a mosaic. As an example, control circuitry (e.g., I/O circuitry 2412 of FIG. 24) may determine to view a key event and an additional content item as a mosaic by receiving an indication from selection item 204 from FIG. 2 indicating that similar plays should be generated during a replay of a key event and if option to display the replay as a mosaic 220 from FIG. 2 is selected. If control circuitry (e.g., I/O circuitry 2412 of FIG. 24) determines that only the key event itself should be replayed, then at step 2110, the I/O circuitry (e.g., I/O circuitry 2412 of FIG. 24) may generate for display only the replay of the portion of the content stream marked as the key event. For example, control circuitry (e.g., I/O circuitry 2412 of FIG. 24) may determine that selection item 204 is toggled off, indicating that similar plays should not be included in a replay.

If control circuitry (e.g., I/O circuitry 2412 of FIG. 24) determines that the key event should be viewed with an additional content portion from at least one additional content item, then at step 2112, I/O circuitry (e.g., I/O circuitry 2412 of FIG. 24) may generate for simultaneous display a mosaic of content items, a mosaic comprising: (a) a replay of the portion of the content stream marked as the key event, and (b) the at least one accessed additional content portion from at least one additional content item. As an example, if option to display the replay as a mosaic 220 is selected, then a mosaic would be generated comprising of both the replay of the portion of the content stream marked as the key event and the at least one accessed additional content portion from at least one additional content item.

At step 2114, control circuitry (e.g., I/O circuitry 2412 of FIG. 24) may determine if an input was received to play an audio of the content stream marked as the key event. At step 2116, if control circuitry (e.g., I/O circuitry 2412 of FIG. 24) determines that the audio of the key event should be played back, then I/O circuitry may start the playback of audio of the content stream marked as the key event. At step 2118, if control circuitry (e.g., I/O circuitry 2412 of FIG. 24) does not determine that the audio should be played back, then I/O circuitry (e.g., I/O circuitry 2412 of FIG. 24) may start the playback of the audio of the at least one accessed additional content portion. For example, as seen in FIG. 3, audio selection prompt 317 may be used to determine if the audio for the key event should be played back or if the audio for another accessed content portion should be played back.

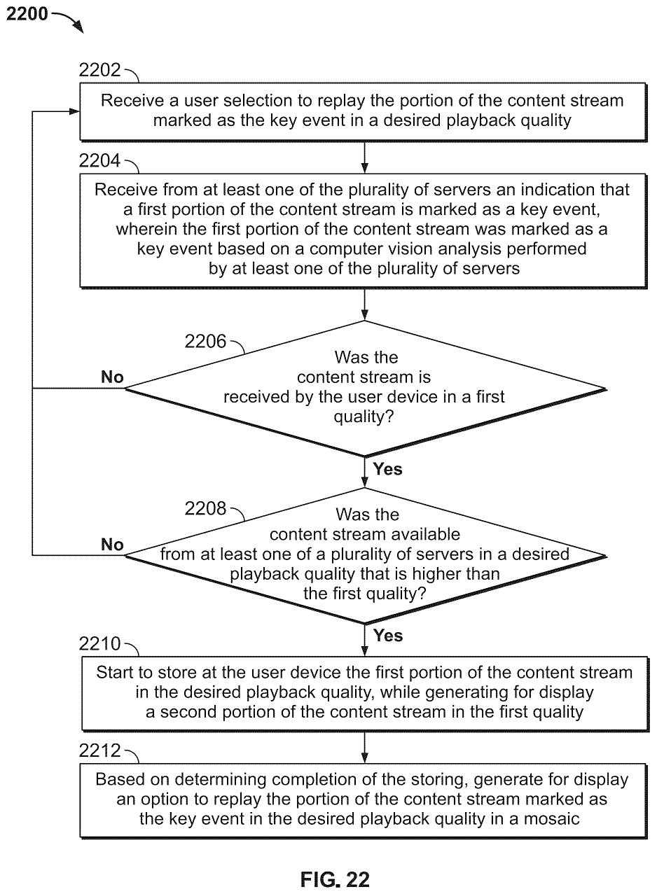

FIG. 22 depicts an illustrative flowchart of process 2100 where I/O circuitry (e.g., I/O circuitry 2412 of FIG. 24) may replay a key event in a higher quality in a mosaic. Steps outlined in FIG. 22 are similar to steps outlined in FIG. 18, but steps outlined in FIG. 22 are more directed towards quality enhancement of a key event when displaying the key event in a mosaic. Steps outlined in FIG. 22 may also be implemented in parallel with steps outlined in FIGS. 1-17. I/O circuitry (e.g., I/O circuitry 2412 of FIG. 24) may begin to stream content at an available quality.

At step 2202, control circuitry (e.g., I/O circuitry 2412 of FIG. 24) may receive a user selection to replay the portion of the content stream marked as the key event in a desired playback quality. For example, control circuitry (e.g., I/O circuitry 2412 of FIG. 24) may determine that the key event should be played back at 2160p quality, but I/O circuitry (e.g., I/O circuitry 2412 of FIG. 24) may be streaming the content at 1080p quality. At step 2204, I/O circuitry (e.g., I/O circuitry 2412 of FIG. 24) may receive from at least one of the plurality of servers an indication that a first portion of the content stream is marked as a key event, wherein the first portion of the content stream was marked as a key event based on a computer vision analysis performed by at least one of the plurality of servers. As an example, at step 112 of FIG. 1, a client device determines if the manifest has an update for the indication of a key event. In another example, computer vision analysis may incorporate media analysis system 307 from FIG. 3, 408 from FIG. 4, or 508 from FIG. 5 to determine if a portion of a content stream is a key event using a plurality of analysis methods.

At step 2206, control circuitry (e.g., I/O circuitry 2412 of FIG. 24) determines if the content stream is received by the user device in a first quality. For example, the first quality may be a lower quality (e.g., 1080p) than the quality that a device typically streams at (e.g., 2160p). If not, then I/O circuitry (e.g., I/O circuitry 2412 of FIG. 24) may continue to stream content in an available quality.

At step 2208, if control circuitry (e.g., I/O circuitry 2412 of FIG. 24) determines that the content was received at a first quality, then control circuitry (e.g., I/O circuitry 2412 of FIG. 24) may also determine if the content stream is available from at least one of a plurality of servers in a desired playback quality that is higher than the first quality. As an example, at step 114 of FIG. 1, a client device determines if there is a variant that has a higher quality version of the stream. In another example, control circuitry (e.g., I/O circuitry 2412 of FIG. 24) may determine that the desired playback quality is 2160p, that the content stream is available at 2160p at another server, and if the content stream is currently being streamed at 1080p (i.e., a lower quality than the desired playback quality). If not, I/O circuitry (e.g., I/O circuitry 2412 of FIG. 24) may again continue to stream content in an available quality.

At step 2210, control circuitry (e.g., I/O circuitry 2412 of FIG. 24) may then start to store at the user device the first portion of the content stream in the desired playback quality in a local storage medium, while I/O circuitry (e.g., I/O circuitry 2412 of FIG. 24) generates for display a second portion of the content stream in the first quality. As an example, at step 122 and step 142 of FIG. 1, an available stream is generated for display while a higher quality version is stored on a local device. In another example, I/O circuitry (e.g., I/O circuitry 2412 of FIG. 24) may continue to stream a live event after the contents of the key event at 1080p while locally storing the portion of the content in a higher, 2160p quality.

At step 2212, based on control circuitry (e.g., I/O circuitry 2412 of FIG. 24) determining completion of the storing, control circuitry (e.g., I/O circuitry 2412 of FIG. 24) may generate for display an option to replay the portion of the content stream marked as the key event in the desired playback quality. As an example, at step 126 of FIG. 1, a client device will playback the stored, desired, higher quality version of a key event.

### Predictive Model

Throughout the present disclosure, in some embodiments, determinations, predictions, likelihoods, and the like are determined with one or more predictive models. In some embodiments, the model receives various forms of data about users, applications, media content items, devices, and more. This includes usage data, load-balancing data, and metadata. The model performs analysis based on hard rules, learning rules, hard models, learning models, usage data, load data, analytics, metadata, profile information, or combinations of these. The model outputs predictions of a future state of any of the devices described. Load-increasing events are determined by load-balancing processes. The model is based on inputs including hard rules, user-defined rules, rules defined by content providers, hard models, learning models, or combinations of these. The model is trained with data using various data processes, analytical processes, and machine learning approaches. It includes regression and classification analyses. An example of a multi-layer neural network is provided. The model is based on data engineering and modeling processes, and is operationalized using registration, deployment, monitoring, and retraining processes. The model is configured to output results to one or multiple devices, which can perform various functions. The devices can be a server, tablet, media display device, network-connected computer, media device, computing device, or combinations of these. The model outputs a current state, future state, determination, prediction, or likelihood. These outputs may be compared to a predetermined or determined standard. If the standard is satisfied or rejected, the predictive process outputs at least one of the current state, future state, determination, prediction, or likelihood to any device or module disclosed.

In some embodiments, the model ingests diverse forms of data about users, applications, media content items, devices, and more. This encompasses user interaction data, load-distribution data, and metadata. The model conducts analysis based on deterministic rules, learned rules, deterministic models, learned models, user interaction data, load data, analytics, metadata, user profile information, or combinations thereof. The model generates predictions of a future state of any of the described devices. Load-increasing events are identified by load-distribution processes.

The model is constructed based on inputs including deterministic rules, user-defined rules, rules defined by content providers, deterministic models, learned models, or combinations thereof. The model is trained with data using various data processing methods, analytical processes, and machine learning techniques. It includes regression and classification analyses. An example of a deep neural network is provided.

The model is built upon data engineering and modeling processes and is operationalized using registration, deployment, monitoring, and retraining processes. The model is designed to output results to one or multiple devices, which can perform various functions. The devices can be a server, tablet, digital display device, network-connected computer, media device, computing device, or combinations thereof.

The model outputs a current state, future state, determination, prediction, or probability. These outputs may be compared to a predetermined or determined benchmark. If the benchmark is met or not met, the predictive process outputs at least one of the current state, future state, determination, prediction, or probability to any device or module disclosed.

A prediction process 2300 includes a predictive model 2350 in some embodiments. The predictive model 2350 receives as input various forms of data about one, more or all the users, applications, media content items, devices, and data described in the present disclosure. The predictive model 2350 performs analysis based on at least one of hard rules, learning rules, hard models, learning models, usage data, load data, analytics of the same, metadata, profile information, combinations of the same, or the like. The predictive model 2350 outputs one or more predictions of a future state of any of the devices described in the present disclosure. A load-increasing event is determined by load-balancing processes, e.g., least connection, least bandwidth, round robin, server response time, weighted versions of the same, resource-based processes, and address hashing. The predictive model 2350 is based on input including at least one of a hard rule 2305, a user-defined rule 2310, a rule defined by a content provider 2315, a hard model 2320, a learning model 2325, combinations of the same, or the like.

The predictive model 2350 receives as input usage data 2330. The predictive model 2350 is based, in some embodiments, on at least one of a usage pattern of the user or media device, a usage pattern of the requesting media device, a usage pattern of the media content item, a usage pattern of the communication system or network, a usage pattern of the profile, a usage pattern of the media device, combinations of the same, or the like.

The predictive model 2350 receives as input load-balancing data 2335. The predictive model 2350 is based on at least one of load data of the display device, load data of the requesting media device, load data of the media content item, load data of the communication system or network, load data of the profile, load data of the media device, combinations of the same, or the like.

The predictive model 2350 receives as input metadata 2340. The predictive model 2350 is based on at least one of metadata of the streaming service, metadata of the requesting media device, metadata of the media content item, metadata of the communication system or network, metadata of the profile, metadata of the media device, combinations of the same, or the like. The metadata includes information of the type represented in the media device manifest.

The predictive model 2350 is trained with data. The training data is developed in some embodiments using one or more data processes including but not limited to data selection, data sourcing, and data synthesis. The predictive model 2350 is trained in some embodiments with one or more analytical processes including but not limited to classification and regression trees (CART), discrete choice models, linear regression models, logistic regression, logit versus probit, multinomial logistic regression, multivariate adaptive regression splines, probit regression, regression processes, survival or duration analysis, and time series models. The predictive model 2350 is trained in some embodiments with one or more machine learning approaches including but not limited to supervised learning, unsupervised learning, semi-supervised learning, reinforcement learning, and dimensionality reduction. The predictive model 2350 in some embodiments includes regression analysis including analysis of variance (ANOVA), linear regression, logistic regression, ridge regression, and/or time series. The predictive model 2350 in some embodiments includes classification analysis including decision trees and/or neural networks. The predictive model 2350 is based on data engineering and/or modeling processes. The data engineering processes include exploration, cleaning, normalizing, feature engineering, and scaling. The modeling processes include model selection, training, evaluation, and tuning. The predictive model 2350 is operationalized using registration, deployment, monitoring, and/or retraining processes.

The predictive model 2340 is configured to output results to a device or multiple devices. The device includes means for performing one, more, or all the features referenced herein of the systems, methods, processes, and outputs of one or more of FIGS. 1-22 (above) in any suitable combination. The device is at least one of a server 2355, a tablet 2360, a media display device 2365, a network-connected computer 2370, a media device 2375, a computing device 2380, combinations of the same, or the like.

The predictive model 2350 is configured to output a current state 2381, and/or a future state 2383, and/or a determination, a prediction, or a likelihood 2385, and the like. The current state 2381, and/or the future state 2383, and/or the determination, the prediction, or the likelihood 2385, and the like may be compared 2390 to a predetermined or determined standard. In some embodiments, the standard is satisfied (2390=OK) or rejected (2390=NOT OK). If the standard is satisfied or rejected, the predictive process 2300 outputs at least one of the current state, the future state, the determination, the prediction, the likelihood to any device or module disclosed herein, combinations of the same, or the like. In some embodiments, the predictive model 2350 incorporates one or more large language models (LLMs).

For example, the predictive model 2350 is an artificial intelligence (AI) system that applies one or more features of the disclosed methods and systems. Also, for example, the model 2350 receives various forms of data about users, applications, media content items, devices, and other data described herein. This includes usage data 2330, load-balancing data 2335, and metadata 2340. The usage data could be related to the scrolling characteristics of the primary content, the size of the screen buffer, and the type of content being displayed. The load-balancing data could be related to the load data of the display device, the requesting media device, the media content item, the communication system or network, the profile, and the media device. The metadata could include information about the streaming service, the requesting media device, the media content item, the communication system or network, the profile, and the media device.

Further, for example, the predictive model 2350 performs analysis based on hard rules, learning rules, hard models, learning models, usage data, load data, analytics of the same, metadata, profile information, or combinations of the same. The model is trained with data using data processes including data selection, data sourcing, and data synthesis. The training involves analytical processes including classification and regression trees (CART), discrete choice models, linear regression models, logistic regression, logit versus probit, multinomial logistic regression, multivariate adaptive regression splines, probit regression, regression processes, survival or duration analysis, and time series models. The model is also trained with machine learning approaches including supervised learning, unsupervised learning, semi-supervised learning, reinforcement learning, and dimensionality reduction. The model is based on data engineering and modeling processes, which include exploration, cleaning, normalizing, feature engineering, scaling, model selection, training, evaluation, tuning, registration, deployment, monitoring, and retraining processes.

In addition, for example, the predictive model 2350 outputs one or more predictions of a future state of any of the devices described herein. This could include the current state 2381, the future state 2383, a determination, a prediction, or a likelihood 2385. These outputs may be compared 2390 to a predetermined or determined standard. If the standard is satisfied or rejected, the predictive process 2300 outputs at least one of the current state, the future state, the determination, the prediction, the likelihood to any device or module disclosed herein.

### Communication System

A communication system is provided including a computing device, a server, and a communication network. Both the server and the communication network can exist in multiple forms and can connect directly or indirectly. The computing device includes control circuitry, a display, and I/O circuitry. The control circuitry can execute systems, methods, processes, and outputs. Both the computing device and server include control circuitry and storage, which can store content, metadata, data, user profiles, messages, and commands for an application. The computing device communicates with an I/O device and can receive and process user inputs locally or transmit them to the remote server for processing. Both the server and the computing device can transmit and receive content via the communication network or directly, and the processing circuitry receives the user input and converts it to digital signals.

In some embodiments, the system is a distributed network with an edge device (a type of computing device 2402), a cloud server (a type of server 2404), and an internet of things (IoT) network (a type of communication network 2406). Both the edge device and server have microservices and data lakes. The edge device includes a user interface and I/O ports. User interactions can be processed at the edge or in the cloud. The system can transmit and receive digital assets via the IoT network. The edge device communicates with an IoT device and can be various types of smart devices capable of displaying and interacting with digital content. The communication paths in the system can be optimized for latency and bandwidth efficiency.

The system is shown to include computing device 2402, server 2404, and a communication network 2406. It is understood that while a single instance of a component may be shown in the above figures, additional embodiments of the component may be employed. For example, server 2404 may include, or may be incorporated in, more than one server. Similarly, communication network 2406 may include, or may be incorporated in, more than one communication network. Server 2404 is shown communicatively coupled to computing device 2402 through communication network 2406. Server 2404 may be directly communicatively coupled to computing device 2402, for example, in a system absent or bypassing communication network 2406.

Communication network 2406 may include one or more network systems, such as, without limitation, the Internet, LAN, Wi-Fi, wireless, or other network systems suitable for audio processing applications. In still other embodiments, server 2404 works in conjunction with one or more components of communication network 2406 to implement certain functionality described herein in a distributed or cooperative manner. In other embodiments, computing device 2402 works in conjunction with one or more components of communication network 2406 or server 2404 to implement certain functionality described herein in a distributed or cooperative manner.

Computing device 2402 includes control circuitry 2408, display 2410 and input/output (I/O) circuitry 2412. Control circuitry 2408 may be based on any suitable processing circuitry and includes control circuits and memory circuits, which may be disposed on a single integrated circuit or may be discrete components. As referred to herein, processing circuitry should be understood to mean circuitry based on at least one microprocessors, microcontrollers, digital signal processors, programmable logic devices, field-programmable gate arrays (FPGAs), application-specific integrated circuits (ASICs), system-on-chip (SoC), application-specific standard parts (ASSPs), indium phosphide (InP)-based monolithic integration and silicon photonics, non-classical devices, organic semiconductors, compound semiconductors, “More Moore” devices, “More than Moore” devices, cloud-computing devices, combinations of the same, or the like, and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i9 processors) or multiple different processors (e.g., an Intel Core i7 processor and an Intel Core i9 processor). Some control circuits may be implemented in hardware, firmware, or software. Control circuitry 2408 in turn includes communication circuitry 2426, storage 2422 and processing circuitry 2418. Either of control circuitry 2408 and 2434 may be utilized to execute or perform any or all the systems, methods, processes, and outputs of one or more of FIGS. 1-17 (above) and FIGS. 19-28 (below), or any combination of steps thereof (e.g., as enabled by processing circuitries 2418 and 2436, respectively).

In addition to control circuitry 2408 and 2434, computing device 2402 and server 2404 may each include storage (storage 2422, and storage 2438, respectively). Each of storages 2422 and 2438 may be an electronic storage device. As referred to herein, the phrase “electronic storage device” or “storage device” should be understood to mean any device for storing electronic data, computer software, or firmware, such as random-access memory, read-only memory, cloud-based storage, hard drives, optical drives, digital video disc (DVD) recorders, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 2422 and 2438 may be used to store several types of content, metadata, and/or other types of data. Non-volatile memory may also be used (e.g., to launch a boot-up routine and other instructions). Cloud-based storage may be used to supplement storages 2422 and 2438 or instead of storages 2422 and 2438. In some embodiments, a user profile and messages corresponding to a chain of communication may be stored in one or more of storages 2422 and 2438. Each of storages 2422 and 2438 may be utilized to store commands, for example, such that when each of processing circuitries 2418 and 2436, respectively, are prompted through control circuitries 2408 and 2434, respectively. Either of processing circuitries 2418 or 2436 may execute any of the systems, methods, processes, and outputs of one or more of FIGS. 1-22 (above), or any combination of steps thereof.

In some embodiments, control circuitry 2408 and/or 2434 executes instructions for an application stored in memory (e.g., storage 2422 and/or storage 2438). Specifically, control circuitry 2408 and/or 2434 may be instructed by the application to perform the functions discussed herein. In some embodiments, any action performed by control circuitry 2408 and/or 2434 may be based on instructions received from the application. For example, the application may be implemented as software or a set of and/or one or more executable instructions that may be stored in storage 2422 and/or 2438 and executed by control circuitry 2408 and/or 2434. The application may be a client/server application where only a client application resides on computing device 2402, and a server application resides on server 2404.

The application may be implemented using any suitable arrangement. For example, it may be a stand-alone application wholly implemented on computing device 2402. In such an approach, instructions for the application are stored locally (e.g., in storage 2422), and data for use by the application is downloaded on a periodic basis (e.g., from an out-of-band feed, from an Internet resource, or using another suitable approach). Control circuitry 2408 may retrieve instructions for the application from storage 2422 and process the instructions to perform the functionality described herein. Based on the processed instructions, control circuitry 2408 may determine a type of action to perform based at least in part on input received from I/O circuitry 2412 or from communication network 2406.

The computing device 2402 is configured to communicate with an I/O device (not shown) via the I/O circuitry 2412. In some embodiments, the user input 2414 is received from the I/O device. A wired and/or wireless connection between the I/O circuitry 2412 and the I/O device is provided in some embodiments. The I/O device may be, for example, at least one of a keyboard, a mouse, a touchscreen, a microphone, a scanner, a joystick, a graphics tablet, a monitor, a printer, speakers, headphones, a projector, a headset, a wearable device, a gaming controller, an external hard drive, a USB hard drive, an SD card, a network interface card (NIC), combinations of the same, or the like.

In client/server-based embodiments, control circuitry 2408 may include communication circuitry suitable for communicating with an application server (e.g., server 2404) or other networks or servers. The instructions for conducting the functionality described herein may be stored on the application server. Communication circuitry may include a cable modem, an Ethernet card, or a wireless modem for communication with other equipment, or any other suitable communication circuitry. Such communication may include the Internet or any other suitable communication networks or paths (e.g., communication network 2406). In another example of a client/server-based application, control circuitry 2408 runs a web browser that interprets web pages provided by a remote server (e.g., server 2404). For example, the remote server may store the instructions for the application in a storage device.

The remote server may process the stored instructions using circuitry (e.g., control circuitry 2434) and/or generate displays. Computing device 2402 may receive the displays generated by the remote server and may display the content of the displays locally via display 2410. For example, display 2410 may be utilized to present a string of characters. This way, the processing of the instructions is performed remotely (e.g., by server 2404) while the resulting displays, such as the display windows described elsewhere herein, are provided locally on computing device 2404. Computing device 2402 may receive inputs from the user via input/output circuitry 2412 and transmit those inputs to the remote server for processing and generating the corresponding displays.

Alternatively, computing device 2402 may receive inputs from the user via input/output circuitry 2412 and process and display the received inputs locally, by control circuitry 2408 and display 2410, respectively. For example, input/output circuitry 2412 may correspond to a keyboard and/or a set of and/or one or more speakers/microphones which are used to receive user inputs. Input/output circuitry 2412 may also correspond to a communication link between display 2410 and control circuitry 2408 such that display 2410 updates based at least in part on inputs received via input/output circuitry 2412 (e.g., simultaneously update what is shown in display 2410 based on inputs received by generating corresponding outputs based on instructions stored in memory via a non-transitory, computer-readable medium).

Server 2404 and computing device 2402 may transmit and receive content and data such as media content via communication network 2406. For example, server 2404 may be a media content provider, and computing device 2402 may be a smart television configured to download or stream media content, such as a live news broadcast, from server 2404. Control circuitry 2434, 2408 may send and receive commands, requests, and other suitable data through communication network 2406 using communication circuitry 2432, 2426, respectively. Alternatively, control circuitry 2434, 2408 may communicate directly with each other using communication circuitry 2432, 2426, respectively, avoiding communication network 2406.

It is understood that computing device 2402 is not limited to the embodiments and methods shown and described herein. In nonlimiting examples, computing device 2402 may be a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, or any other device, computing equipment, or wireless device, and/or combination of the same, capable of suitably displaying and manipulating media content.

Computing device 2402 receives user input 2414 at input/output circuitry 2412. For example, computing device 2402 may receive a user input such as a user swipe or user touch. It is understood that computing device 2402 is not limited to the embodiments and methods shown and described herein.

User input 2414 may be received from a user selection-capturing interface that is separate from device 2402, such as a remote-control device, trackpad, or any other suitable user movement-sensitive, audio-sensitive or capture devices, or as part of device 2402, such as a touchscreen of display 2410. Transmission of user input 2414 to computing device 2402 may be accomplished using a wired connection, such as an audio cable, USB cable, ethernet cable and the like attached to a corresponding input port at a local device, or may be accomplished using a wireless connection, such as Bluetooth, Wi-Fi, WiMAX, GSM, UTMS, CDMA, TDMA, 8G, 4G, 4G LTE, 5G, NearLink, ultra-wideband technology, or any other suitable wireless transmission protocol. Input/output circuitry 2412 may include a physical input port such as a 12.5 mm (0.4921 inch) audio jack, RCA audio jack, USB port, ethernet port, or any other suitable connection for receiving audio over a wired connection or may include a wireless receiver configured to receive data via Bluetooth, Wi-Fi, WiMAX, GSM, UTMS, CDMA, TDMA, 3G, 4G, 4G LTE, 5G, NearLink, ultra-wideband technology, or other wireless transmission protocols.

Processing circuitry 2418 may receive user input 2414 from input/output circuitry 2412 using communication path 2416. Processing circuitry 2418 may convert or translate the received user input 2414 that may be in the form of audio data, visual data, gestures, or movement to digital signals. In some embodiments, input/output circuitry 2412 performs the translation to digital signals. In some embodiments, processing circuitry 2418 (or processing circuitry 2436, as the case may be) conducts disclosed processes and methods.

Processing circuitry 2418 may provide requests to storage 2422 by communication path 2420. Storage 2422 may provide requested information to processing circuitry 2418 by communication path 2446. Storage 2422 may transfer a request for information to communication circuitry 2426 which may translate or encode the request for information to a format receivable by communication network 2406 before transferring the request for information by communication path 2428. Communication network 2406 may forward the translated or encoded request for information to communication circuitry 2432, by communication path 2430.

At communication circuitry 2432, the translated or encoded request for information, received through communication path 2430, is translated or decoded for processing circuitry 2436, which will provide a response to the request for information based on information available through control circuitry 2434 or storage 2438, or a combination thereof. The response to the request for information is then provided back to communication network 2406 by communication path 2440 in an encoded or translated format such that communication network 2406 forwards the encoded or translated response back to communication circuitry 2426 by communication path 2442.

At communication circuitry 2426, the encoded or translated response to the request for information may be provided directly back to processing circuitry 2418 by communication path 2454 or may be provided to storage 2422 through communication path 2444, which then provides the information to processing circuitry 2418 by communication path 2446. Processing circuitry 2418 may also provide a request for information directly to communication circuitry 2426 through communication path 2452, where storage 2422 responds to an information request (provided through communication path 2420 or 2444) by communication path 2424 or 2446 that storage 2422 does not contain information pertaining to the request from processing circuitry 2418.

Processing circuitry 2418 may process the response to the request received through communication paths 2446 or 2454 and may provide instructions to display 2410 for a notification to be provided to the users through communication path 2448. Display 2410 may incorporate a timer for providing the notification or may rely on inputs through input/output circuitry 2412 from the user, which are forwarded through processing circuitry 2418 through communication path 2448, to determine how long or in what format to provide the notification. When display 2410 determines the display has been completed, a notification may be provided to processing circuitry 2418 through communication path 2450.

The communication paths between computing device 2402, server 2404, communication network 2406, and all subcomponents depicted are examples and may be modified to reduce processing time or enhance processing capabilities for each step in the processes disclosed herein by one skilled in the art.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It may be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Although at least one exemplary embodiment is described as using a plurality of units to perform the exemplary process, it is understood that the exemplary processes may also be performed by one or plurality of modules. Additionally, it is understood that the term controller/control unit may refer to a hardware device that includes a memory and a processor. The memory may be configured to store the modules and the processor may be specifically configured to execute said modules to perform one or more processes which are described further below.

The use of the terms “first”, “second”, “third”, and so on, herein, are provided to identify structures or operations, without describing an order of structures or operations, and, to the extent the structures or operations are used in an exemplary embodiment, the structures may be provided or the operations may be executed in a different order from the stated order unless a specific order is definitely specified in the context.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory (e.g., a non-transitory computer-readable medium accessible by an application via control or processing circuitry from storage) including, but not limited to, volatile and non-volatile computer memory or storage devices such as a hard disk, floppy disk, USB drive, DVD, CD, media cards, register memory, processor caches, random access memory (RAM), etc.

The interfaces, processes, and analysis described may, in some embodiments, be performed by an application. The application may be loaded directly onto each device of any of the systems described or may be stored in a remote server or any memory and processing circuitry accessible to each device in the system. The generation of interfaces and analysis there-behind may be performed at a receiving device, a sending device, or some device or processor therebetween.

The systems and processes discussed above are intended to be illustrative and not limiting. One skilled in the art would appreciate that the actions of the processes discussed herein may be omitted, modified, combined, and/or rearranged, and any additional actions may be performed without departing from the scope of the invention. More generally, the above disclosure is meant to be exemplary and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

While some portions of this disclosure may refer to “convention” or examples, any such reference is merely to provide context to the instant disclosure and does not form any admission as to what constitutes the state of the art.

Accordingly, this description is to be taken only by way of example and not to otherwise limit the scope of the exemplary embodiments herein. Therefore, it is the object of the appended claims to cover all such variations and modifications as come within the true spirit and scope of the exemplary embodiments herein.

1. A method comprising:
receiving a content stream from at least one of a plurality of servers for generating for display on a user device;
receiving from at least one of the plurality of servers an indication that a first portion of the content stream is marked as a key event, wherein the first portion of the content stream was marked as a key event based on a computer vision analysis performed by at least one of the plurality of servers;
based on determining that: (a) the content stream is being received by the user device in a first quality, and (b) that the content stream is available from at least one of a plurality of servers in a second quality that is higher than the first quality:
starting to store at the user device the first portion of the content stream in the second quality, while generating for display a second portion of the content stream in the first quality;
after the storing the first portion of the content stream is complete:
receiving a request to replay at least the first portion of the content stream;
retrieving from storage of the user device at least the first portion of the content stream in the second quality; and
replaying at least the first portion of the content stream in the second quality.

2. The method of claim 1, wherein the receiving the indication that the first portion of the content stream is marked as the key event comprises:
receiving a manifest file comprising data indicative of the first portion of the content stream from the at least one of the plurality of servers;
determining that the data contains an attribute indicating that the first portion of the content stream is marked as the key event.

3. The method of claim 1, further comprising:
accessing the manifest file comprising data indicative of the first portion of the content stream from the at least one of the plurality of servers;
identifying, from the data, a start time of the first portion of the content stream marked as the key event; and
wherein the starting to store at the user device the first portion of the content stream in the second quality comprises:
starting to store the first portion of the content stream in the second quality from the identified start time.

4. The method of claim 3 further comprising:
determining that the manifest file contains an attribute indicating that the second portion of the content stream is not marked as the key event;
identifying an end time of the first portion of the content stream marked as the key event;
stopping the storing of the first portion of the content stream at the end time.

5. The method of claim 3, further comprising:
receiving an updated manifest file comprising update data indicative of the first portion of the content stream from the at least one of the plurality of servers;
determining that the update data contains an attribute indicating that the first portion of the content stream is not marked as the key event;
based on the determining that the update data contains the attribute indicating that the first portion of the content stream is not marked as the key event:
stopping the storing of the first portion of the content stream in the second quality; and
removing the stored first portion of the content stream in the second quality from the user device.

6. The method of claim 1, further comprising:
determining that a third portion of the content stream is a different key event based on analyzing user history information;
based on determining that: (a) the content stream is being received by the user device in the first quality, and (b) that the content stream is available from at least one of the plurality of servers in the second quality that is higher than the first quality:
starting to store at the user device the third portion of the content stream in the second quality.

7. The method of claim 1, wherein the receiving from the at least one of the plurality of servers the indication that the first portion of the content stream is marked as the key event comprises receiving, from the at least one of the plurality of servers, key event metadata describing the first portion of the content stream based on the computer vision analysis; and
wherein the method further comprises generating for display a textual summary of the first portion based on the key event metadata generated.

8. The method of claim 7, wherein the key event metadata is indicative of at least one of key players, actors, gameplays, critical decisions, or scores identified in the first portion the content stream using the computer vision analysis.

9. The method of claim 7, further comprising:
receiving a multiplexed signal being multicast to the user device from the at least one of the plurality of servers, wherein a multiplexed signal is generated by the at least one of the plurality of servers by incorporating an output of the computer vision analysis with the key event metadata.

10. The method of claim 9, further comprising:
causing the multiplexed signal to be demultiplexed into a media file and the key event metadata at the user device;
storing the key event metadata as a file on the user device;
extracting a set of images from the media file; and
causing the set of images and the key event metadata to be displayed at the user device on a timeline for navigating the content stream.

11. The method of claim 1, wherein the computer vision analysis performed by the at least one of the plurality of servers further determines a likelihood that the first portion is to be replayed by user devices.

12. The method of claim 1, wherein the starting to store at the user device the first portion of the content stream in the second quality is in response to a user input indicating a rewind of the key event.

13. The method of claim 1, wherein the indication that the first portion of the content stream is marked as the key event is from a different multiplex stream.

14. The method of claim 1, wherein the first portion is stored in a key event database, the method further comprising:
receiving from at least one of the plurality of servers an indication that a third portion of the content stream is marked as a separate key event
storing the third portion of the content stream in the key event database;
determining that the content stream has ended;
retrieving from the key event database at least the first portion of the content stream and the third portion of the content stream; and
replaying at least the first portion of the content stream and the third portion of the content stream.

15. A system comprising:
I/O circuitry configured to:
receive a content stream from at least one of a plurality of servers for generating for display on a user device;
receive from at least one of the plurality of servers an indication that a first portion of the content stream is marked as a key event, wherein the first portion of the content stream was marked as a key event based on a computer vision analysis performed by at least one of the plurality of servers;
based on determining that: (a) the content stream is being received by the user device in a first quality, and (b) that the content stream is available from at least one of a plurality of servers in a second quality that is higher than the first quality:
control circuitry configured to:
start to store at the user device the first portion of the content stream in the second quality, while generating for display a second portion of the content stream in the first quality;
after the storing the first portion of the content stream is complete:
I/O circuitry configured to:
receive a request to replay at least the first portion of the content stream;
control circuitry configured to:
retrieve from storage of the user device at least the first portion of the content stream in the second quality; and
replay at least the first portion of the content stream in the second quality.

16. The system of claim 15, wherein I/O circuitry, when the receiving the indication that the first portion of the content stream is marked as the key event, is configured to:
receive a manifest file comprising data indicative of the first portion of the content stream from the at least one of the plurality of servers;
determine that the data contains an attribute indicating that the first portion of the content stream is marked as the key event.

17. The system of claim 15, wherein control circuitry is further configured to:
access the manifest file comprising data indicative of the first portion of the content stream from the at least one of the plurality of servers;
identify, from the data, a start time of the first portion of the content stream marked as the key event; and
wherein the starting to store at the user device the first portion of the content stream in the second quality comprises:
starting to store the first portion of the content stream in the second quality from the identified start time.

18. The system of claim 17, wherein control circuitry is further configured to:
determine that the manifest file contains an attribute indicating that the second portion of the content stream is not marked as the key event;
identify an end time of the first portion of the content stream marked as the key event; and
stop the storing of the first portion of the content stream at the end time.

19. The system of claim 17, further configured to:
receive, by I/O circuitry, an updated manifest file comprising update data indicative of the first portion of the content stream from the at least one of the plurality of servers;
determine, by control circuitry, that the update data contains an attribute indicating that the first portion of the content stream is not marked as the key event;
based on the determining that the update data contains the attribute indicating that the first portion of the content stream is not marked as the key event:
stop, by control circuitry, the storing of the first portion of the content stream in the second quality; and
remove, by control circuitry, the stored first portion of the content stream in the second quality from the user device.

20. The system of claim 15, wherein control circuitry is further configured to:
determine that a third portion of the content stream is a different key event based on analyzing user history information;
based on determining that: (a) the content stream is being received by the user device in the first quality, and (b) that the content stream is available from at least one of the plurality of servers in the second quality that is higher than the first quality:
start to store at the user device the third portion of the content stream in the second quality.

21-120. (canceled)
